(19) United States
(12) Patent Application Publication
(10) Pub. No.: US 2026/0049171 A1
(43) Pub. Date: Feb. 19, 2026

(54) CLOSED LOOP RECYCLING CONCEPT FOR COMPOSITES COMPRISING COVALENT ADAPTABLE POLY(UREA-URETHANE) NETWORKS WITH DYNAMIC HINDERED UREA BONDS

(71) Applicant: BASE SE, Ludwigshafen am Rhein (DE)

(72) Inventors: Larissa Maria HAMMER, Ludwigshafen am Rhein (DE); Florian Ludwig GEYER, Ludwigshafen am Rhein (DE)

(21) Appl. No.: 19/129,799

(22) PCT Filed: Nov. 14, 2023
(86) PCT No.: PCT/EP2023/081743

§ 371 Date: May 14, 2025

(30) Foreign Application Priority Data
Nov. 15, 2022 (EP) 22207570.7
Nov. 15, 2022 (EP) 22207575.6

(51) Int. Cl. C08G 18/72; C08G 18/10; C08J 11/28

(52) U.S. Cl. CPC C08G 18/72; C08G 18/10; C08J 11/28; C08J 2375/04

(57) ABSTRACT

The present invention relates to a process for recycling a composition comprising a poly(urea-urethane) polymer with hindered urea bonds comprising the treatment of the composition comprising the poly(urea-urethane) polymer under conditions suitable to at least partially cleave the urea bonds of the polymer to give a mixture (M1) containing prepolymers. The present invention also relates to the prepolymer obtained or obtainable according to the process, a poly(urea-urethane) polymer obtained or obtainable according to the process according to the present invention as well as the use of said prepolymer for the preparation of a poly(urea-urethane) polymer.

The present invention relates to a process for recycling a composition comprising a poly(urea-urethane) polymer with hindered urea bonds comprising the treatment of the composition comprising the poly(urea-urethane) polymer under conditions suitable to at least partially cleave the urea bonds of the polymer to give a mixture (M1) containing prepolymers.

There is a need in the material and polymer sciences to develop polymeric materials with desired in-use performance characteristics that are also malleable, repairable, and shape reprogrammable. There is also a need to develop such polymers that can be degraded or reversibly depolymerized. Even though shape memory and self-healing polymers are known, many of these polymers do not have both the desired performance and dynamic characteristics. With respect to degradable or reversibly depolymerizable polymers, these polymers often lack the required in-use performance characteristics and are either too easily degraded or on the other hand not degraded as readily or rapidly as desired.

Further, composite materials based on polymers comprising fillers such as fibrous materials or isotropic materials, for example glass fibers reinforced plastics (GFRP), are widely used in applications such as airplanes, boats or windmill blades. Over 10 million of tones of GFRP are produced every year and no feasible recycling concept exits once embedded into the polymers.

Due to their excellent dimensional stability, chemical resistance, and thermal and mechanical performances, thermosets are used in a wide range of applications, including structural composites, adhesives, coatings, and electrical insulation. However, conventional thermosets cannot be reshaped, reprocessed, or recycled due to their inability to melt or flow at high temperatures.

An effective chemical strategy to combine these properties is to introduce dynamic chemical bonds into a polymer network, resulting in a dynamic polymer network. Polymers containing dynamic bonds are considered covalent adaptable networks (CANs).

Several scientific publications disclose that urea bonds bearing a bulky group on the nitrogen atom resulted in hindered urea bonds (HUBs) that were dynamic and can reversibly dissociate into an amine and isocyanate based on the associative exchange mechanisms.

However, those documents do not disclose processes suitable for industrial processes on a large scale which allow to recycle waste materials on a large scale.

Thus, there is a need to develop processing techniques to recover materials from plastic waste. The recycling process should reduce both the waste of material and the carbon footprint. Further, it should be an economical and energy efficient process delivering valuable materials which comprise high technical features. In contrast, disposal, e.g. by combustion, has a negative impact on the environment as well as on the carbon footprint. Furthermore, there is a need to provide a new polymer and a process for recycling said polymer.

According to the present invention, this objective was solved by a process for recycling a composition comprising a poly(urea-urethane) polymer (PUU1) comprising step (i):
(i) treatment of the composition comprising the poly(urea-urethane) polymer (PUU1) under conditions suitable to at least partially cleave the urea bonds of the polymer to give a mixture (M1) containing prepolymers, the poly(urea-urethane) polymer (PUU1) being obtainable or obtained by a process comprising:
reacting the following components
(i) at least one isocyanate;
(ii) at least one polyol; and
(iii) at least one secondary amine having the following formula (I)

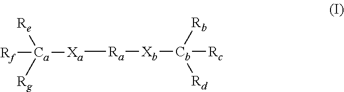

wherein —Rₐ— is selected from the group consisting of —Z₁—, —Z₂—, —Z₃—, —Z₄—, —Z₅—, —Z₆—, —Z₇—, —Z₇—, —Z₈—, —Z₉—, —Z₁₀—, —Z₁₁—, —Z₁₃—, —Z₁—Z₅—, —Z₅—Z₁—Z₅—, —Z₁—Z₆—, —Z₁—Z₇—, —Z₁—Z₈—, —Z₁—Z₉—, —Z₉—Z₁—Z₉—, —Z₁—Z₁₁, —Z₃—Z₅—, —Z₃—Z₆—, —Z₃—Z₇—, —Z₃—Z₉—, —Z₃—Z—, —Z₃—Z₁₁, —Z₁—Z₅—Z₁—, —Z₁—Z₉—Z₁—, —Z—Z₁(—Z₁₁—Z₁)—Z—, with n=1, 2, 3, 4, 5, or 6, and —Z₁—Z₁₂—Z₁—; wherein —Z₁— is a substituted or unsubstituted, linear or branched C₁-C₃₀ alkylene;
—Z₂— is a substituted or unsubstituted, linear or branched 2- to 300,000-membered heteroalkylene;
—Z₃— is a substituted or unsubstituted, linear or branched C₂-C₃₀ alkenylene;
—Z₄— is a substituted or unsubstituted, linear or branched 3- to 30-membered heteroalkenylene;
—Z₅— is a substituted or unsubstituted C₅-C₃₀ cycloalkylene;
—Z₆— is a substituted or unsubstituted 5- to 30-membered heterocycloalkylene;
—Z₇— is a substituted or unsubstituted C₅-C₃₀ cycloalkenylene;
—Z— is a substituted or unsubstituted 5- to 30-membered heterocycloalkenylen;
—Z— is a substituted or unsubstituted C₆-C₃₀ arylene;
—Z₁₀— is a substituted or unsubstituted 5- to 30-membered heteroarylene;
—Z₁₁— is a C₆-C₃₀ arylene substituted with —NHR or —OR, wherein R is selected from the group consisting of H and substituted or unsubstituted, linear or branched C₁-C₁₀ alkyl;
—Z₁₂— is —N(Rf)—;
—Z₁₃— is a substituted or unsubstituted 5- to 30-membered heterocycloalkylene, wherein at least one of the one or more heteroatoms of Z₁₃ is from Xₐ;
wherein Cₐ is a C atom or a H atom and C_{b} is a C atom or a H atom, wherein at least one of Cₐ and C_{b} is a C atom;
wherein Xₐ is a O atom or NH and X_{b} is a O atom or NH, wherein at least one of Xₐ and X_{b} is NH, with the condition that for Xₐ and/or X_{b} being NH, the respective Cₐ and/or C_{b} is/are C atom(s);
wherein
   (A) Rₑ, R_{d}, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl, R_{b} and Rₑ independently of each other are defined as Rₑ, R_{d}, R_{f} and R_{g}; or R_{b} and Rₑ are none, and Cₐ and C_{b} are connected to each other via a single bond forming a heterocycle consisting of Cₐ, C_{b}, Xₐ, X_{b} and Rₐ; or
   (B) Cₐ and Rₑ form a substituted or unsubstituted C₆-C₃₀ arylene, and both R_{f} and R_{g} are none; and
   C_{b} and R_{b} form a substituted or unsubstituted C₆-C₃₀ arylene, and both R_{c} and R_{d} are none; or
   (C)—Cₐ and Rₑ form a substituted or unsubstituted C₆-C₃₀ arylene, and both R_{f} and R_{g} are none; or
   C_{b} and R_{b} form a substituted or unsubstituted C₆-C₃₀ arylene, and both R_{c} and R_{d} are none;
   wherein, when Cₐ and Rₑ form a substituted or unsubstituted C₆-C₃₀ arylene, R_{b}, R_{c} and R_{d} independently of each other are defined as any one of Rₑ, R_{d}, R_{f} and R_{g} under (A);
   wherein, when C_{b} and R_{b} form a substituted or unsubstituted C₆-C₃₀ arylene, Rₑ, R_{f} and R_{g} independently of each other are defined as any one of Rₑ, R_{d}, R_{f} and R_{g} under (A).

According to the present invention the composition comprising the poly(urea-urethane)polymer (PUU1) is treated under conditions suitable to at least partially cleave the urea bonds. Preferably, the urea bonds in the polymer are cleaved while the urethane bonds are stable under the conditions of the treatment. Preferably, the treatment is conducted under conditions which are suitable to result in cleavage of the urea bonds in the polymer until the material is processable, soluble or has a reduced viscosity for the desired application. According to the present invention, in step (i) a mixture (M1) is obtained which contains prepolymers but also might obtain poly(urea-urethane)polymer and further components.

According to a further embodiment, the present invention is also directed to a process as disclosed above, wherein the conditions applied in step (i) are suitable to cleave the urea bonds of the polymer while the urethane bonds are substantially stable.

In the context of the present invention, a bond between N (from secondary hindered amine) and C (of NCO) of a urea group which can be reversibly formed and broken is also designated as reversible NCO bond.

The present method enables re-utilization of poly(urea-urethane)polymers. The process of the present invention provides the advantage that a wide range of mild reaction conditions can be applied and allows to recover and reuse the components used. Preferably, the process of the present invention allows the complete recovery of the poly(urea-urethane) and expensive fillers used, such as carbon fibers from the composites. Surprisingly, it was found that the polymer according to the present invention permits to create composites which can be used in many applications while being easily repairable and recyclable. In-deed, the poly(urea-urethane) polymer according to the present invention has dynamic hindered urea bonds (HUBs) which acts as dynamic covalent bonds in a covalent adaptable system/network (CAS/CAN). It is thus believed that the introduction of bulky substituent to a nitrogen atom weakens the bond such that there is a dissociation equilibrium of open and closed bonds which shifts to the open side by increasing temperature. The HUBs split up to the original constituting groups (de-polymerisation). The claimed materials are easily processable by thermo-mechanical processing methods as demonstrated in the following and facilitate the chemical and mechanical recycling of the poly(urea-urethane) polymers.

According to the present invention, the treatment according to step (i) may be applied to a formed body or also parts of a formed body. The composition might for example be cut into small pieces before the treatment or also comminuted using standard procedures.

The treatment may comprise a treatment at elevated temperature for example in in the range of from 600° C. to 200° C.

It is for example possible that the treatment comprises applying pressure at elevated temperature, for example pressure in the range of 1 bar to 200 bar in a solution or melt process, or by applying mechanical energy by extrusion processes or in hot presses.

It is for example possible that the treatment comprises applying reduced pressure at elevated temperature, for example in a solution or melt-process, preferable between 50 mbar and 1 bar.

Therefore, according to a further embodiment, the present invention is also directed to the process as disclosed above, wherein step (i) is a treatment at a temperature in the range from 60° C. to 200° C. and a pressure in the range from 1 bar to 200 bar or in a range from 50 mbar to 1 bar.

Preferably, in solution the treatment is performed at a pressure in the range of from 1 to 180 bar, preferably in the range of from 1 to 150 bar, more preferably in the range of from 1 to 100 bar.

Preferably in hot melt, the treatment is performed at a pressure in the range of from 1.5to 180 bar, preferably in the range of from 2 to 150 bar, more preferably in the range of from 5 to 100 bar.

Preferably, mechanical pressing is hot-pressing, more preferably performed at a temperature in the range of from 80 to 200° C., more preferably in the range of from 120 to 160° C., more preferably in the range of from 130 to 150° C.

Preferably, mechanical pressing is performed at a pressure in the range of from 1.5 to 180 bar, preferably in the range of from 2 to 100 bar, more preferably in the range of from 5 to 50 bar.

Preferably, mechanical pressing is performed for a duration in the range of from 1 to 60 min, more preferably in the range of from 4 to 20 min, more preferably in the range of from 5 to 10 min.

Preferably, extruding is performed at a temperature in the range of from 140 to 220° C., more preferably in the range of from 160 to 200° C., more preferably in the range of from 170 to 190° C.

Preferably, extruding is performed at a torque in the range of from 2.0 to 2.4 kN, more preferably at a maximum torque of 2.2 kN.

According to the invention, step (i) might be carried out using a suitable solvent. Suitable solvents are in principle known and comprise for example aprotic solvents, in particular organic aprotic solvents.

According to a further embodiment, the present invention is also directed to the process as disclosed above, wherein in step (i) an aprotic solvent is added.

In principle, any solvent may be used which is suitable to dissolve the poly(urea-urethane)polymers or mixture containing the prepolymers obtained but will not react with the poly(urea-urethane)polymers or the components. For an economic process, preferably an organic solvent is selected with a boiling point at ambient pressure below 230° C., preferably below 150° C.

In one embodiment, the organic aprotic solvent is selected from aliphatic hydrocarbons, halogenated hydrocarbons, ethers, aromatic hydrocarbons, esters, amides, sulfoxides and sulfones, ketones and mixtures thereof.

Therefore, according to a further embodiment, the present invention is also directed to the process as disclosed above, wherein organic aprotic solvent is selected from aliphatic hydrocarbons, halogenated hydrocarbons, ethers, aromatic hydrocarbons, esters, amides, sulfoxides, sulfones, ketones and mixtures thereof.

Suitable aliphatic hydrocarbons are selected from pentane and its isomers, hexane and its isomers, heptane and it s isomers, octane and its isomers, cyclopentane, methylcyclopentane, cyclohexane and methylcyclohexane and mixtures thereof.

Suitable halogenated hydrocarbons are selected from dichloromethane, chloroform, 1,2-di-chloroethane, 1,1,1-trichloroethane, 1,1,2,2-tetrachlroethane and mixtures thereof.

Suitable ethers are selected from tetrahydrofuran, 1,4-dioxane, anisole, diethyl ether, diisopropyl ether, dibutyl ether, methyl tert-butyl ether (MTBE) and diethylene glycol dimethyl ether and mixtures thereof.

Suitable aromatic hydrocarbons are selected from benzene, toluene, ortho-xylene, meta-xylene, para-xylene, ethylbenzene, mesitylene and chlorobenzene, isomers of dichlorobenzene and mixtures thereof.

Suitable esters are selected from gamma-butyrolactone, methylformate, methylacetate, ethylacetate and butylacetate and mixtures thereof.

Suitable amides are selected from dimethyl formamide, dimethyl acetamide, diethyl formamide, diethyl acetamide and mixtures thereof.

Suitable sulfoxides and sulfones are selected from dimethyl sulfoxide and sulfolane and mixtures thereof.

Suitable ketones are selected from acetone, methylethylketone, diethylketone, cylopentanone and mixtures thereof.

Also 1,3-dimethyl-2-imidazolidinon (DMI) may be suitable in the context of the present invention.

If desired, mixtures of two or more of the aforementioned organic aprotic solvents may be used.

In a preferred embodiment, the extraction solvent is selected from THF, MTBE, toluene, xylene, DMSO, DMI, and mixtures thereof.

According to step (i), urea bonds of the poly(urea-urethane)polymer are cleaved. In principle, the process is reversible according to the present invention and the urea bonds might for example reform when the temperature of the mixture obtained is reduced. This allows for example reshaping of a formed body or also repairing a formed body.

According to a further embodiment, it is also possible to add further components which react with the free functional groups which are formed due to the dynamic cleaving of the urea bonds. This allows for example to form stable components which might be isolated.

Therefore, according to a further embodiment, the present invention is also directed to the process as disclosed above, wherein in step (i), a component (S) is added which is suitable to react with the free functional groups of the cleaved urea bonds.

Component (S) may also be designated as scavenger in the context of the present invention.

Suitable as component (S) are compounds which form stable bonds with the components in mixture (M1). Suitable are for example compounds having OH or NH groups such as for example polyols, diols, monols, polyamines, oligo-amines, diamines and monoamines which may react with free isocyanate groups. Also, isocyanates such as polyisocyanates or diisocyanates may be added as component (S) which may react with the free functional groups of the hindered amines present in the mixture (M1).

Amines suitable as component (S) may be amines of the general formula (II):

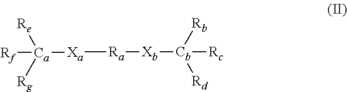

with the definition of the residues as defined above, and the condition that Xa is NH and Xb, Cb, Rb, Rc and Rd are none or Xb is NH and Xa, Ca, Re, Rf and Rg are none.

Therefore, according to a further embodiment, the present invention is also directed to the process as disclosed above, wherein component (S) is selected from the group consisting of polyols, diols, polyisocyanates, diisocyanates, polyamines, oligo-amines, diamines, and amines of the general formula (II).

Suitable polyols are known per se to a person skilled in the art.

Principally, any polyol conventionally used for the preparation of polyurethanes can be used as polyol. The type of polyol may depend on the desired purpose of the application. Suitable polyols are polyester polyols, including in particular aliphatic polyester polyols and aliphatic aromatic polyester polyols, polyestercarbonate polyols, polyetherester polyols, aliphatic polycarbonate polyols, polyacrylate polyols, polyolefine polyols, aliphatic polyetherols and mixtures thereof. In preferred groups of embodiments, the at least one polyol is selected from polyester polyols, in particular aliphatic polyester polyols and aliphatic aromatic polyester polyols, aliphatic polycarbonate polyols, aliphatic polyetherols and mixtures thereof. In particular, the at least one polyol comprises a polyester polyol and/or an aliphatic polyether polyol as described herein. Especially, the at least one polyol is selected from polyester polyols, aliphatic polyether polyols and combinations thereof.

Diols and diamines are in principle known to the person skilled in the art. Suitable are for example aliphatic dialcohols such as butanediol, pentanediol, hexanediol or decanediol and the respective isomers, preferably pentanediol and/or hexanediol, in particular hexanediol.

In addition to these alcohols, further mono-, di- or polyalcohols may also be present in the alcohol component, for example those having a molecular weight of 62 to 400 g/mol. Examples are monoethylene glycol, 1,2- or 1,3-propanediol, 2-methyl-1,3-propandiol, 3-methyl-1,5-pentanediol, diethylene glycol, dipropylene glycol, triethylene glycol, tripropylene glycol, PTHF 250, bisphenols, and mixtures of polyhydric alcohols. Suitable active hydrogen com-pounds may for example be 1,2-, 1,3- and 1,4-butanediol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-2,5-diol, 1,6-hexanediol, heptane-1,2-diol 1,7-heptanediol, 1,8-octanediol, 1,2-octanediol, 1,9-nonanediol, 1,2-decanediol, 1,10-decanediol, 1,2-dodecanediol, 1,12-dodecanediol, 1,5-hexadi-ene-3,4-diol, 2,2-Bis(4-hydroxycyclohexyl)propane, neo-pentyl glycol (2,2-dimethylpropane-1,3-diol), 2,2-diethylpropane-1,3-diol, 2-methyl-2-ethylpropane-1,3-diol, 2-methyl-2,4-pen-tanediol, 2,4-dimethyl-2,4-pentanediol, 2-ethyl-1,3-hexanediol, 2,5-dimethyl-2,5-hexanediol, 2,2,4-trimethyl-1,3-pentanediol, pinacol, diethylene glycol, triethylene glycol, dipropylene glycol, and tripropylene glycol, 1,1-dimethylethane-1,2-diol, 2-butyl-2-ethyl-1,3-propanediol, 2-ethyl-1,3-propanediol, neopentyl glycol, hydroxypivalic acid neopentyl glycol ester, 2-ethyl-1,3-hexanediol, 2,4-diethyloctane-1,3-diol,—cyclic aliphatic diol compounds having 3 to 14 carbon atoms, for example tetramethylcyclobutanediol, 1,2-, 1,3- and 1,4cyclohexanediol, 1,1-, 1,2-, 1,3- and 1,4cyclohexanedimethanol, 1,2-, 1,3- or 1,4cyclooctanediol, 4,8-Bis(hydroxymethyl)tricyclo[5.2.1.02,6]decane, norbornanediol, pinanediol, decalindiol, 2,2-bis(4-hydroxycyclohexyl)propane, bis(4-hydroxycyclohexane)isopropylidene; aromatic diols such as for example 2,5-bis(hydroxymethyl)furan, 3,4-bis(hydroxymethyl)furan, bis(2-hydroxyethyl) terephthalate, 1,4 benzenediol, hydroquinone bis(2-hydroxyethyl) ether, bisphenol A, bisphenol AP, bisphenol AF, bisphenol B, bisphenol BP, bisphenol C, bisphenol C2, bisphenol E, bisphenol F, bisphenol G, bisphenol M, bisphenol S, bisphenol P, bisphenol PH, bisphenol TMC, bisphenol Z, tetrabromobisphenol A and—aliphatic alcohols having 2 to 20 carbon atoms and further functional groups, such as or mixtures of two or more thereof.

According to the present invention, it is also possible to use hindered amines of the general formula (I) or (II) as component (M1) to obtain products which in turn contain urea groups which might be cleaved.

Therefore, according to a further embodiment, the present invention is also directed to the process as disclosed above, wherein component (S) is selected from diisocyanates, polyamines, oligo-amines, diamines of the general formula (I), and amines of the general formula (II).

Suitable isocyanates may be selected from the group consisting of monomeric methylene diphenylene diisocyanate (mMDI), polymethylene polyphenylene polyisocyanate (pMDI), a mixture of monomer methylene diphenylene diisocyanate and polymethylene polyphenylene polyisocyanate (MDI) and tolylene diisocyanate (TDI).

Preferably, the at least one isocyanate (i) is selected from the group consisting of methylene diphenylene diisocyanate (mMDI), polymethylene polyphenylene polyisocyanate (pMDI) and a mixture of monomeric methylene diphenylene diisocyanate and polymethylene polyphenylene polyisocyanate (MDI), more preferably selected from the group consisting of monomeric methylene diphenylene diisocyanate (mMDI) and a mixture of monomeric methylene diphenylene diisocyanate and polymethylene polyphenylene polyisocya-nate (MDI)) and tolylene diisocyanate (TDI).

More preferably, tolylene diisocyanate (TDI) comprises, more preferably consists of, one or more of 2,4-TDI and 2,6-TDI.

More preferably the monomeric methylene diphenylene diisocyanate (mMDI) comprises, more preferably consists of, one or more 4,4′-methylene(diphenyl diisocyanate) (4,4′-MDI), 2,2′—methylene (diphenyl diisocyanate) (2,2′-MDI) and 2,4′—methylene (diphenyl diisocya-nate) (2,4′-MDI), more preferably 4,4′-methylene(diphenyl diisocyanate) (4,4′-MDI). More preferably, the at least one isocyanate (i) is a monomeric methylene diphenylene diisocya-nate (mMDI) which comprises, more preferably consists of, one or more 4,4′-methylene(di-phenyl diisocyanate) (4,4′-MDI), 2,2′—methylene (diphenyl diisocyanate) (2,2′-MDI) and 2,4′-methylene (diphenyl diisocyanate) (2,4′-MDI), more preferably 4,4′-methylene(diphenyl diisocyanate) (4,4′-MDI).

Other possible isocyanates are mentioned by way of example in “Kunststoffhandbuch [Plastics handbook], volume 7, Polyurethane [Polyurethanes]”, Carl Hanser Verlag, 3rd edition 1993, chapter 3.2 and 3.3.2.

According to a further embodiment, the present invention is also directed to the process as disclosed above, wherein component (S) is selected from polyamines, oligo-amines, dia-mines or a mixture of polyamines, oligo-amines and diamines of the general formula (I).

According to the present invention, the composition comprising the poly(urea-urethane)polymer may also comprise further components such as for example fillers, pigments or further additives. Suitable additives are known to the person skilled in the art. In particular fillers may be added such as for example fibrous fillers.

Therefore, according to a further embodiment, the present invention is also directed to the process as disclosed above, wherein the composition comprises a filler, the filler being selected from the group consisting of glass fibers, carbon fibers, mineral fibers, textiles, metal meshs, metal fibers, metal rods, carbonates, wood, and a mixture of two or more thereof.

In case the composition comprises the poly(urea-urethane) polymer and fillers, the mixture (M1) also comprises fillers. In the context of the present invention, the process for recycling as disclosed above may also comprise suitable separation steps to isolate the components of mixture (M1). It is also possible to separate one component from the remaining mixture.

The process may also comprise further purification steps.

Therefore, according to a further embodiment, the present invention is also directed to the process as disclosed above, wherein the process comprises step (ii)
(ii) separation of the components of the mixture obtained in step (i).

Suitable separation steps are in principle known and may for example comprise filtration steps, distillation steps or extraction steps. Filtration may also be carried out at elevated temperatures depending on the solubility of the components. Therefore, according to a further embodiment, the present invention is also directed to the process as disclosed above, wherein step (ii) comprises a filtration step.

Filtration may for example be carried out at a temperature in the range from 20 to 230° C., preferably in a range of from 40° C. to 200° C., in particular in a range of from 60 to 150° C.

The components of mixture (M1) may be separated and isolated. The components may be obtained in solution, or the solvent may be removed using suitable techniques known to the person skilled in the art. The process may also comprise two or more purification steps.

This allows to obtain the components of the composite, for example the filler may be isolated.

The components isolated may also be reused, in particular as starting materials in processes for the preparation of poly(urea-urethane) polymers.

Therefore, according to a further embodiment, the present invention is also directed to the process as disclosed above, wherein the process comprises step (iii)
(iii) preparing a poly(urea-urethane) polymer using one or more of the components obtained in step (ii).

The process according to the present invention comprises step (i), and optionally (ii), and optionally (iii) but may also comprise further steps. The process may for example comprise further purification steps or heat treatments. According to a further embodiment, the present invention is also directed to the process as disclosed above, wherein the process comprises further purification steps. Suitable purification steps include for example washing steps and drying steps.

Suitable treatment steps are in principle known to the person skilled in the art. Suitable treatment and/or purification steps may be carried out between steps (i) and (ii), or between steps (ii) and (iii). In the context of the present invention it is also possible that step (ii) is carried out directly after step (i). It is also possible that step (iii) is carried out directly after step (ii).

According to the present invention, the poly(urea-urethane) polymer (PUU1) is obtainable or obtained by a process comprising:
reacting the following components
(i) at least one isocyanate;
(ii) at least one polyol; and
(iii) at least one secondary amine having the following formula (I)

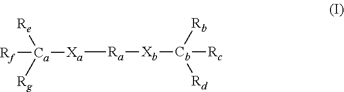

wherein —Rₐ— is selected from the group consisting of —Z₁—, —Z₂—, —Z₃—, —Z₄—, —Z₅, —Z₆, —Z₇—, —Z₇—, —Z—, —Z₉—, —Z₁₀—, —Z₁₁—, —Z₁₃—, —Z₁—Z₅—, —Z₅—Z₁—Z₅—, —Z₁—Z₆—, —Z₁—Z₇—, —Z₁—Z—, —Z₁—Z₉—, —Z₉—Z₁—Z₉—, —Z₁—Z₁₀—, —Z₃—Z₅—, —Z₃—Z₆—, —Z₃—Z₇—, —Z₃—Z₈—, —Z₃—Z₉—, —Z₃—Z₁₀—, —Z₁—Z₅—Z₁—, —Z₁—Z₉—Z₁—, —Z₉—Z₁(—Z₁₁—Z₁)—Z₉—, with n=1, 2, 3, 4, 5, or 6, and —Z₁—Z₁₂—Z₁—; wherein —Z₁— is a substituted or unsubstituted, linear or branched C₁-C₃₀ alkylene;
—Z₂— is a substituted or unsubstituted, linear or branched 2- to 300,000-membered heteroalkylene;
—Z₃— is a substituted or unsubstituted, linear or branched C₂-C₃₀ alkenylene;
—Z₄— is a substituted or unsubstituted, linear or branched 3- to 30-membered heteroalkenylene;
—Z₅— is a substituted or unsubstituted C₅-C₃₀ cycloalkylene;
—Z₆— is a substituted or unsubstituted 5- to 30-membered heterocycloalkylene;
—Z₇— is a substituted or unsubstituted C₅-C₃₀ cycloalkenylene;
—Z₈— is a substituted or unsubstituted 5- to 30-membered heterocycloalkenylen;
—Z₉— is a substituted or unsubstituted C₆-C₃₀ arylene;
—Z₁₀— is a substituted or unsubstituted 5- to 30-membered heteroarylene;
—Z₁₁— is a C₆-C₃₀ arylene substituted with —NHR or —OR, wherein R is selected from the group consisting of H and substituted or unsubstituted, linear or branched C₁-C₁₀ alkyl; Z₁₂— is —N(R_{f})—;
—Z₁₃— is a substituted or unsubstituted 5- to 30-membered heterocycloalkylene, wherein at least one of the one or more heteroatoms of Z₁₃ is from Xₐ;
wherein Cₐ is a C atom or a H atom and C_{b} is a C atom or a H atom, wherein at least one of Cₐ and C_{b} is a C atom;
wherein Xₐ is a O atom or NH and X_{b} is a O atom or NH, wherein at least one of Xₐ and X_{b} is NH, with the condition that for Xₐ and/or X_{b} being NH, the respective Cₐ and/or C_{b} is/are C atom(s);
wherein
   (A) Rₑ, R_{d}, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl, R_{b} and Rₑ independently of each other are defined as Rₑ, R_{d}, R_{f} and R_{g}; or R_{b} and Rₑ are none, and Cₐ and C_{b} are connected to each other via a single bond forming a heterocycle consisting of Cₐ, C_{b}, Xₐ, X_{b} and Rₐ; or
   (B) Cₐ and Rₑ form a substituted or unsubstituted C₆-C₃₀ arylene, and both R_{f} and R_{g} are none; and C_{b} and R_{b} form a substituted or unsubstituted C₆-C₃₀ arylene, and both R_{c} and R_{d} are none; or
   (C)—Cₐ and Rₑ form a substituted or unsubstituted C₆-C₃₀ arylene, and both R_{f} and R_{g} are none; or
   C_{b} and R_{b} form a substituted or unsubstituted C₆-C₃₀ arylene, and both R_{c} and R_{d} are none;
   wherein, when Cₐ and Rₑ form a substituted or unsubstituted C₆-C₃₀ arylene, R_{b}, R_{c} and R_{d} independently of each other are defined as any one of Rₑ, R_{d}, R_{f} and R_{g} under (A);
   wherein, when C_{b} and R_{b} form a substituted or unsubstituted C₆-C₃₀ arylene, Rₑ, R_{f} and R_{g} independently of each other are defined as any one of Rₑ, R_{d}, R_{f} and R_{g} under (A).

Preferably, the at least one secondary amine (iii) has the following formula (I)

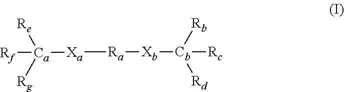

wherein —Rₐ— is selected from the group consisting of —Z₁—, —Z₂—, —Z₃, —Z₄—, —Z₅, —Z₆, —Z₇, —, —Z₇—, —Z₈—, —Z₉—, —Z₁₀—, —Z₁₁—, —Z₁₃—, —Z₁—Z₅—, —Z₅—Z₁—Z₅—, —Z₁—Z₆—, —Z₁—Z₇—, —Z₁—Z₈—, —Z₁—Z₉—, —Z₉—Z₁—Z₉—, —Z₁—Z₁₁, —Z₃—Z₅—, —Z₃—Z₆—, —Z₃—Z₇—, —Z₃—Z₃—, —Z₃—Z—, —Z₃—Z₁₁, —Z₁—Z₅—Z₁—, —Z₁—Z₉—Z₁—, —Z₉—Z₁(—Z₁₁—Z₁)ₙ—Z₉—, with n=1, 2, 3, 4, 5, or 6, and —Z₁—Z₁—Z₁—; wherein
—Z₁— is a substituted or unsubstituted, linear or branched C₁-C₃₀ alkylene;
—Z₂— is a substituted or unsubstituted, linear or branched 2- to 300,000-membered heteroalkylene;
—Z₃— is a substituted or unsubstituted, linear or branched C₂-C₃₀ alkenylene;
—Z₄— is a substituted or unsubstituted, linear or branched 3- to 30-membered heteroalkenylene;
—Z₅— is a substituted or unsubstituted C₅-C₃₀ cycloalkylene;
—Z₆— is a substituted or unsubstituted 5- to 30-membered heterocycloalkylene;
—Z₇— is a substituted or unsubstituted C₅-C₃₀ cycloalkenylene;
—Z₈— is a substituted or unsubstituted 5- to 30-membered heterocycloalkenylen;
—Z₉— is a substituted or unsubstituted C₆-C₃₀ arylene;
—Z₁₀— is a substituted or unsubstituted 5- to 30-membered heteroarylene;
—Z₁₁— is a C₆-C₃₀ arylene substituted with —NHR or —OR, wherein R is selected from the group consisting of H and substituted or unsubstituted, linear or branched C₁-C₁₀ alkyl; —Z₁₂— is —N(R_{f})—;
—Z₁₃— is a substituted or unsubstituted 5- to 30-membered heterocycloalkylene, wherein at least one of the one or more heteroatoms of Z₁₃ is from Xₐ;
wherein Cₐ is a C atom or a H atom and C_{b} is a C atom or a H atom, wherein at least one of Cₐ and C_{b} is a C atom;
wherein Xₐ is a O atom or NH and X_{b} is a O atom or NH, wherein at least one of Xₐ and X_{b} is NH, with the condition that for Xₐ and/or X_{b} being NH, the respective Cₐ and/or C_{b} is/are C atom(s);
wherein
   (A) Rₑ, R_{d}, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, lin-ear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cyclo-alkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl, R_{b} and Rₑ independently of each other are defined as Rₑ, R_{d}, R_{f} and R_{g}; or R_{b} and Rₑ are none, and Cₐ and C_{b} are connected to each other via a single bond forming a heterocycle consisting of Cₐ, C_{b}, Xₐ, X_{b} and Rₐ; or
(B) Cₐ and Rₑ form a substituted or unsubstituted C₆-C₃₀ arylene, more preferably a phenyl, and both R_{f} and R_{g} are none; and C_{b} and R_{b} form a substituted or unsubstituted C₆-C₃₀ arylene, more preferably a phenyl, and both R_{c} and R_{d} are none.

Preferably, each of Cₐ and C_{b} is a C atom.

Preferably, Xₐ is NH, X_{b} is NH, the secondary amine (iii) having the following formula (II)

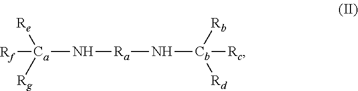

wherein Cₐ, C_{b}, R_{b}, R_{C}, R_{d}, Rₑ, R_{f}, R_{g}, and —Rₐ— are as defined in formula (I).
Preferably, —Rₐ— is selected from the group consisting of —Z₁—, —Z₂—, —Z₅—, —Z₉—, —Z₁₀—, —Z₁—Z₅—, —30 Z₅—Z₁—Z₅—, —Z₉—Z₁—Z₉—, —Z₁—Z₅—Z₁—, —Z₁—Z₉—Z₁—, and —Z₉—Z₁(—Z₁₁—Z₁)ₙ—Z₉—, wherein n=1, 2, 3, 4, 5, or 6, preferably selected from the group consisting of —Z₂—, —Z₉—Z₁—Z₉—, and —Z₉—Z₁(—Z₁₁—Z₁)ₙ—Z₉—, wherein n=1, 2, 3, 4, 5, or 6, more preferably selected from the group consisting of —Z₂— and —Z₉—Z₁(—Z₁₁—Z₁)—Z₉—, wherein n=1, 2, 3, 4, 5, or 6.

Preferably, —Z₁— is selected from the group consisting of —CH₂—, —CH₂—CH₂—, —CH₂—CH(CH₃)—, —CH(CH₃)—CH₂—, —CH(CH₃)—CH₂—CH₂—, —CH₂—CH₂—CH(CH₂CH₃)—, —C(CH₃)₂—, —CH₂—C(CH₃)₂—CH₂—, —CH₂—CH(CH₃)—CH₂—C(CH₃)₂—CH₂—CH₂—, —CH₂—C(CH₃)₂—CH₂—CH(CH₃)—CH₂—CH₂—, —(CH₂)₃—, —(CH₂)₄—, —(CH₂)₅—, —(CH₂)₆—, —(CH₂)₈—, and —(CH₂)₁₀—.

Preferably, when R, is selected from the group consisting of —Z₁—Z₅—, —Z₅—Z₁—Z₅—, —Z₁—Z₆—, —Z₁—Z₇—, —Z₁—Z—, —Z₁—Z₉—, —Z₉—Z₁—Z₉—, —Z₁—Z₁₀—, —Z₁—Z₅—Z₁—, —Z₁—Z₉—Z₁—, —Z₉—Z₁(—Z₁—Z₁)ₙ—Z₉—, with n=1, 2, 3, 4, 5, or 6, and —Z₁—Z₁₂—Z₁—, —Z₁— is —CH₂—.

Preferably, —Z₉— is selected from the group consisting of phenylene, naphthylene, bi-phenylene, fluorenylene, and indenyl, wherein —Z₉—more preferably is phenylene.

Preferably, phenylene is selected from the group consisting of ortho-phenylene, meta-phenylene, and para-phenylene, more preferably ortho- and para-phenylene.

Preferably, —Rₐ— is —Z_{y}—Z₁—Z₉—, with —Z₉—is phenylene, more preferably para-phenylene, and —Z₁— is —CH₂—.

Preferably, —Rₐ— is —Z₉—Z₁(—Z₁₁—Z₁)ₙ—Z₉—, wherein n=1, 2, 3, 4, 5, or 6, with —Z₉— is phenylene and —Z₁— is —CH₂— and wherein —Z₁₁— is a C₆-arylene substituted with —NHR.

Preferably, in —Z₁₁—, R is —C(Rₕ)(Rᵢ)(Rⱼ), wherein Rₕ, Rᵢ and Rⱼ independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₁alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl. More preferably, Rₕ, Rᵢ and Rⱼ independently of each other are selected from the group consisting of hydrogen, linear or branched, substituted or unsubstituted C₁-C₃₀alkyl. More preferably, Rₕ, Rᵢ and Rⱼ independently of each other are selected from the group consisting of hydrogen, methyl, ethyl, propyl, iso-propyl, butyl, pentyl, hexyl, octyl, dodecyl, sec-butyl, tert-butyl, sec-isopentyl, 2-pentyl, 2-methyl-4-pentyl, 3-pentyl, 2-methyl-pentyl, 2,6-dimethyl-4-heptyl, 3-pinanyl-methyl, cyclopentyl, cyclohexyl, dicyclohexylmethyl, cyclohexylmethyl, cyclododecyl, phenyl, benzyl, and cyclohexyl(phenyl)methyl, preferably selected from the group consisting of hydrogen, methyl, and ethyl, more preferably selected from the group consisting of hydro-gen, methyl and ethyl. More preferably, any one of Rₕ, Rᵢ and Rⱼ is H, and one of Rₕ, Rᵢ and Rⱼ other than the one being H is CH₃. More preferably, one of Rₕ, Rᵢ, and Rⱼ, other than the one being CH₃ or H, is an ethyl group.

Alternatively, preferably, in —Z₁₁—, R is —C(Rₕ)(Rᵢ)(Rⱼ), wherein C and Rₕ form a substituted or unsubstituted C₆-C₃₀ arylene, and both Rᵢ and Rⱼ are none. For example, —Z₁₁— can be —NH—Ph.

In the context of the present invention, preferably, —Z₂— is a substituted or unsubstituted, linear or branched 2- to 500-membered heteroalkylene, more preferably a substituted or unsubstituted, linear or branched 2- to 35-membered heteroalkylene, more preferably a substituted or unsubstituted, linear or branched 2- to 30-membered heteroalkylene.

More preferably, —Z₂— is selected from the group consisting of —CH₂—CH₂—NH—CH₂—CH₂—, —CH₂—CH₂—NH—CH₂—CH₂—CH₂—, —CH(CH₃)—CH₂—NH—CH₂—CH(CH₃)—, —CH₂—CH₂—CH₂—N(CH₃)—CH₂—CH₂—CH₂—, —CH₂—CH₂—CH₂—NH—CH₂—CH₂—CH₂—, —CH₂—CH₂—CH₂—NH—CH₂—CH₂—NH—CH₂—CH₂—CH₂—, —CH₂—CH₂—NH—CH₂—CH₂—NH—CH₂—CH₂—, —CH₂—CH₂—NH—CH₂—CH₂—NH—CH₂—CH₂— NH—CH₂—CH₂—, —CH₂—CH₂—O—CH₂—CH₂—, —CH₂—CH₂—CH₂—O—CH₂—CH₂—O—CH₂—CH₂—O—CH₂—CH₂—CH₂—, —CH₂—CH₂—CH₂—O—CH₂—CH₂—CH₂—CH₂—O—CH₂—CH₂—CH₂—, —CH₂—CH₂—O—CH₂—CH₂— O—CH₂—CH₂—, —(CH(CH₃)—CH₂O—)₁₋₁₀₀—CH(CH₃)—CH₂—, —[CH(CH₃)—CH₂—]ₘ—CH₂C(Rₓ) (R_{y1})—[O—CH₂CH(CH₃)]ₒ₁—, wherein Rₓ₁ is —CH₂—CH₃, wherein R_{y1} is [—O—CH₂—CH(CH₃)]ₙ₁—NH—C(Rₙ)(Rₘ)(Rₙ), wherein m1+n1+o1 is in the range of from 5 to 6, —[CH(CH₃)—CH₂—O]ₘ₂—CH₂—CH(R_{y2})—[O—CH₂—CH(CH₃)]ₒ₂, wherein R_{y2} is [—O—CH₂—CH(CH₃)]ₙ₂—NH—C(Rᵢ)(Rₘ)(Rₙ), and wherein m2+n2+o2 is in the range of 45 to 85, —[CH(CH₃)—CH₂O]ₘ3-[CH₂—CH₂-O]₃ [CH₂CH(CH₃)—O]₃—CH₂—CH(CH)₃—, wherein n3 is in the range of from 8 to 10 and m3+o3 is in the range of from 3 to 4, or wherein n3 is in the range of from 12 to 13 and m3+o3 is in the range of from 5 to 7, or wherein n3 is in the range of from 38 to 40 and m3+o3 is in the range of from 5 to 7, —[CH-CH₂O]ₘ₄CH₂CH₂—, wherein m4 is in the range of from 8 to 250, and —[CH₂—CH₂—NH]ₘ₅, wherein m5 is in the range of from 10 to 100,000.

More preferably, —Z₂— is more preferably —[CH(CH₃)—CH₂—O]ₘ₁—CH₂—C(Rₓ)(R_{y1})—CH₂[O—CH₂—CH(CH₃)]ₒ₁—, wherein Rₓ₁ is —CH₂—CH₃, wherein R_{y1} is —CH₂—[O—CH₂—CH(CH₃)]ₙ₁—NH—C(Rₗ)(Rₘ)(Rₙ), wherein m1+n1+o1 is in the range of 5 to 6.

Preferably, in one or more of R_{y1} and R_{y2}, Rₗ, Rₘ and Rₙ independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl. More preferably, Rₗ, Rₘ and Rₙ independently of each other are selected from the group consisting of hydrogen, linear or branched, substituted or unsubstituted C₁-C₃₀alkyl. More preferably, R₁, Rₘ and Rₙ independently of each other are selected from the group consisting of hydrogen, methyl, ethyl, propyl, iso-propyl, butyl, pentyl, hexyl, octyl, dodecyl, sec-butyl, tert-butyl, sec-isopentyl, 2-pentyl, 2-methyl-4-pentyl, 3-pentyl, 2-methyl-pentyl, 2,6-dimethyl-4-heptyl, 3-pinanyl-methyl, cyclopentyl, cyclohexyl, dicyclohexylmethyl, cyclohexylmethyl, cyclododecyl, phenyl, benzyl, and cyclohexyl(phenyl)methyl, preferably selected from the group consisting of hydrogen, methyl, and ethyl, more preferably selected from the group consisting of hydro-gen, methyl and ethyl. More preferably, any one of Rₗ, Rₘ and Rₙ is H, and one of Rₗ, Rₘ and Rₙ other than the one being H is CH₃. More preferably, one of Rₗ, Rₘ and Rₙ, other than the one being CH₃ or H, is an ethyl group. Alternatively, preferably, in one or more of R_{y1} and R_{y2}, C and Rₗ form a substituted or unsubstituted C₆-C₃₀ arylene, and both Rₘ and Rₙ are none. For example, R_{y1} can be —CH₂—[O—CH₂—CH(CH₃)]ₙ₁—NH—Ph and R_{y2} can be [—O—CH₂—CH(CH₃)]ₙ₂—NH—Ph.

Preferably, —Z₃— is selected from the group consisting of —CH═CH— and —CH₂—CH═CH—.

Preferably, —Z₄— is selected from the group consisting of —CH═CH—NH—, —CH═CH—O—, —CH═CH—CH₂—O—.

Preferably, —Z₅— is selected from the group consisting of cyclohexa-1,4ylene, cyclohexa-1,3ylene

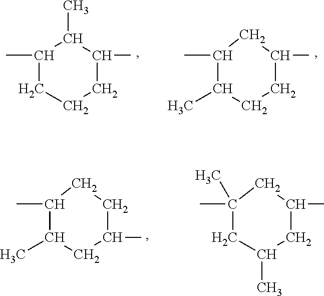

2,6-diyl-norbornane.

Preferably, —Z₆— is selected from the group consisting of 1,5-dioxaoctylene and 4,8-dioxabicyclo[3.3.0]octylene.

Preferably, —Z₇— is selected from the group consisting of cyclopent-1,2-en-3,5ylene, 3cyclo-hexene-1,2ylene, 2,5cyclohexadiene-1,4ylene, cyclohex-1,2-en-3,5ylene, 2,5cyclohexa-diene-1,4-ylene and cyclohept-1,2-en-3,5ylene.

Preferably, —Z₁₀— is triazinylene, more preferably one or more of victriazinylene, asymtriazinylene, and symtriazinylene.

Preferably, Rₑ, R_{d}, R_{f} and R_{g} independently of each other are selected from the group consisting of hydrogen, methyl, ethyl, propyl, iso-propyl, butyl, pentyl, hexyl, octyl, dodecyl, sec-butyl, tert-butyl, sec-isopentyl, 2-pentyl, 2-methyl-4-pentyl, 3-pentyl, 2-methyl-pentyl, 2,6-dimethyl-4-heptyl, 3-pinanyl-methyl, cyclopentyl, cyclohexyl, dicyclohexylmethyl, cyclohexylmethyl, cyclododecyl, phenyl, benzyl, cyclohexyl(phenyl)methyl, and —C(OH)H-Rₖ, more preferably selected from the group consisting of hydrogen, methyl, and ethyl, more preferably selected from the group consisting of hydrogen, methyl and ethyl,

wherein Rₖ is selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl.

Preferably, R_{b} and Rₑ independently of each other are selected from the group consisting of hydrogen, methyl, ethyl, propyl, iso-propyl, butyl, pentyl, hexyl, octyl, dodecyl, sec-butyl, tert-butyl, sec-isopentyl, 2-pentyl, 2-methyl-4-pentyl, 3-pentyl, 2-methyl-pentyl, 2,6-dimethyl-4-heptyl, 3-pinanylmethyl, cyclopentyl, cyclohexyl, dicyclohexylmethyl, cyclohexylmethyl, cyclododecyl, phenyl, benzyl, and cyclohexyl(phenyl)methyl, more preferably selected from the group consisting of hydrogen, methyl, and ethyl.

Preferably, any one of R_{b}, Rₑ, and R_{d} is H, and any one of Rₑ, R_{f}, and R_{g} is H; wherein one of R_{b}, Rₑ, and R_{d} other than the one being H is CH₃, and one of Rₑ, R_{f}, and R_{g} other than the one being H is CH₃.

Preferably, any one of R_{b}, Rₑ, and R_{d} is an ethyl group, and any one of Rₑ, R_{f}, and R_{g} is an ethyl group; more preferably wherein one of R_{b}, Rₑ, and R_{d} other than the one being an ethyl group is H, one of Rₑ, R_{f}, and R_{g} other than the one being an ethyl group is H, one of R_{b}, Rₑ, and R_{d} other than the one being an ethyl group or H is CH₃, and one of Rₑ, R_{f}, and R_{g} other than the one being an ethyl group or H is CH₃.

Preferably, the at least one secondary amine (iii) is

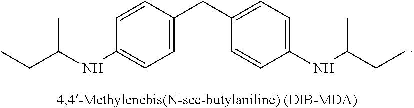 [SMILES: CCC(C)Nc1ccc(Cc2ccc(NC(C)CC)cc2)cc1]

Alternatively, preferably, the at least one secondary amine (iii) is a sec-butyl-modified poly-ether amine, CH₃—CH₂—CH(CH₃)—NH—[CH(CH₃)—CH₂—O], —CH₂—C(Rₓ₁)(R_{y1})—CH₂—[O—CH₂—CH(CH₃)]ₒ₁—NH—CH(CH₃)—CH₂—CH₃, wherein Rₓ₁ is —CH₂—CH₃, wherein R_{y1} is —CH₂—[O—CH₂—CH(CH₃)]ₙ₁—NH—CH(CH₃)—CH—CH₃, wherein m1+n1+o1 is in the range of 5 to 6.

Preferably, the at least one secondary amine (iii) is

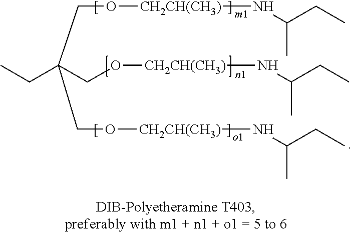

Alternatively, it is preferred that the at least one secondary amine (iii) is DIB-butanediamine (N,N′-di-sec-butyl-1,4-butanediamine). Also 2-(ethylamino)ethanol may be used according to the present invention.

In the context of the present invention, suitable isocyanates are known per se to a person skilled in the art.

Preferably, the at least one isocyanate (i) has a NCO functionality of 2 or more, more prefer-ably of 2 or 3.

Preferably the at least one isocyanate (i) is a mixture of an isocyanate having a NCO functionality of 2 and an isocyanate having a NCO functionality of 3 or more, more preferably the at least one isocyanate (i) is a mixture of an isocyanate having a NCO functionality of 2 and an isocyanate having a NCO functionality of 3.

Preferably, the at least one isocyanate (i) is selected from the group consisting of monomeric methylene diphenylene diisocyanate (mMDI), polymethylene polyphenylene polyisocyanate (pMDI), a mixture of monomeric methylene diphenylene diisocyanate and polymethylene polyphenylene polyisocyanate (MDI), tolylene diisocyanate (TDI), isomers of xylylene diisocyanate (XDI), isomers of diisocyanatobenzene, xylene 2,6-diisocyanate, naphthylene 1,5-diisocyanate (1,5-NDI), butane 1,4-diisocyanate, pentane 1,5-diisocyanate (PDI), hexane 1,6-diisocyanate (HDI), octane 1,8-diisocyanate, nonane 1,9-diisocyanate, decane 1,10-diisocyanate, 2,2-dimethylpentane 1,5-diisocyanate, 2-methylpentane 1,5-diisocyanate (MPDI), 2,4,4(or 2,2,4)-trimethylhexane 1,6-diisocyanate (TMDI), cyclohexane 1,3- and 1,4-diisocyanate, 1-isocyanato-3,3,5-trimethyl-5-isocyanatomethylcyclohexane (IPDI), methylene-bis(cyclohexyl isocyanate) (H12MDI), 2,4- or 2,6-diisocyanato-1-methylcyclohexane (H6TDI), 1-isocyanato-1-methyl-4(3)-isocyanatomethylcyclohexane (AMCI), 1,3-bis(isocyanatomethyl)cyclohexane, 1,4-bis(isocyanatomethyl)cyclohexane, bis(isocy-anatomethyl)norbornane (NBDI), triphenylmethane-4,4′,4″-triisocyanate, toluene-2,4,6-triyl triisocyanate, ethyl ester 1-lysine triisocyanate, triisocyanatocyclohexane, tris(isocy-anatomethyl)cyclohexane, triisocyanatomethylcyclohexane, 1,8-diisocyanato-4-(isocy-anatomethyl)octane, undecane 1,6,11-triisocyanate, 1,7-diisocyanato-4-(3-isocyanatopro-pyl)heptane, 1,6-diisocyanato-3-(isocyanatomethyl)hexane, 2,2-bis[[4-(isocyanatomethyl)phenyl]methyl]butyl n-[[4-(isocyanatomethyl)phenyl]methyl]carbamate, (2,4,6-triox-otriazine-1,3,5(2h,4h,6h)-triyl)tris(hexamethylene) isocyanate, 1,3,5-triisocyanatobenzene, tris(isocyanatohexyl)biuret, 3,3′,3″-[(1h,3h,5h)-2,4,6-trioxo-1,3,5-triazine-1,3,5-tri-yltris(methylene)]tris[3,5,5-trimethylcyclohexyl]triisocyanate, 1,3,5-triazine-2,4,6-triisocy-anate, 2,4,4′-triisocyanato-dicyclohexylmethane, triisocyanate triphenylthiophosphate, 2,4,4′-diphenylethertriisocyanate, 1,3-Bis(3-isocyanato-4-methylphenyl)-1,3-diazetidine-2,4-dione, and a mixture of two or more thereof,

more preferably selected from the group consisting of monomeric methylene diphenylene diisocyanate (mMDI), polymethylene polyphenylene polyisocyanate (pMDI), a mixture of monomer methylene diphenylene diisocyanate and polymethylene polyphenylene polyisocy-anate (MDI), tolylene diisocyanate (TDI), naphthylene 1,5-diisocyanate (1,5-NDI), 1,4-diiso-cyanate, pentane 1,5-diisocyanate (PDI), hexane 1,6-diisocyanate (HDI), methylene-bis(cyclohexyl isocyanate) (H12MDI), such as dicyclohexylmethane 4,4′- or 2,4′- or 2,2′-diisocya-nate, and a mixture of two or more thereof.

Preferably, the at least one isocyanate (i) is selected from the group consisting of monomeric methylene diphenylene diisocyanate (mMDI), polymethylene polyphenylene polyiso-cyanate (pMDI), a mixture of monomer methylene diphenylene diisocyanate and polymethylene polyphenylene polyisocyanate (MDI) and tolylene diisocyanate (TDI).

Preferably, the at least one isocyanate (i) is selected from the group consisting of methylene diphenylene diisocyanate (mMDI), polymethylene polyphenylene polyisocyanate (pMDI) and a mixture of monomeric methylene diphenylene diisocyanate and polymethylene polyphenylene polyisocyanate (MDI), more preferably selected from the group consisting of monomeric methylene diphenylene diisocyanate (mMDI) and a mixture of monomeric methylene diphenylene diisocyanate and polymethylene polyphenylene polyisocya-nate (MDI).

More preferably, tolylene diisocyanate (TDI) comprises, more preferably consists of, one or more of 2,4-TDI and 2,6-TDI.

More preferably the monomeric methylene diphenylene diisocyanate (mMDI) comprises, more preferably consists of, one or more 4,4′-methylene(diphenyl diisocyanate) (4,4′-MDI), 2,2′—methylene (diphenyl diisocyanate) (2,2′-MDI) and 2,4′—methylene (diphenyl diisocya-nate) (2,4′-MDI), more preferably 4,4′-methylene(diphenyl diisocyanate) (4,4′-MDI). More preferably, the at least one isocyanate (i) is a monomeric methylene diphenylene diisocya-nate (mMDI) which comprises, more preferably consists of, one or more 4,4′-methylene(di-phenyl diisocyanate) (4,4′-MDI), 2,2′—methylene (diphenyl diisocyanate) (2,2′-MDI) and 2,4′-methylene (diphenyl diisocyanate) (2,4′-MDI), more preferably 4,4′-methylene(diphenyl diisocyanate) (4,4′-MDI).

Other possible isocyanates are mentioned by way of example in “Kunststoffhandbuch [Plastics handbook], volume 7, Polyurethane [Polyurethanes]”, Carl Hanser Verlag, 3rd edition 1993, chapter 3.2 and 3.3.2.

Suitable polyols are known per se to a person skilled in the art.

Principally, any polyol conventionally used for the preparation of polyurethanes can be used as polyol. The type of polyol may depend on the desired purpose of the application. Suitable polyols are polyester polyols, including in particular aliphatic polyester polyols and aliphatic aromatic polyester polyols, polyestercarbonate polyols, polyetherester polyols, aliphatic polycarbonate polyols, polyacrylate polyols, polyolefine polyols, aliphatic polyetherols and mixtures thereof. Preferably, the at least one polyol is selected from polyester polyols, in particular aliphatic polyester polyols and aliphatic aromatic polyester polyols, aliphatic polycarbonate polyols, aliphatic polyetherols and mixtures thereof. In particular, the at least one polyol comprises a polyester polyol and/or an aliphatic polyether polyol as described herein.

Especially, the at least one polyol is selected from polyester polyols, aliphatic polyether polyols and combinations thereof.

Preferably, the at least one polyol (i) is selected from the group consisting of polyester polyol, polyetherester polyol, polycarbonate polyol, polyacrylate polyol, polyolefine polyol, polyether polyol, and mixtures thereof.

More preferably, the at least one polyol (i) is selected from the group consisting of polyester polyol and polyether polyol.

Polyester polyols suitable as polyol are in particular aliphatic polyesterols and aliphatic/aromatic polyesterols, i.e. polyesterols which are based on a dicarboxylic acid component selected from aliphatic dicarboxylic acids, cycloaliphatic dicarboxylic acids, aromatic dicarboxylic acids and combinations and a diol component, selected from aliphatic diols and cycloaliphatic diols and polyetherpolyols.

Suitable aliphatic diols for preparing the polyester polyols generally have usually 2 to 20 C atoms, in particular 3 to 10 C atoms. Examples of aliphatic diols are ethylene glycol, pro-pane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol 1,7-heptanediol, 1,8-octanediol, 1,2-octanediol, 1,9-nonanediol, 1,2-decanediol, 1,10-decanediol, 1,2-dodecanediol, 1,12-dodec-anediol, 1,5-hexadiene-3,4-diol, neopentyl glycol (2,2-dimethylpropane-1,3-diol), 2,2-dieth-ylpropane-1,3-diol, 2-methyl-2-ethylpropane-1,3-diol, 2-methyl-2,4-pentanediol, 2,4-dimethyl-2,4-pentanediol, 2-ethyl-1,3-hexanediol, 2,5-dimethyl-2,5-hexanediol, 2,2,4-trimethyl-1,3-pentanediol, pinacol, diethylene glycol, triethylene glycol, dipropylene glycol, and tripropylene glycol Suitable cycloaliphatic diols for preparing the polyester polyols generally have usually 4 to 20 C atoms, in particular 5 to 10 C atoms. Examples of cycloaliphatic diols are cyclopentanediol, cyclohexane-1,4-diol, cyclohexane-1,2-dimethanol, cyclohexane-1,3-dimethanol, cyclohexane-1,4-dimethanol and 2,2,4,4-tetramethylcyclobutane-1,3-diol. Also suitable diols for preparing the polyester polyols are polyether diols, in particular polyethylene glycols HO(CH₂CH₂O)ₙ-H, higher polypropylene glycols HO(CH[CH₃]CH₂O)ₙ-H, where n is an integer and n>4, e.g., 4 to 20, and polyethylene-polypropylene glycols, more particularly those having 4 to 20 repeating units, it being possible for the sequence of the ethylene oxide and propylene oxide units to be blockwise or random, and polytetramethylene glycols, more particularly those having 4 to 20 repeating units, and poly-1,3-propanediols, more particularly those having 4 to 20 repeating units.

Preferred dicarboxylic acids for preparing the polyester polyols are aromatic dicarboxylic acids, such as phthalic acid, isophthalic acid and, terephthalic acid, cycloaliphatic dicarboxylic acids having preferably from 8 to 12 carbon atoms, such as tetrahydrophthalic acid, hexahydrophthalic acid, cyclohexanedicarboxylic acid, and aliphatic dicarboxylic acids having preferably from 3 to 40 carbon atoms, such as malonic acid, succinic acid, 2-methylsuccinic acid, glutaric acid, 2-methylglutaric acid, 3-methylglutaric acid, α-ketoglutaric acid, adipic acid, pimelic acid, azelaic acid, sebacic acid, brassylic acid, fumaric acid, 2,2-dimethylglutaric acid, suberic acid, diglycolic acid, oxaloacetic acid, glutamic acid, aspartic acid, itaconic acid and maleic acid and dimer fatty acids, such as the dimer fatty acid of octadecadienoic acids or dimeric fatty acids obtained by dimerization of other polyunsaturated fatty acids or fatty acid mixtures [CAS 61788-89-4].

The dicarboxylic acid used in preparing the polyester polyols may be the free acids or ester-forming derivatives thereof. Derivatives are understood preferably to be the corresponding anhydrides, monoalkyl and dialkyl esters, preferably mono- and di-C₁-C₄ alkyl esters, more preferably monomethyl and dimethyl esters, and also the corresponding monoethyl and di-ethyl esters, and additionally monovinyl and divinyl esters, and also mixed esters, examples being mixed esters with different C₁-C₄ alkyl components.

Amongst polyester polyols preference is given to polyester polyols based on a diol component selected from the group consisting of butanediol, neopentyl glycol, hexanediol, ethylene glycol, diethylene glycol and mixtures thereof, and a dicarboxylic acid component selected from the group consisting of adipic acid, phthalic acid, isophthalic acid and combinations thereof. Particular preference is given to polyester polyols based on butanediol and/or neopentyl glycol and/or hexanediol with adipic acid and/or phthalic acid and/or isophthalic acid.

Polyester polyols suitable as polyol also include polylactones, in particular poly-C4-C12-lac-tones, especially polycaprolactones (PCL). Polylactones refer to aliphatic polyesters obtain-able by ring-opening polymerization of lactones, in particular C4-C12-lactones, especially epsilon-caprolactones (ε—caprolactone). Polycaprolactones have repeating monomer units of the general formula [—O—CHR—(CH₂)ₘ-CO—], in which m is 4 to 10, in case of caprolactone m=4, and R is hydrogen. In the context of the invention, the term polycaprolactone is understood to mean both homopolymers of epsilon-caprolactone and copolymers of epsilon-caprolactone. Suitable copolymers are, for example, copolymers of epsilon-caprolactone with monomers selected from the group consisting of lactic acid, lactide, hydroxyacetic acid and glycolide. The polyester polyols are customary components which are known e.g. from Ullmanns Encyklopsdie der technischen Chemie [Ullmann's Encyclopedia of Industrial Chemistry], 4th edition, volume 19, pp. 62 to 65.

Aliphatic polyether polyols suitable as polyol are, for example, the polyaddition products of C2-C4-alkylene oxides, such as ethylene oxide, propylene oxide, 1,2-butylene oxide, 2,3-butylene oxide or 2-methylpropylene oxide. Further suitable polymeric polyols are aliphatic polyether polyols obtainable by condensation of polyhydric aliphatic alcohols, aliphatic poly-ether polyols obtained by alkoxylation of aliphatic polyhydric alcohols, amines and amino alcohols. Suitable polyhydric alcohols include ethylene glycol, 1,2-propylene glycol, 1,3-propylene glycol, 1,4-butanediol, neopentyl glycol, 1,6-hexanediol, trimethylolpropane, glycerol, pentaerythritol, triethanolamine (=tris(2-hydroxyethyl)amine), sorbitol or mixtures of these.

Suitable polyetherols have generally OH functionalities in the range of 1.5 to 3.0, in particular in the range of 1.8 to 2.5. Suitable polyetherols have preferably OH numbers in the range of 20 to 300 mg KOH/g and in particular in the range of 30 to 250 mg KOH/g. In the context of the present invention, the OH number is measured according to EN ISO 4629-1:2016 unless otherwise noted.

Generally, they have number average molecular weights Mn in the range of 400 to 10.000 g/mol, preferably of 500 to 5.000 g/mol, determined by gel permeation chromatography as described above. Preferred polyether components are polyethylene oxide polyols, polypropylene oxide polyols and polytetramethylene oxide polyols (poly-THF) having a molecular weight Mn of 400 to 10.000 g/mol, preferably of 500 to 5.000 g/mol. In this case, the poly-ether polyols of particularly low molecular weight may be water-soluble in the case of correspondingly high OH contents.

Preferably, the at least one polyol (ii) is polyether polyol, the polyether polyol more preferably being selected from the group consisting of polytetrahydrofuran, trifunctional polyether polyol containing secondary hydroxyl groups, polypropylene glycol, polyether polyol based on sucrose, tetrafunctional polyether polyol based on ethylenediamine and propylene oxide, and a mixture of two or more thereof, more preferably selected from the group consisting of polytetrahydrofuran and trifunctional polyether polyol containing secondary hydroxyl groups.

Preferably, the at least one polyol (ii) is a polyether polyol, the polyether polyol more prefer-ably being selected from the group consisting of polytetrahydrofuran (f=2 Mn=2000 g/mol, OH=56 mg KOH/g), trifunctional polyether polyol containing secondary hydroxyl groups (f=3, Mn=3500 g/mol, OH=48, Viscosity (25° C.)=600 mPa·s; or f=3, Mn=3000 g/mol, OH=53 mg KOH/g Viscosity (25° C.)=553 mPa·s), polypropylene glycol (f=2, Mn=500 g/mol, OH=248 mg KOH/g Viscosity (25° C.)=72 mPa·s), polyether polyol based on sucrose (f=5, Mn=500 g/mol, OH=490 mg KOH/g Viscosity (25° C.)=8450 mPa·s), tetrafunctional polyether polyol based on ethylenediamine and propylene oxide (f=4, Mn=300 g/mol, OH=753 mg KOH/g Viscosity (25° C.)=42000 mPa·s), and a mixture of two or more thereof, more preferably selected from the group consisting of polytetrahydrofuran (f=2 Mn=2000 g/mol, OH=56 mg KOH/g) and trifunctional polyether polyol containing secondary hydroxyl groups (f=3, Mn=3500 g/mol, OH=48, Viscosity (25° C.)=600 mPa·s; or f=3, Mn=3000 g/mol, OH=53 mg KOH/g Viscosity (25° C.)=553 mPa·s). For viscosity at 25° C.:DIN 53 240 and for OH value DIN EN 12092.

Alternatively, aliphatic polycarbonate polyols suitable as polyol are obtainable by reaction of carbonic acid derivatives, for example diphenyl carbonate, dimethyl carbonate or phosgene, with diols. Useful diols of this kind include, for example, ethylene glycol, propan-1,2- and -1,3-diol, butane-1,3- and 1,4-diol, hexane-1,6-diol, octane-1,8-diol, neopentyl glycol, 1,4-bishydroxymethylcyclohexane, 2-methylpropane-1,3-diol, 2,2,4-trimethylpentane-1,3-diol, dipropylene glycol, polypropylene glycols, dibutylene glycol, polybutylene glycols, but also lactone-modified diols. The diol component preferably contains 40% to 100% by weight of hexane-1,6-diol and/or hexanediol derivatives, preferably those having ether or ester groups as well as terminal OH groups, for example products which are obtained by reaction of 1 mol of hexanediol with at least 1 mol, preferably 1 to 2 mol, of ε-caprolactone or by etherification of hexanediol with itself to give di- or trihexylene glycol. It is also possible to use polyether polycarbonate polyols. Amongst aliphatic polycarbonate polyols preference is given to polycarbonate polyols based on dimethyl carbonate and hexanediol and/or butane-diol and/or—-caprolactone. Very particular preference is given to polycarbonate polyols based on dimethyl carbonate and hexanediol and/or—-caprolactone. Preferred polycarbonate polyols have a molecular weight Mn of 400 to 10.000 g/mol, preferably of 500 to 5.000 g/mol, determined by gel permeation chromatography as described above.

Other possible polyols are mentioned by way of example in “Kunststoffhandbuch [Plastics handbook], volume 7, Polyurethane [Polyurethanes]”, Carl Hanser Verlag, 3rd edition 1993, chapter 3.1, 3.2 and 3.3.2.

Preferably, the at least one isocyanate (i), the at least one polyol (ii) and the at least one secondary amine (iii) are reacted in the absence of a solvent.

Preferably, the poly(urea urethane) polymer(PUU1) is obtainable or obtained by a process comprising reacting (i), (ii) and/or (iii), more preferably (i) and (ii), with at least one additive, wherein the at least one additive selected from the group consisting of benzoyl chloride and diethylene glycol bis-chloroformate.

Any other additive than those listed above known by the skilled person might be used for the reaction of (i), (ii) and/or (iii).

Preferably, the poly(urea urethane) polymer (PUU1) is obtainable or obtained in the absence of a catalyst.

Preferably, the poly(urea urethane) polymer (PUU1) is obtained or obtainable by a process comprising
reacting the at least one isocyanate (i) with the at least one polyol (ii), obtaining a pre-polymer, and
reacting the obtained pre-polymer with the at least one secondary amine (iii); or
reacting the at least one isocyanate (i) with the at least one secondary amine (iii), obtaining a pre-polymer, and
reacting the obtained pre-polymer with the at least one polyol (ii).

Preferably, the molar ratio of -NCO of the at least one isocyanate (i) relative to-OH of the at least one polyol (ii) is in the range of from 1:0.50 to 1:0.10, more preferably in the range of from 1:0.40 to 1:0.15, more preferably in the range of from 1:0.30 to 1:0.20.

Preferably, the molar ratio of -NCO of the at least one isocyanate (i) relative to —NH-of the at least one secondary amine (iii) is in the range of from 1:1.50 to 1:0.5, more preferably in the range of from 1:1.20 to 1:0.60, more preferably in the range of from 1:0.8 to 1:0.7.

Preferably, the reaction of the components (i), (ii) and/or (iii) is performed at a temperature in the range of from more than 0 to 200° C., more preferably in the range of from 1 to 200° C., more preferably in the range of from 10 to 150° C., more preferably in the range of from 20 to 90° C.

Preferably, the poly(urea-urethane) polymer (PUU1) is obtained or obtainable by a process further comprising curing the mixture of (i), (ii) and (iii), more preferably at a temperature in the range of from 90 to 200° C., more preferably in the range of from 100 to 150° C.

Preferably, the poly(urea-urethane) polymer (PUU1) is thermoplastic or thermoset.

Preferably the poly(urea-urethane) polymer (PUU1) of the present invention is a covalent adaptable polymer, preferably a covalent adaptable network (CAN) thermoset or covalent adaptable system (CAS)/thermoplastic.

Preferably the poly(urea-urethane) polymer (PUU1) of the present invention is recyclable.

Preferably the poly(urea-urethane) polymer has a solubility in toluene in the range of 0.05 1 to 1:1 g/mL (grams of dissolved polymer: mL of solvent) measured at a temperature of 110° C. and after a duration of at least 12 hours of heating at ambient pressure, more preferably the poly(urea-urethane) polymer has a solubility in toluene in the range of 0.075:1 to 0.5:1 g/mL (grams of dissolved polymer: mL of solvent) measured at a temperature of 110° C. and after a duration of at least 12 hours of heating at ambient pressure.

Preferably the poly(urea-urethane) polymer has a solubility in 1,3-dimethyl-2-imidazolidinone in the range of 0.05:1 to 1:1 g/mL (grams of dissolved polymer: mL of solvent) measured at a temperature of 130° C. and after a duration of at least 20 hours of heating at ambient pressure, more preferably the poly(urea-urethane) polymer has a solubility in an organic solvent in the range of 0.075:1 to 0.5:1 g/mL (grams of dissolved polymer: mL of solvent) measured at a temperature of 130° C. and after a duration of at least 20 hours of heating at ambient pressure.

Preferably the poly(urea-urethane) polymer has a melting point in the range of from 10° C. to 200° C. at 20 kN of pressure determined by hot press, more preferably in the range of from 50° C. to 190° C. at 20 kN of pressure, more preferably in the range of from 60° C. to 180° C. at 20 kN of pressure. According to the present invention, the for the determination of the melting point, a circle shaped press with a diameter of 17 cm was used (pressure of about 880 kPa, press brand: Fa. Weber Model number: PW20H of 2006).

The present invention further discloses to a poly(urea-urethane) polymer-based composite obtainable or obtained by
reacting the following components
   (i) at least one isocyanate;
   (ii) at least one polyol; and
   (iii) at least one secondary amine having the following formula (I)

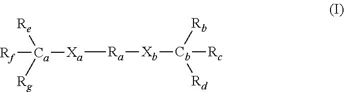

wherein —Rₐ— is selected from the group consisting of —Z₁—, Z₂—, —Z₃—, —Z₄—, —Z₅—, —Z₆—, —Z, —, —Z₇—, —Z₈—, —Z—, —Z₁₀—, —Z₁₁—, —Z₁₃—, —Z₁—Z₅—, —Z₅—Z₁—Z₅—, —Z₁—Z₆—, —Z₁—Z₇—, —Z₁—Z₈—, —Z₁—Z—, —Z₉-15 Z₁—Z—, —Z₁—Z₁₀—, —Z₃—Z₅—, —Z₃—Z₆—, —Z₃—Z₇—, —Z₃—Z₃—, —Z₃—Z₉—, —Z₃—Z₁₀—, —Z₁—Z₅—Z₁—, —Z₁—Z₉—Z₁—, —Z_{y}—Z₁(—Z₁₁—Z₁)ₙ—Z₉—, with n=1, 2, 3, 4, 5, or 6, and —Z₁—Z₁—Z₁—; wherein
—Z₁— is a substituted or unsubstituted, linear or branched C₁-C₃₀ alkylene;
—Z₂— is a substituted or unsubstituted, linear or branched 2- to 300,000-membered heteroalkylene;
—Z₃— is a substituted or unsubstituted, linear or branched C₂-C₃₀ alkenylene;
—Z₄— is a substituted or unsubstituted, linear or branched 3- to 30-membered heteroalkenylene;
—Z₅— is a substituted or unsubstituted C₅-C₃₀ cycloalkylene;
—Z₆— is a substituted or unsubstituted 5- to 30-membered heterocycloalkylene;
—Z₇— is a substituted or unsubstituted C₅-C₃₀ cycloalkenylene;
—Z— is a substituted or unsubstituted 5- to 30-membered heterocycloalkenylene;
—Z₉— is a substituted or unsubstituted C₆-C₃₀ arylene;
—Z₁₀— is a substituted or unsubstituted 5- to 30-membered heteroarylene;
—Z₁₁— is a C₆-C₃₀ arylene substituted with —NHR or —OR, wherein R is selected from the group consisting of H and substituted or unsubstituted, linear or branched C₁-C₁₀ alkyl;
—Z₁₂— is —N(R_{f})—;
—Z₁₃— is a substituted or unsubstituted 5- to 30-membered heterocycloalkylene, wherein at least one of the one or more heteroatoms of Z₁₃ is from Xₐ;
wherein Cₐ is a C atom or a H atom and C_{b} is a C atom or a H atom, wherein at least one of Cₐ and C_{b} is a C atom;
wherein Xₐ is a O atom or NH and X_{b} is a O atom or NH, wherein at least one of Xₐ and X_{b} is NH, with the condition that for Xₐ and/or X_{b} being NH, the respective Cₐ and/or C_{b} is/are C atom(s);
wherein
   (A) Rₑ, R_{d}, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, lin-ear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cyclo-alkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl,
   R_{b} and Rₑ independently of each other are defined as Rₑ, R_{d}, R_{f} and R_{g}; or R_{b} and Rₑ are none, and Cₐ and C_{b} are connected to each other via a single bond forming a heterocycle consisting of Cₐ, C_{b}, Xₐ, X_{b} and Rₐ; or
   (B) Cₐ and Rₑ form a substituted or unsubstituted C₆-C₃₀ arylene, and both R_{f} and R_{g} are none; and
   C_{b} and R_{b} form a substituted or unsubstituted C₆-C₃₀ arylene, and both R_{c} and R_{d} are none; or
   (C)—Cₐ and Rₑ form a substituted or unsubstituted C₆-C₃₀ arylene, and both R_{f} and R_{g} are none; or
   C_{b} and R_{b} form a substituted or unsubstituted C₆-C₃₀ arylene, and both R_{c} and R_{d} are none;
   wherein, when Cₐ and Rₑ form a substituted or unsubstituted C₆-C₃₀ arylene, R_{b}, Rₑ and R_{d} independently of each other are defined as any one of Rₑ, R_{d}, R_{f} and R_{g} under (A);
   wherein, when C_{b} and R_{b} form a substituted or unsubstituted C₆-C₃₀ arylene, Rₑ, R_{f} and R_{g} independently of each other are defined as any one of Rₑ, R_{d}, R_{f} and R_{g} under (A),
obtaining a mixture, preferably a polymer; and
bringing in contact the obtained mixture, preferably the obtained polymer, with (iv):
   (iv) a filler, the filler being selected from the group consisting of glass fibers, carbon fibers, mineral fibers, textiles, metal meshs, metal fibers, metal rods, carbonates, wood, and a mixture of two or more thereof.

Preferably, the at least one secondary amine (iii) has the following formula (I)

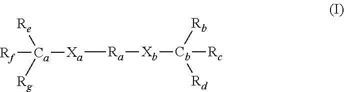

wherein —Rₐ— is selected from the group consisting of —Z₁—, —Z₂—, —Z₃—, —Z₄—, —Z₅—, —Z₆—, —Z, —, —Z₇—, —Z₈—, —Z—, —Z₁₁, —Z₁₁—, —Z₁₃—, —Z₁—Z₅—, —Z₅—Z₁—Z₅—, —Z₁—Z₆—, —Z₁—Z₇—, —Z₁—Z₈—, —Z₁—Z—, —Z₉—Z₁—Z—, —Z₁—Z₁₀—, —Z₃—Z₅—, —Z₃—Z₆—, —Z₃—Z₇—, —Z₃—Z₈—, —Z₃—Z₉—, —Z₃—Z₁₀—, —Z₁—Z₅—Z₁—, —Z₁—Z₉—Z₁—, —Z₉-Z₁(—Z₁₁—Z₁)ₙ-Z—, with n=1, 2, 3, 4, 5, or 6, and —Z₁—Z₁—Z₁—; wherein
—Z₁— is a substituted or unsubstituted, linear or branched C₁-C₃₀ alkylene;
—Z₂— is a substituted or unsubstituted, linear or branched 2- to 300,000-membered heteroalkylene;
—Z₃— is a substituted or unsubstituted, linear or branched C₂-C₃₀ alkenylene;
—Z₄— is a substituted or unsubstituted, linear or branched 3- to 30-membered heteroalkenylene;
—Z₅— is a substituted or unsubstituted C₅-C₃₀ cycloalkylene;
—Z₆— is a substituted or unsubstituted 5- to 30-membered heterocycloalkylene;
—Z₇— is a substituted or unsubstituted C₅-C₃₀ cycloalkenylene;
—Z— is a substituted or unsubstituted 5- to 30-membered heterocycloalkenylene;
—Z₉-is a substituted or unsubstituted C₆-C₃₀ arylene;
—Z₁₀— is a substituted or unsubstituted 5- to 30-membered heteroarylene;
—Z₁₁— is a C₆-C₃₀ arylene substituted with —NHR or —OR, wherein R is selected from the group consisting of H and substituted or unsubstituted, linear or branched C₁-C₁₀ alkyl;
—Z₁₂— is —N(R_{f})—;
—Z₁₃— is a substituted or unsubstituted 5- to 30-membered heterocycloalkylene, wherein at least one of the one or more heteroatoms of Z₁₃ is from Xₐ;
wherein Cₐ is a C atom or a H atom and C_{b} is a C atom or a H atom, wherein at least one of Cₐ and C_{b} is a C atom;
wherein Xₐ is a O atom or NH and X_{b} is a O atom or NH, wherein at least one of Xₐ and X_{b} is NH, with the condition that for Xₐ and/or X_{b} being NH, the respective Cₐ and/or C_{b} is/are C atom(s);
wherein
   (A) Rₑ, R_{d}, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, lin-ear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cyclo-alkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl,
   R_{b} and Rₑ independently of each other are defined as Rₑ, R_{d}, R_{f} and R_{g}; or R_{b} and Rₑ are none, and Cₐ and C_{b} are connected to each other via a single bond forming a heterocycle consisting of Cₐ, C_{b}, Xₐ, X_{b} and Rₐ; or
   (B) Cₐ and Rₑ form a substituted or unsubstituted C₆-C₃₀ arylene, more preferably a phenyl, and both R_{f} and R_{g} are none; and C_{b} and R_{b} form a substituted or unsubstituted C₆-C₃₀ arylene, more preferably a phenyl, and both R_{c} and R_{d} are none.

Preferably, the filler (iv) is glass fibers.

Preferably, the at least one polyol, the at least one isocyanate, and the at least one secondary amine are defined as above for the poly(urea-urethane) polymer.

Further, the present invention discloses a process for preparing a poly(urea-urethane) polymer to the present invention comprising:
(a) reacting at least one isocyanate (i) with at least one polyol (ii), obtaining a pre-polymer;
(b) bringing in contact the pre-polymer obtained in (a) with at least one secondary amine, the at least one secondary amine having the formula (I) as defined in the present invention, obtaining the poly(urea-urethane) polymer; or
(a′) reacting at least one isocyanate (i) with at least one secondary amine, the at least one secondary amine having the formula (I) as defined in the present invention, obtaining a pre-polymer;
(b′) bringing in contact the pre-polymer obtained in (a′) with at least one polyol (ii), poly(urea-urethane) polymer.

Preferably, (a) or (a′) is performed at a temperature in the range of from 0 to 200° C., more preferably in the range of from 1 to 200° C., more preferably in the range of from 10 to 150° C., more preferably in the range of from 20 to 90° C.

Preferably, one or more of (a) and (b) or one or more of (a′) and (b′), more preferably (a) and (b) or (a′) and (b′), are performed in the absence of a solvent.

Preferably, (b) or (b′) is performed at a temperature in the range of from 0 to 200° C., more preferably in the range of from 1 to 200° C., more preferably in the range of from 10 to 150° C., more preferably in the range of from 20 to 90° C.

Preferably, the process further comprises
(c) curing the mixture obtained in (b) or (b′), more preferably at a temperature in the range of from 90 to 150° C., more preferably in the range of from 100 to 120° C.

Furthermore, the present invention discloses a process for preparing a composite according to the present invention, the process comprising:
(1) providing a poly(urea urethane) polymer comprising
   (1.1) reacting at least one isocyanate (i) with at least one polyol (ii), obtaining a pre-polymer;
   (1.2) bringing in contact the pre-polymer obtained in (1.1) with at least one secondary amine, the at least one secondary amine (iii) having the formula (I) as defined in the present invention; or
   (1.1′) reacting at least one isocyanate (i) with at least one secondary amine, the at least one secondary amine (iii) having the formula (I) as defined in the present invention, obtaining a pre-polymer;
   (1.2′) bringing in contact the pre-polymer obtained in (1.1′) with at least one polyol (ii);
(2) bringing in contact the polymer obtained in (1.2) or (1.2′) with a filler (iv) as defined in the present invention.

Preferably, (1) is performed at a temperature in the range of from 0 to 200° C., more prefer-ably in the range of from 1 to 200° C., more preferably in the range of from 10 to 150° C., more preferably in the range of from 20 to 90° C.

Preferably, one or more of (1) and (2), more preferably (1) and (2), are performed in the absence of a solvent.

Preferably, bringing the polymer in contact with the filler in (2) is performed by mixing or pressing.

In the context of the present invention, it is also conceivable that other thermomechanical methods are used for step (2) such as injection molding, infusion.

Preferably, pressing is performed at a pressure in the range of from 10 to 30 kN, more preferably in the range of from 15 to 25 kN, more preferably in the range of from 18 to 22 kN.

Preferably, pressing is hot-pressing, more preferably performed at a temperature in the range of from 100 to 200° C., more preferably in the range of from 120 to 160° C., more preferably in the range of from 130 to 150° C.

Preferably, pressing is performed for a duration in the range of from 1 to 60 min, more preferably in the range of from 4 to 20 min, more preferably in the range of from 5 to 10 min.

Preferably, the process further comprises (1.3) curing the polymer obtained in (1.2) or (1.2′), more preferably at a temperature in the range of from 90 to 150° C., more preferably in the range of from 100 to 120° C.: or
(3) curing the polymer obtained in (2), more preferably at a temperature in the range of from 90 to 150° C., more preferably in the range of from 100 to 120° C.

The present invention further relates to a use of a poly(urea-urethane) polymer according to the present invention or a poly(urea-urethane) polymer composite according to the present invention as a recyclable material.

The present invention further discloses a recyclable article comprising a poly(urea-urethane) polymer according to the present invention or a poly(urea-urethane) polymer composite according to the present invention.

The present invention further discloses a process for shaping a poly(urea-urethane) polymer according to the present invention or a poly(urea-urethane) polymer obtainable or obtained by a process according to the present invention comprising: shaping the poly(urea-urethane) polymer, wherein shaping the polymer comprises
(x) applying pressure and heat to the poly(urea-urethane) polymer, obtaining a shaped body, more preferably a foil or a sheet; or
(x′) extruding the poly(urea-urethane) polymer, obtaining a shaped body, more preferably a granulate or a paste.

Preferably, the applied pressure according to (x) is in the range of from 10′ to 10′ Pa, more preferably in the range of from 1.5×10′ to 106 Pa.

Preferably, the heating according to (x) is performed at a temperature is the range of from 60° C. to 250° C., more preferably in the range of from 65 to 150° C., more preferably in the range of from 70 to 130° C.

Preferably, extruding according to (x′) is performed at a temperature in the range of from 140 to 220° C., more preferably in the range of from 160 to 200° C., more preferably in the range of from 170 to 190° C.

Preferably, the poly(urea-urethane) polymer is extruded at a torque in the range of from 2.0 to 2.4 Nm, more preferably at a maximum torque of 2.2 Nm. The value was determined using an Xplore Microcompounder MC15 as extruder.

According to the present invention, the mixture (M1) contains a prepolymer. According to a further aspect, the present invention is also directed to a prepolymer obtained or obtainable according to the process as disclosed above.

Preferably the prepolymer obtained contains hindered urea bonds. It is also possible according to the present invention that the prepolymer obtained is reused, for example for the preparation of a poly(urea-urethane) polymer.

It is also possible that the product of the process according to the present invention is a poly(urea-urethane) polymer. According to a further embodiment, the present invention therefore is also directed to a poly(urea-urethane) polymer obtained or obtainable according to the process as disclosed above.

According to a further aspect, the present invention is also directed to the use of a prepolymer according to the present invention for the preparation of a poly(urea-urethane) polymer.

The results indicated that the poly(urea-urethane)polymers can be reprocessed and recycled under mild conditions while still maintaining their chemical and mechanical properties due to the dynamic reversibility of HUBs.

Thus, due to the reversible nature of the bonds formed, the catalyst-free poly(urea-urethane)polymers exhibited excellent reprocessability and recyclability without chemical changes or loss of mechanical properties.

The present invention is further illustrated by the following set of embodiments and combinations of embodiments resulting from the dependencies and back-references as indicated.

In particular, it is noted that in each instance where a range of embodiments is mentioned, for example in the context of a term such as “The process of any one of embodiments 1 to 4”, every embodiment in this range is meant to be explicitly disclosed for the skilled person, i.e. the wording of this term is to be understood by the skilled person as being synonymous to “The process of any one of embodiments 1, 2, 3, and 4”. Further, it is explicitly noted that the following set of embodiments represents a suitably structured part of the general description directed to preferred aspects of the present invention, and, thus, suitably supports, but does not represent the claims of the present invention.
1. Process for recycling a composition comprising a poly(urea-urethane) polymer (PUU1) comprising step (i):
   (i) treatment of the composition comprising the poly(urea-urethane) polymer (PUU1) under conditions suitable to at least partially cleave the urea bonds of the polymer to give a mixture (M1) containing prepolymers,
the poly(urea-urethane) polymer (PUU1) being obtainable or obtained by a process comprising:
reacting the following components
   (i) at least one isocyanate;
   (ii) at least one polyol; and
   (iii) at least one secondary amine having the following formula (I)

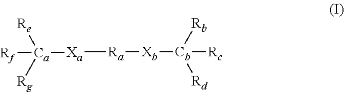

wherein —Rₐ— is selected from the group consisting of —Z₁—, —Z₂—, —Z₃—, —Z₄—, —Z₅—, —Z₆—, —Z₇—, —Z₇—, —Z₈—, —Z—, —Z₁₁, —Z₁₁—, —Z₁₃—, —Z₁—Z₅—, —Z₅—Z₁—Z₅—, —Z₁—Z₆—, —Z₁—Z₇—, —Z₁—Z—, —Z₁—Z₉—, —Z₉—Z₁—Z—, —Z₁—Z₁₀—, —Z₃—Z₅—, —Z₃—Z₆—, —Z₃—Z₇, —, —Z₃—Z₈—, —Z₃z—, —Z₃—Z₁₀—, —Z₁—Z₅—Z₁—, —Z₁—Z₉—Z₁—, —Z—Z₁(—Z₁₁—Z₁)—Z—, with n=1, 2, 3, 4, 5, or 6, and —Z₁—Z₁₂—Z₁—; wherein
—Z₁— is a substituted or unsubstituted, linear or branched C₁-C₃₀ alkylene;
—Z₂— is a substituted or unsubstituted, linear or branched 2- to 300,000-membered heteroalkylene;
—Z₃— is a substituted or unsubstituted, linear or branched C₂-C₃₀ alkenylene;
—Z₄— is a substituted or unsubstituted, linear or branched 3- to 30-membered heteroalkenylene;
—Z₅— is a substituted or unsubstituted C₅-C₃₀ cycloalkylene;
—Z₆— is a substituted or unsubstituted 5- to 30-membered heterocycloalkylene;
—Z₇— is a substituted or unsubstituted C₅-C₃₀ cycloalkenylene;
—Z₉— is a substituted or unsubstituted 5- to 30-membered heterocycloalkenylen; —Z— is a substituted or unsubstituted C₆-C₃₀ arylene;
—Z₁₀— is a substituted or unsubstituted 5- to 30-membered heteroarylene;
—Z₁₁— is a C₆-C₃₀ arylene substituted with —NHR or —OR, wherein R is selected from the group consisting of H and substituted or unsubstituted, linear or branched C₁-C₁₀ alkyl;
—Z₁₂— is —N(R_{f})—;
—Z₁₃— is a substituted or unsubstituted 5- to 30-membered heterocycloalkylene, wherein at least one of the one or more heteroatoms of Z₁₃ is from Xₐ;
wherein Cₐ is a C atom or a H atom and C_{b} is a C atom or a H atom, wherein at least one of Cₐ and C_{b} is a C atom;
wherein Xₐ is a O atom or NH and X_{b} is a O atom or NH, wherein at least one of Xₐ and X_{b} is NH, with the condition that for Xₐ and/or X_{b} being NH, the respective Cₐ and/or C_{b} is/are C atom(s);
wherein
   (A) Rₑ, R_{d}, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl,
   R_{b} and Rₑ independently of each other are defined as Rₑ, R_{d}, R_{f} and R_{g}; or R_{b} and Rₑ are none, and Cₐ and C_{b} are connected to each other via a single bond forming a heterocycle consisting of Cₐ, C_{b}, Xₐ, X_{b} and Rₐ; or
   (B) Cₐ and Rₑ form a substituted or unsubstituted C₆-C₃₀ arylene, and both R_{f} and R_{g} are none; and C_{b} and R_{b} form a substituted or unsubstituted C₆-C₃₀ arylene, and both R_{c} and R_{d} are none; or
   (C) —Cₐ and Rₑ form a substituted or unsubstituted C₆-C₃₀ arylene, and both R_{f} and R_{g} are none; or
   C_{b} and R_{b} form a substituted or unsubstituted C₆-C₃₀ arylene, and both R_{c} and R_{d} are none;
   wherein, when Cₐ and Rₑ form a substituted or unsubstituted C₆-C₃₀ arylene, R_{b}, R_{c} and R_{d} independently of each other are defined as any one of Rₑ, R_{d}, R_{f} and R_{g} under (A);
   wherein, when C_{b} and R_{b} form a substituted or unsubstituted C₆-C₃₀ arylene, Rₑ, R_{f} and R_{g} independently of each other are defined as any one of Rₑ, R_{d}, R_{f} and R_{g} under (A).
2. The process according to embodiment 1, wherein the conditions applied in step (i) are suitable to cleave the urea bonds of the polymer while the urethane bonds are substantially stable.
3. The process according to embodiment 1 or 2, wherein step (i) is a treatment at a temperature in the range from 60° C. to 200° C. and a pressure in the range from 1 bar to 200 bar or in a range from 50 mbar to 1 bar.
4. The process according to any of embodiments 1 to 3, wherein in step (i) an aprotic solvent is added.
5. The process according to any of embodiments 1 to 4, wherein the aprotic solvent is selected from the group consisting of selected from aliphatic hydrocarbons, halogenated hydrocarbons, ethers, aromatic hydrocarbons, esters, amides, sulfoxides and sulfones, ketones and mixtures thereof.
6. The process according to any one of embodiments 1 to 5, wherein in step (i), a component (S) is added which is suitable to react with the free functional groups of the cleaved urea bonds.
7. The process according to embodiment 6, wherein component (S) is selected from the group consisting of polyols, diols, polyisocyanates, diisocyanates, polyamines, oligo-amines, diamines, and amines of the general formula (II).
8. The process according to embodiment 7, wherein component (S) is selected from diisocyanates, polyamines, oligo-amines, diamines of the general formula (I), and amines of the general formula (II).
9. The process according to embodiment 7, wherein component (S) is a polyamine, oligo-amine or diamine of the general formula (I).
10. The process according to any one of embodiments 1 to 9, wherein the composition comprises a filler, the filler being selected from the group consisting of glass fibers, carbon fibers, mineral fibers, textiles, metal meshs, metal fibers, metal rods, carbonates, wood, and a mixture of two or more thereof.
11. The process according to any one of embodiments 1 to 10, wherein the process comprises step (ii)
   (ii) separation of the components of the mixture obtained in step (i).
12. The process according to embodiment 11, wherein step (ii) comprises a filtration step.
13. The process according to embodiment 12, wherein filtration is carried out at a temperature in the range from 20° C. to 200° C. 14. The process according to any one of embodiments 1 to 13, wherein the process comprises step (iii)
   (iii) preparing a poly(urea-urethane) polymer using one or more of the components obtained in step (ii).
15. The process according to any one of embodiments 1 to 14, wherein the process comprises further purification steps.
16. The process according to any one of embodiments 1 to 15, wherein the process comprises further filtration steps.
17. Prepolymer obtained or obtainable according to the process of any one of embodiments 1 to 15.
18. Prepolymer according to embodiment 17, wherein the prepolymer contains HUBs.
19. Poly(urea-urethane) polymer obtained or obtainable according to the process according to any one of embodiments 1 to 15.
20. Use of a prepolymer according to embodiment 17 or 18, for the preparation of a poly(urea-urethane) polymer.
21. Poly(urea-urethane) polymer obtained or obtainable by a process using the prepolymer according to embodiment 11 for the preparation of the poly(urea-urethane) polymer.
22. The process of any one of embodiments 1 to 15, wherein Xₐ is NH, X_{b} is NH, the secondary amine (iii) having the following formula (II)

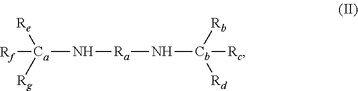

wherein Cₐ, C_{b}, R_{b}, Rₑ, R_{d}, Rₑ, R_{f}, R_{g}, and —Rₐ— are as defined in formula (I).
23. The process of any one of embodiments 1 to 15 or 22, wherein —Rₐ— is selected from the group consisting of —Z₁—, —Z₂—, —Z₅—, —Z₉—, —Z₁₀—, —Z₁—Z₅—, —Z₅—Z₁—Z₅—, —Z₉—Z₁—Z₉—, —Z₁—Z₅—Z₁—, —Z₁—Z₈—Z₁—, and —Z₉—Z₁(—Z₁₁—Z₁)ₙ—Z₉—, wherein n=1, 2, 3, 4, 5, or 6, preferably selected from the group consisting of —Z₂—, —Z₉—Z₁—Z₉—, and —Z₉—Z₁(—Z₁₁—Z₁)ₙ—Z₉—, wherein n=1, 2, 3, 4, 5, or 6, more preferably selected from the group consisting of —Z₂— and —Z₉—Z₁(—Z₁₁—Z₁)ₙ—Z₉—, wherein n=1, 2, 3, 4, 5, or 6.
24. The process of any one of embodiments 1 to 15 or 22 to 23, wherein —Z₁— is selected from the group consisting of —CH₂—, —CH₂—CH₂—, —CH₂—CH(CH₃)—, —CH(CH₃)—CH₂—, —CH(CH₃)—CH₂—CH₂—, —CH₂—CH₂—CH(CH₂CH₃)—, —C(CH₃)₂—, —CH₂—C(CH₃)₂—CH₂—, —CH₂—CH(CH₃)—CH₂—C(CH₃)₂—CH₂—CH₂—, —CH₂—C(CH₃)₂—CH₂—CH(CH₃)—CH₂—CH₂—, —(CH₂)₃—, —(CH₂)₄—, —(CH₂)₅—, —(CH₂)₆—, —(CH₂)₈-, and —(CH₂)₁₀—.
25. The process of any one of embodiments 1 to 15 or 22 to 24, wherein —Z₉— is selected from the group consisting of phenylene, naphthylene, biphenylene, fluorenylene, and indenyl, wherein —Z₉— preferably is phenylene.
26. The process of embodiment 25, wherein —Rₐ— is —Z₉—Z₁—Z₉—, with —Z₉—is phenylene, preferably para-phenylene, and —Z₁— is —CH₂—.
27. The process of embodiment 25, wherein —Rₐ— is —Z₉—Z₁(—Z₁₁—Z₁)ₙ—Z₉—, wherein n=1, 2, 3, 4, 5, or 6, with —Z₉— is phenylene and —Z₁— is —CH₂— and wherein —Z₁₁— is a C₆-arylene substituted with —NHR.
28. The process of any one of embodiments 1 to 15 or 22 to 25, wherein —Z₂— is a substituted or unsubstituted, linear or branched 2- to 500-membered heteroalkylene, preferably a substituted or unsubstituted, linear or branched 2- to 35-membered heteroalkylene, more preferably a substituted or unsubstituted, linear or branched 2- to 30-membered heteroalkylene.
29. The process of embodiment 28, wherein —Z₂— is selected from the group consisting of —CH₂—CH₂—NH—CH₂—CH₂—, —CH₂—CH₂—NH—CH₂—CH₂—CH₂—, —CH(CH₃)—CH₂—NH—CH₂—CH(CH₃)—, —CH₂—CH₂—CH₂—N(CH₃)—CH₂—CH₂—CH₂—, —CH₂—CH₂—CH₂—NH—CH₂—CH₂—CH₂—, —CH₂—CH₂—CH₂—NH—CH₂—CH₂—NH—CH₂—CH₂—CH₂—, —CH₂—CH₂—NH—CH₂—CH₂—NH—CH₂—CH₂—, —CH₂—CH₂—NH—CH₂—CH₂—NH—CH₂—CH₂—NH—CH₂—CH₂—, —CH₂—CH₂—O—CH₂—CH₂—, —CH₂—CH₂—CH₂—O—CH₂—CH₂—O—CH₂—CH₂—O—CH₂—CH₂—CH₂—, —CH₂—CH₂—CH₂—O—CH₂—CH₂—CH₂—CH₂—O—CH₂—CH₂—CH₂—, —CH₂—CH₂—O—CH₂—CH₂—O—CH₂—CH₂—, —(CH(CH₃)—CH₂—O)₁, —CH(CH₃)—CH₂—, —[CH(CH₃)—CH₂O]ₘ₁—CH₂-C(Rₓ)(R_{y1})—[O—CH₂—CH(CH₃)]ₒ₁—, wherein R₁ is —CH₂—CH₃, wherein R_{y1} is [—O—CH₂—CH(CH₃)]ₒ₁—NH—C(Rₙ)(Rₘ)(Rₙ), wherein m1+n1+o1 is in the range of from 5 to 6, —[CH(CH₃)—CH₂—0]ₘ₂—CH₂—CH(R_{y2})—[O—CH₂—CH(CH₃)]ₒ₂—, wherein R_{y2} is [—O—CH₂—CH(CH₃)]ₙ₂—NH—C(Rᵢ)(Rₘ)(Rₙ), and wherein m2+n2+o2 is in the range of 45 to 85, —[CH(CH₃)—CH₂O]ₘ₃—[CH₂—CH₂—O]₃—[CH₂—CH(CH₃)—O]₃—CH₂—CH(CH)₃—, wherein n3 is in the range of from 8 to 10 and m3+o3 is in the range of from 3 to 4, or wherein n3 is in the range of from 12 to 13 and m3+o3 is in the range of from 5 to 7, or wherein n3 is in the range of from 38 to 40 and m3+o3 is in the range of from 5 to 7, —[CH—CH₂—O]ₘ₄CH₂—CH₂—, wherein m4 is in the range of from 8 to 250, and —[CH₂—CH₂—NH]ₘ₅, wherein m5 is in the range of from 10 to 100,000;
wherein —Z₂— is preferably —[CH(CH₃)—CH₂—O]ₘ₁—CH₂—C(Rₓ₁)(R_{y1})—CH₂—[O—CH₂—CH(CH₃)]—, wherein Rₓ₁ is —CH₂—CH₃, wherein R_{y1} is —CH₂—[O—CH₂—CH(CH₃)]ₙ₁—NH—C(Rₙ)(Rₘ)(Rₙ), wherein m1+n1+o1 is in the range of 5 to 6.
30. The process of any one of embodiments 1 to 15 or 22 to 29, wherein Rₑ, R_{d}, R_{f} and R_{g} independently of each other are selected from the group consisting of hydrogen, methyl, ethyl, propyl, iso-propyl, butyl, pentyl, hexyl, octyl, dodecyl, sec-butyl, tert-butyl, sec-isopentyl, 2-pentyl, 2-methyl-4-pentyl, 3-pentyl, 2-methyl-pentyl, 2,6-dimethyl-4-heptyl, 3-pinanyl-methyl, cyclopentyl, cyclohexyl, dicyclohexylmethyl, cyclohexylmethyl, cyclododecyl, phenyl, benzyl, cyclohexyl(phenyl)methyl, and —C(OH)H-Rₖ, preferably selected from the group consisting of hydrogen, methyl, and ethyl, more preferably selected from the group consisting of hydrogen, methyl and ethyl, wherein Rₖ is selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl.
31. The process of any one of embodiments 1 to 15 or 22 to 30, wherein R_{b} and Rₑ independently of each other are selected from the group consisting of hydrogen, methyl, ethyl, propyl, iso-propyl, butyl, pentyl, hexyl, octyl, dodecyl, sec-butyl, tert-butyl, sec-isopentyl, 2-pentyl, 2-methyl-4-pentyl, 3-pentyl, 2-methyl-pentyl, 2,6-dimethyl-4-heptyl, 3-pinanyl-methyl, cyclopentyl, cyclohexyl, dicyclohexylmethyl, cyclohexylmethyl, cyclododecyl, phenyl, benzyl, and cyclohexyl(phenyl)methyl, preferably selected from the group consisting of hydrogen, methyl, and ethyl.
32. The process of any one of embodiments 1 to 15 or 22 to 31, wherein any one of R_{b}, Rₑ, and R_{d} is H, and any one of Rₑ, R_{f}, and R_{g} is H;
wherein one of R_{b}, Rₑ, and R_{d} other than the one being H is CH₃, and one of Rₑ, R_{f}, and R_{g} other than the one being H is CH₃.
33. The process of any one of embodiments 1 to 15 or 22 to 32, wherein any one of R_{b}, Rₑ, and R_{d} is an ethyl group, and any one of Rₑ, R_{f}, and R_{g} is an ethyl group; preferably wherein one of R_{b}, Rₑ, and R_{d} other than the one being an ethyl group is H, one of Rₑ, R_{f}, and R_{g} other than the one being an ethyl group is H, one of R_{b}, Rₑ, and R_{d} other than the one being an ethyl group or H is CH₃, and one of Rₑ, R_{f}, and R_{g} other than the one being an ethyl group or H is CH₃.
34. The process of embodiment 33, wherein the at least one secondary amine (iii) is 4,4′-Methylenebis(N-sec-butylaniline) (DIB-MDA) or wherein the at least one secondary amine (iii) is DIB-butanediamine (N,N′-di-sec-butyl-1,4-butanediamine).
35. The process of embodiment 33, wherein the at least one secondary amine (iii) is an sec-butyl-modified polyether amine, CH₃—CH₂CH(CH₃)—NH—[CH(CH₃)—CH₂—0]ₘ—CH₂C(Rₓ₁)(R_{y1})—CH₂—[O—CH₂—CH(CH₃)]ₒ₁—NH—CH(CH₃)—CH₂—CH₃, wherein Rₓ₁ is —CH₂—CH₃, wherein R_{y1} is —CH₂—[O—CH₂—CH(CH₃)]ₒ₁—NH—CH(CH₃)—CH₂—CH₃, wherein m1+n1+o1 is in the range of 5 to 6.
36. The process of any one of embodiments 1 to 15 or 22 to 35, wherein the at least one isocyanate (i) has a NCO functionality of 2 or more, preferably of 2 or 3, wherein preferably the at least one isocyanate (i) is a mixture of an isocyanate having a NCO functionality of 2 and an isocyanate having a NCO functionality of 3 or more, preferably the at least one isocyanate (i) is a mixture of an isocyanate having a NCO functionality of 2 and an isocyanate having a NCO functionality of 3.
37. The process of any one of embodiments 1 to 15 or 22 to 36, wherein the at least one isocyanate (i) is selected from the group consisting of monomeric methylene diphenylene diisocyanate (mMDI), polymethylene polyphenylene polyisocyanate (pMDI), a mixture of monomeric methylene diphenylene diisocyanate and polymethylene polyphenylene polyisocyanate (MDI), tolylene diisocyanate (TDI), isomers of xylylene diisocyanate (XDI), isomers of diisocyanatobenzene, xylene 2,6-diisocyanate, naphthylene 1,5-diisocyanate (1,5-NDI), butane 1,4-diisocyanate, pentane 1,5-diisocyanate (PDI), hexane 1,6-diisocyanate (HDI), octane 1,8-diisocyanate, nonane 1,9-diisocya-nate, decane 1,10-diisocyanate, 2,2-dimethylpentane 1,5-diisocyanate, 2-methylpentane 1,5-diisocyanate (MPDI), 2,4,4(or 2,2,4)-trimethylhexane 1,6-diisocyanate (TMDI), cyclohexane 1,3- and 1,4-diisocyanate, 1-isocyanato-3,3,5-trimethyl-5-isocyanatomethylcyclohexane (IPDI), methylene-bis(cyclohexyl isocyanate) (H12MDI), 2,4- or 2,6-diisocyanato-1-methylcyclohexane (H6TDI), 1-isocyanato-1-methyl-4(3)-isocyanatomethylcyclohexane (AMCI), 1,3-bis(isocyanatomethyl)cyclohexane, 1,4-bis(iso-cyanatomethyl)cyclohexane, bis(isocyanatomethyl)norbornane (NBDI), triphenylme-thane-4,4′,4″-triisocyanate, toluene-2,4,6-triyl triisocyanate, ethyl ester 1-lysine triisocyanate, triisocyanatocyclohexane, tris(isocyanatomethyl)cyclohexane, triisocyanatomethylcyclohexane, 1,8-diisocyanato-4-(isocyanatomethyl)octane, undecane 1,6,11-triisocyanate, 1,7-diisocyanato-4-(3-isocyanatopropyl)heptane, 1,6-diisocyanato-3-(isocyanatomethyl)hexane, 2,2-bis[[4-(isocyanatomethyl)phenyl]methyl]butyl n-[[4-(isocyanatomethyl)phenyl]methyl]carbamate, (2,4,6-trioxotriazine-1,3,5(2h,4h,6h)-triyl)tris(hexamethylene) isocyanate, 1,3,5-triisocyanatobenzene, tris(isocyanatohexyl)biuret, 3,3′,3″-[(1h,3h,5h)-2,4,6-trioxo-1,3,5-triazine-1,3,5-tri-yltris(methylene)]tris[3,5,5-trimethylcyclohexyl]triisocyanate, 1,3,5-triazine-2,4,6-triisocyanate, 2,4,4′-triisocyanato-dicyclohexylmethane, triisocyanate triphenylthiophosphate, 2,4,4′-diphenylethertriisocyanate, 1,3-Bis(3-isocyanato-4-methylphenyl)-1,3-diazetidine-2,4-dione, and a mixture of two or more thereof, preferably selected from the group consisting of monomeric methylene diphenylene diisocyanate (mMDI), polymethylene polyphenylene polyisocyanate (pMDI), a mixture of monomer methylene diphenylene diisocyanate and polymethylene polyphenylene polyisocyanate (MDI), tolylene diisocyanate (TDI), naphthylene 1,5-diisocyanate (1,5-NDI), 1,4-diisocyanate, pentane 1,5-diisocyanate (PDI), hexane 1,6-diisocyanate (HDI), methylene-bis(cyclohexyl isocyanate) (H12MDI) and a mixture of two or more thereof.
38. The process of embodiment 37, wherein the at least one isocyanate (i) is selected from the group consisting of monomeric methylene diphenylene diisocyanate (mMDI), polymethylene polyphenylene polyisocya-nate (pMDI), a mixture of monomer methylene diphenylene diisocyanate and polymethylene polyphenylene polyisocyanate (MDI) and tolylene diisocyanate (TDI).
39. The process of any one of embodiments 1 to 15 or 22 to 38, wherein the at least one polyol (i) is selected from the group consisting of polyester polyol, polyetherester polyol, polycarbonate polyol, polyacrylate polyol, polyolefine polyol, polyether polyol, and mixtures thereof.
40. The process of embodiment 39, wherein the at least one polyol (i) is selected from the group consisting of polyester polyol and polyether polyol.
41. The process of embodiment 40, wherein the at least one polyol (ii) is polyether polyol, the polyether polyol preferably being selected from the group consisting of polytetrahydrofuran, trifunctional polyether polyol containing secondary hydroxyl groups, polypropylene glycol, polyether polyol based on sucrose, tetrafunctional polyether polyol based on ethylenediamine and propylene oxide, and a mixture of two or more thereof, more preferably selected from the group consisting of polytetrahydrofuran and trifunctional polyether polyol containing secondary hydroxyl groups.
42. The process of any one of embodiments 1 to 15 or 22 to 41, wherein the at least one isocyanate (i), the at least one polyol (ii) and the at least one secondary amine (iii) are reacted in the absence of a solvent.
43. The process of any one of embodiments 1 to 15 or 22 to 42, wherein said polymer (PUU1) is obtainable or obtained by a process comprising reacting (i), (ii) and/or (iii), preferably (i) and (ii), with at least one additive, wherein the at least one additive selected from the group consisting of benzoyl chloride and diethylene glycol bis-chloroformate.
44. The process of any one of embodiments 1 to 15 or 22 to 43, wherein said polymer (PUU1) is obtainable or obtained by a process in the absence of a catalyst.
45. The process of any one of embodiments 1 to 15 or 22 to 44, wherein the poly(urea-urethane) polymer (PUU1) is obtained or obtainable by a process comprising
reacting the at least one isocyanate (i) with the at least one polyol (ii), obtaining a pre-polymer, and
reacting the obtained pre-polymer with the at least one secondary amine (iii); or being obtained or obtainable by a process comprising
reacting the at least one isocyanate (i) with the at least one secondary amine (iii), obtaining a pre-polymer, and
reacting the obtained pre-polymer with the at least one polyol (ii).
46. The process of any one of embodiments 1 to 15 or 22 to 45, wherein the molar ratio of -NCO of the at least one isocyanate (i) relative to -OH of the at least one polyol (ii) is in the range of from 1:0.50 to 1:0.10, preferably in the range of from 1:0.40 to 1:0.15, more preferably in the range of from 1:0.30 to 1:0.20.
47. The process of any one of embodiments 1 to 15 or 22 to 46, wherein the molar ratio of -NCO of the at least one isocyanate (i) relative to —NH-of the at least one secondary amine (iii) is in the range of from 1:1.50 to 1:0.5, preferably in the range of from 1:1.20 to 1:0.60, more preferably in the range of from 1:0.8 to 1:0.7.
48. The process of any one of embodiments 1 to 15 or 22 to 47, wherein the reaction of the components (i), (ii) and/or (iii) is performed at a temperature in the range of from more than 0 to 200° C., preferably in the range of from 1 to 200° C., more preferably in the range of from 10 to 150° C., more preferably in the range of from 20 to 90° C.
49. The process of any one of embodiments 1 to 15 or 22 to 47, wherein the poly(urea-urethane) polymer (PUU1) is obtained or obtainable by a process further comprising curing the mixture of (i), (ii) and (iii), preferably at a temperature in the range of from 90 to 200° C., more preferably in the range of from 100 to 150° C.
50. The process of any one of embodiments 1 to 15 or 22 to 49, wherein the poly(urea-urethane) polymer (PUU1) is thermoplastic or thermoset.
51. The process of any one of embodiments 1 to 15 or 22 to 50, wherein the poly(urea-urethane) polymer (PUU1) has a solubility in toluene in the range of 0.05:1 to 1:1 g/mL (grams of dissolved polymer: mL of solvent) measured at a temperature of 110° C. and after a duration of at least 12 hours of heating at ambient pressure, preferably a solubility in toluene in the range of 0.075:1 to 0.5:1 g/mL (grams of dissolved polymer: mL of solvent) measured at a temperature of 110° C. and after a duration of at least 12 hours of heating at ambient pressure.
52. The process of any one of embodiments 1 to 15 or 22 to 51, wherein the poly(urea-urethane) polymer (PUU1) has a solubility in 1,3-dimethyl-2-imidazolidinone in the range of 0.05:1 to 1:1 g/mL (grams of dissolved polymer: mL of solvent) measured at a temperature of 130° C. and after a duration of at least 20 hours of heating at ambient pressure, preferably a solubility in an organic solvent in the range of 0.075:1 to 0.5:1 g/mL (grams of dissolved polymer: mL of solvent) measured at a temperature of 130° C. and after a duration of at least 20 hours of heating at ambient pressure.
53. The process of any one of embodiments 1 to 15 or 22 to 52, wherein the poly(urea-urethane) polymer (PUU1) has a melting point in the range of from 10° C. to 200° C. at 20 kN of pressure determined by hot press, preferably in the range of from 50° C. to 190° C. at 20 kN of pressure, more preferably in the range of from 60° C. to 180° C. at 20 kN of pressure.
54. A process of any one of embodiments 1 to 15 or 22 to 53, wherein the poly(urea-urethane) polymer-based composite is obtainable or obtained by
reacting the following components
   (i) at least one isocyanate;
   (ii) at least one polyol; and
   (iii) at least one secondary amine having the following formula (I)

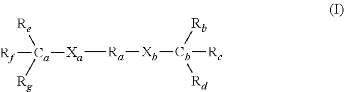

wherein —Rₐ— is selected from the group consisting of —Z₁—, —Z₂—, —Z₃—, —Z₄—, —Z₅—, —Z₆—, —Z₇—, —Z₇—, —Z₈—, —Z—, —Z₁₁, —Z₁₁—, —Z₁₃—, —Z₁—Z₅—, —Z₅—Z₁—Z₅—, —Z₁—Z₆—, —Z₁—Z₇—, —Z₁—Z—, —Z₁—Z₉—, —Z₉—Z₁—Z—, —Z₁—Z₁₀—, —Z₃—Z₅—, —Z₃—Z₆—, —Z₃—Z₇, —, —Z₃—Z₈—, —Z₃Z₉, —Z₃—Z₁₀—, —Z₁—Z₅—Z₁—, —Z₁—Z₉—Z₁—, —Z—Z₁(—Z₁₁—Z₁)—Z—, with n=1, 2, 3, 4, 5, or 6, and —Z₁—Z₁₂—Z₁—; wherein
—Z₁— is a substituted or unsubstituted, linear or branched C₁-C₃₀ alkylene;
—Z₂— is a substituted or unsubstituted, linear or branched 2- to 300,000-membered heteroalkylene;
—Z₃— is a substituted or unsubstituted, linear or branched C₂-C₃₀ alkenylene;
—Z₄— is a substituted or unsubstituted, linear or branched 3- to 30-membered heteroalkenylene;
—Z₅— is a substituted or unsubstituted C₅-C₃₀ cycloalkylene;
—Z₆— is a substituted or unsubstituted 5- to 30-membered heterocycloalkylene;
—Z₇— is a substituted or unsubstituted C₅-C₃₀ cycloalkenylene;
—Z₈— is a substituted or unsubstituted 5- to 30-membered heterocycloalkenylen;
—Z₉— is a substituted or unsubstituted C₆-C₃₀ arylene;
—Z₁₀— is a substituted or unsubstituted 5- to 30-membered heteroarylene;
—Z₁₁— is a C₆-C₃₀ arylene substituted with —NHR or —OR, wherein R is selected from the group consisting of H and substituted or unsubstituted, linear or branched C₁-C₁₀ alkyl;
—Z₁₂— is —N(R_{f})—;
—Z₁₃— is a substituted or unsubstituted 5- to 30-membered heterocycloalkylene, wherein at least one of the one or more heteroatoms of Z₁₃ is from Xₐ;
wherein Cₐ is a C atom or a H atom and C_{b} is a C atom or a H atom, wherein at least one of Cₐ and C_{b} is a C atom;
wherein Xₐ is a O atom or NH and X_{b} is a O atom or NH, wherein at least one of Xₐ and X_{b} is NH, with the condition that for Xₐ and/or X_{b} being NH, the respective Cₐ and/or C_{b} is/are C atom(s);
wherein
   (A) Rₑ, R_{d}, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl, R_{b} and Rₑ independently of each other are defined as Rₑ, R_{d}, R_{f} and R_{g}; or R_{b} and Rₑ are none, and Cₐ and C_{b} are connected to each other via a single bond forming a heterocycle consisting of Cₐ, C_{b}, Xₐ, X_{b} and Rₐ; or
   (B) Cₐ and Rₑ form a substituted or unsubstituted C₆-C₃₀ arylene, and both R_{f} and R_{g} are none; and
   C_{b} and R_{b} form a substituted or unsubstituted C₆-C₃₀ arylene, and both R_{c} and R_{d} are none; or
   (C) —Cₐ and Rₑ form a substituted or unsubstituted C₆-C₃₀ arylene, and both R_{f} and R_{g} are none; or
   C_{b} and R_{b} form a substituted or unsubstituted C₆-C₃₀ arylene, and both R_{c} and R_{d} are none;
   wherein, when Cₐ and Rₑ form a substituted or unsubstituted C₆-C₃₀ arylene, R_{b}, R_{c} and R_{d} independently of each other are defined as any one of Rₑ, R_{d}, R_{f} and R_{g} under (A);
   wherein, when C_{b} and R_{b} form a substituted or unsubstituted C₆-C₃₀ arylene, Rₑ, R_{f} and R_{g} independently of each other are defined as any one of Rₑ, R_{d}, R_{f} and R_{g} under (A),
obtaining a mixture, comprising a poly(urea-urethane) polymer, preferably a polymer; and
bringing in contact the obtained mixture, preferably polymer, with component (iv):
   (iv) a filler, the filler being selected from the group consisting of glass fibers, carbon fibers, mineral fibers, textiles, metal meshs, metal fibers, metal rods, carbonates, wood, and a mixture of two or more thereof.
55. The process of embodiment 54, wherein the filler (iv) is glass fibers.
56. Process of any one of embodiments 1 to 15 or 22 to 55, wherein the process for preparing the poly(urea-urethane) polymer comprises:
   (a) reacting at least one isocyanate (i) with at least one polyol (ii), obtaining a pre-polymer;
   (b) bringing in contact the pre-polymer obtained in (a) with at least one secondary amine, the at least one secondary amine having the formula (I) as defined in any one of embodiments 1 to 15, obtaining the poly(urea-urethane) polymer; or
   (a′) reacting at least one isocyanate (i) with at least one secondary amine, the at least one secondary amine having the formula (I) as defined in any one of embodiments 1 to 15, obtaining a pre-polymer;
   (b′) bringing in contact the pre-polymer obtained in (a′) with at least one polyol (ii), poly(urea-urethane) polymer.
57. The process of embodiment 56, wherein (a) or (a′) is performed at a temperature in the range of from 0 to 200° C., preferably in the range of from 1 to 200° C., more preferably in the range of from 10 to 150° C., more preferably in the range of from 20 to 90° C.
58. The process of embodiment 56 or 57, wherein one or more of (a) and (b) or one or more of (a′) and (b′), preferably (a) and (b) or (a′) and (b′), are performed in the ab-sence of a solvent.
59. The process of any one of embodiments 56 to 58, wherein (b) or (b′) is performed at a temperature in the range of from 0 to 200° C., preferably in the range of from 1 to 200° C., more preferably in the range of from 10 to 150° C., more preferably in the range of from 20 to 90° C.
60. The process of any one of embodiments 56 to 59, further comprising
   (c) curing the mixture obtained in (b) or (b′), preferably at a temperature in the range of from 90 to 150° C., more preferably in the range of from 100 to 120° C.
61. Process of any one of embodiments 1 to 15 or 22 to 60, wherein the process for preparing the composite comprises:
(1) providing a poly(urea urethane) polymer comprising
   (1.1) reacting at least one isocyanate (i) with at least one polyol (ii), obtaining a pre-polymer;
   (1.2) bringing in contact the pre-polymer obtained in (1.1) with at least one secondary amine, the at least one secondary amine (iii) having the formula (I) as defined in any one of embodiments 1 to 15; or
   (1.1′) reacting at least one isocyanate (i) with at least one secondary amine, the at least one secondary amine (iii) having the formula (I) as defined in any one of embodiments 1 to 15, obtaining a pre-polymer;
   (1.2′) bringing in contact the pre-polymer obtained in (1.1′) with at least one polyol (ii);
(2) bringing in contact the polymer obtained in (1.2) or (1.2′) with a filler as defined in embodiment 54 or 55.
62. The process of embodiment 61, wherein (1) is performed at a temperature in the range of from 0 to 200° C., preferably in the range of from 1 to 200° C., more preferably in the range of from 10 to 150° C., more preferably in the range of from 20 to 90° C.
63. The process of embodiment 61 or 62, wherein one or more of (1) and (2), preferably (1) and (2), are performed in the absence of a solvent.
64. The process of any one of embodiments 61 to 63, wherein bringing the polymer in contact with the filler in (2) is performed by mixing or pressing.
65. The process of embodiment 64, wherein pressing is performed at a pressure in the range of from 10 to 30 kN, preferably in the range of from 15 to 25 kN, more preferably in the range of from 18 to 22 kN.
66. The process of any one of embodiments 61 to 65, further comprising (1.3) curing the polymer obtained in (1.2) or (1.2′), preferably at a temperature in the range of from 90 to 150° C., more preferably in the range of from 100 to 120° C.; or
   (3) curing the polymer obtained in (2), preferably at a temperature in the range of from 90 to 150° C., more preferably in the range of from 100 to 120° C.
67. Prepolymer obtained or obtainable according to the process of any one of embodiments 21 to 66.
68. Prepolymer according to embodiment 67, wherein the prepolymer contains HUBs.
69. Poly(urea-urethane) polymer obtained or obtainable according to the process according to any one of embodiments 21 to 66.
70. Use of a prepolymer according to embodiment 67 or 68, for the preparation of a poly(urea-urethane) polymer.
71. Poly(urea-urethane) polymer obtained or obtainable by a process using the prepolymer according to embodiment 67 for the preparation of the poly(urea-urethane) polymer.

In the context of the present invention, the term “alkylene” relates to acyclic saturated hydrocarbon groups, which may be acyclic saturated hydrocarbon chains, which combine different moieties, as in the case of C₁-C₃₀ alkylene with 1 to 30 (i.e. 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30) C atoms or with, as in the case of C₁-C₅ alkylene, 1 to 5 (i.e. 1, 2, 3, 4 or 5) C atoms. Representative examples of alkylene include, but are not limited to, —CH₂—, —CH₂—CH₂—, —CH₂—CH(CH₃)—, —CH(CH₃)—CH₂—, —CH(CH₃)—CH₂—CH₂—, —CH₂—CH(CH₂CH₃)—, —CH₂—CH₂—CH(CH₂CH₃)—, —CH₂—CH(n-C₃H₇)—, —CH₂—CH(n-C₄H₉)—, —CH₂—CH(n-C₅H₁₁)—, —CH₂—CH(n-C₆H₁₃)—, —CH₂—CH(n-C₇H₁₅)—, —CH₂—CH(n-CsH₁₇)—, —CH(CH₃)—CH(CH₃)—, —C(CH₃)₂—, —CH₂—C(CH₃)₂—CH₂—, —CH₂—[C(CH₃)₂]₂—CH₂—, —CH₂—CH(CH₃)—CH₂—C(CH₃)₂—CH₂—CH₂—, —CH₂—C(CH₃)₂—CH₂—CH(CH₃)—CH₂—CH₂—, —(CH₂)₃—, —(CH₂)₄-—(CH₂)₅—, —(CH₂)₆—, —(CH₂)₈—, —(CH₂)₁₀—, —(CH₂)₇—, —(CH₂)₉—, —(CH₂)₁₁—, —(CH₂)₁₂—, —(CH₂)₁₃—, —(CH₂)₁₄—, —(CH₂)₁₅—, —(CH₂)₁₆—, —(CH₂)₁₇—, —(CH₂)₁₈—, —(CH₂)₁₉—, —(CH₂)₂₀—, —(CH₂)₂₁—, —(CH₂)₂₂—, —(CH₂)₂₃—, —(CH₂)₂₄—, —(CH₂)₂₅—, —(CH₂)₂₆—, —(CH₂)₂₇—, —(CH₂)₂₈—, —(CH₂)₂₉— and —(CH₂)₃₀—. In the context of the present invention, the term “heteroalkylene” relates to an alkylene group as described above, in which one or more carbon atoms have been replaced with heteroatoms each independently selected from the group consisting of oxygen, sulfur and nitrogen (—NH—). The heteroalkylene groups can preferably have 1, 2 or 3 heteroatom (s), particularly preferably 1 heteroatom selected from the group consisting of oxygen, sulfur and nitrogen (—NH—) as chain link(s). The heteroalkylene groups can preferably be 2- to 30-membered, particularly preferably 2- to 12-membered, very particularly preferably 2- or 6-membered. More preferably, oxygen (—O—) is the most preferred heteroatom in “heteroalkylene”. Representative examples of the heteroalkylene groups include, but are not limited to, (—CH₂—O—CH₂—)₁₋₅₀₀, (—CH₂—O—CH(CH₃)—)₁₋₅₀₀, —(CH(CH₃)—CH₂—O)₁₋₁₀₀—CH(CH₃)—CH₂—, —CH₂—CH₂—O—CH₂—CH₂—, —CH₂—O—CH(CH₃)—, —CH₂—O—CH(CH₂CH₃)—, —CH₂—O—CH(n—C₃H₇)—, —CH₂—O—CH(n—C₄H₉)—, —CH₂— O—CH(n—C₅H₁₁)—, —CH₂—O—CH(n—C₆H₁₃)—, —CH₂—O—CH(n—C₇H₁₅)—, —CH₂—O—CH(n—C₈H₁₇)—, —CHO—(CH₃)—CHO—(CH₃)—, —CO—(CH₃)₂—, —CH₂—O—C(CH₃)₂—CH₂—, —CH₂—[O—C(CH₃)₂]₂—CH₂—, —(CH₂)₃—CH₂—, —(CH₂)₄O—CH₂—, —(CH₂)₅O—CH₂—, —(CH₂)₆—O—CH₂—, —(CH₂)s-OCH₂—, —(CH₂)₁₀-O—CH₂—, —(CH₂)₇O—CH₂—, —(CH₂)₉O—CH₂—, —(CH₂)₁₁—O—CH₂—, —(CH₂)₁₂—.CH₂—, —(CH₂)₁₃—O—CH₂—, —(CH₂)₁₄—O—CH₂—, —(CH₂)₁₅—O—CH₂—, —(CH₂)₁₆—O—CH₂—, —(CH₂)₁₇—O—CH₂—, —(CH₂)₁₈—O—CH₂—, —(CH₂)₁₉—O—CH₂—, —(CH₂)₂₀—CH₂—, —(CH₂)₂₁-OCH₂—, —(CH₂)₂₂—OCH₂—, —(CH₂)₂₃—O—CH₂—, —(CH₂)₂₄-OCH₂—, —(CH₂)₂₅-OCH₂—, —(CH₂)₂₆-OCH₂—, —(CH₂)₂₇—O—CH₂—, —(CH₂)₂₈—O—CH₂—, —(CH₂)₂₉—O—CH₂—, —(CH₂)₃₀—CH₂—, —CH₂—S—CH₂—, —CH₂—NH—CH₂—, —CH₂—NH—, —CH₂—CH₂—NH—CH₂—CH₂—CH₂—, —CH₂—CH₂—CH₂—N(CH₃)—CH₂—CH₂—CH₂—, —CH₂—CH₂—CH₂—NH—CH₂—CH₂—CH₂—, —CH₂—CH₂—CH₂—NH—CH₂—CH₂—NH—CH₂—CH₂—CH₂—, —CH₂—CH₂—NH—CH₂—CH₂—NH—CH₂—CH₂—, —CH₂—CH₂—NH—CH₂—CH₂—NH—CH₂—CH₂—NH—CH₂—CH₂—, —CH₂—CH₂—CH₂—O—CH₂—CH₂—O—CH₂—CH₂—O—CH₂—CH₂—CH₂—, —CH₂—CH₂—CH₂—O—CH₂—CH₂—CH₂—CH₂—O—CH₂—CH₂—CH₂—, —CH₂—CH₂— O—CH₂—CH₂—O—CH₂—CH₂—, —CH(CH₃)—CH₂—NH—CH₂—CH(CH₃)—, —CH₂—CH₂—NH—CH₂—CH₂—, —[CH(CH₃)—CH₂—O]ₘ₁—CH₂—C(Rₓ₁)(R_{y1})—[O—CH₂—CH(CH₃)]ₒ₁—, wherein Rₓ₁ is —CH₂—CH₃, wherein R_{y1} is [—O—CH₂—CH(CH₃)]ₒ₁—NH—C_{d}(Rₙ)(Rₘ)(Rₙ), and wherein m1+n1+o1 is in the range of 5 to 6, —[CH(CH₃)—CH₂—O]ₘ₂—CH₂—CH(R_{y2})—[O—CH₂—CH(CH₃)]ₒ₂, wherein R_{y2} is [—O—CH₂—CH(CH₃)]ₙ₂—NH—C_{d}(Rₗ)(Rₘ)(Rₙ), and wherein m2+n2+o2 is in the range of 45 to 85, —[CH(CH₃)—CH₂—O]ₘ—[CH₂—CH₂O]₃—[CH₂CH(CH₃)—O](3CH₂—CH(CH)₃—, wherein n3 is in the range of 8 to 10 and m3+o3 is in the range of 3 to 4, or wherein n3 is in the range of 12 to 13 and m3+o3 is in the range of 5 to 7, or wherein n3 is in the range of 38 to 40 and m3+o3 is in the range of 5 to 7, —[CH—CH₂-0]4—CH₂CH₂—, wherein m4 is in the range of 8 to 250, and —[CH₂—CH₂—NH]ₘ₅, wherein m5 is in the range of 10 to 100,000.

In the context of the present invention, the term “alkenylene” relates to acyclic unsaturated hydrocarbon groups having at least one double bond, preferably 1, 2 or 3 double bonds, and may be branched or linear and unsubstituted or at least monosubstituted with as in the case of C₂-C₃₀ alkenylene 2 to 30 (i.e. 2, 3, 4, 5, 6, 7, 8, 9, 10, 11, 12, 13, 14, 15, 16, 17, 18, 19, 20, 21, 22, 23, 24, 25, 26, 27, 28, 29 or 30)C-atoms, more preferably C₂-C₂₀ alkenylene, most preferably C₂-C₁₀ alkenylene, and in particular C₂-C₆ alkenylene. Representative examples of alkenylene include, but are not limited to, —CH═CH— and —CH—CH═CH—.

In the context of the present invention, the term “heteroalkenylene” relates to an alkenylene group as described above, in which one or more carbon atoms have been replaced with heteroatoms each independently selected from the group consisting of oxygen, sulfur and nitrogen (NH). The heteroalkenylene groups can preferably have 1, 2 or 3 heteroatom (s), particularly preferably 1 heteroatom selected from the group consisting of oxygen, sulfur and nitrogen (NH) as chain link(s). The heteroalkenylene groups can preferably be 3- to 30-membered, particularly preferably 3- to 12-membered, very particularly preferably 3- or 6-membered.

Representative examples of the heteroalkenylene groups include, but are not limited to, —CH═CH—NH—, —CH═CH—O—, —CH═CH—CH₂—O— and —CH═CH—S—.

In the context of the present invention, it is conceivable that if one or more of the substituents denote an alkylene, alkenylene, heteroalkylene and heteroalkenylene or comprises such a group, which is mono- or polysubstituted, this group is preferably substituted with 1, 2, 3, 4 or 5, particularly preferably with 1, 2 or 3, substituents mutually independently selected from the group consisting of phenyl, F, Cl, Br, I, —NO₂, —CN, -O-phenyl, —O—CH₂-phenyl, —SH, —S— phenyl, —S—CH₂-phenyl, —NH₂, —N(C₁₅-alkyl)₂, —NH-phenyl, —N(C₁₅-alkyl)(phenyl), —N(C₁₅-alkyl)(CH₂-phenyl), —N(C₁₅-alkyl)(CH₂—CH₂-phenyl), —C(═O)—H, —C(═O)—C₁₅-alkyl, —C(═O)-phenyl, —C(═S)—C₁₅-alkyl, —C(═S)-phenyl, —C(═O)—OH, —C(═O)—O—C₁₅-alkyl, —C(═O)—O—phenyl, —C(═O)—NH₂, —C(═O)—NH-C₁₅-alkyl, —C(═O)—N(C₁₅-alkyl)₂, —S(═O)—C₁₅-alkyl, -S(═O)-phenyl, —S(═O)₂—C₁₅-alkyl, —S(═O)₂-phenyl, —S(═O)₂—NH₂ and —SO₃H, wherein the above-stated -C₁₅alkyl residues in each case are linear or branched and the above-stated phenyl residues are unsubstituted or substituted with 1, 2, 3, 4 or 5, preferably with 1, 2, 3 or 4, substituents mutually independently selected from the group consisting of F, Cl, Br, I, —CN, —NO₂, —SH, —NH₂, —C(═O)—OH, —C₁₋₅alkyl, —(CH₂)—O—C₁₅-alkyl, —C₂₋₅alkenyl, —C₂₋₅alkynyl, —C -C—Si(CH₃)₃, —C—C—Si(C₂H₅)₃, —S—C₁₅-alkyl, -S-phenyl, —S—CH₂-phenyl, —O—C₁₅-alkyl, —O— phenyl, —O—CH₂-phenyl, —CF₃, —CHF₂, —CH₂F, —O—CF₃, —O—CHF₂, —O—CH₂F, —C(═O)—CF₃, —S—CF₃, —S—CHF₂ and —S—CH₂F. It is conceivable that alkylene, alkenylene, heteroalkylene and heteroalkenylene groups are independently from one another unsubstituted or substituted with 1, 2 or 3 substituents mutually independently selected from the group consisting of phenyl, F, Cl, Br, I, —NO₂, —CN, -O-phenyl, —SH, -S-phenyl, —NH₂, —N(CH₃)₂, —N(C₂H₅)₂ and —N(CH₃)(C₂H₅), wherein the phenyl residue are unsubstituted or substituted with 1, 2, 3, 4 or 5 substituents mutually independently selected from the group consisting of F, Cl, Br, I, —OH, —SH, —NO₂, —CN, —O—CH₃, —O—CF₃, and —O—C₂H₅.

In the context of the present invention, the term “cycloalkylene” relates to saturated cyclic hydrocarbon groups. Representative examples of C₅-C₃₀ cycloalkylene include, but are not limited to, cyclopentylene (e.g., cyclopenta-1,3ylene, cyclopenta-1,2ylene), cyclohexylene (eg, cyclohexa-1,4ylene, cyclohexa-1,3ylene and cyclohexa-1,2ylene), cycloheptylene, cyclooctylene groups (e.g. 1,5cyclooctylene),

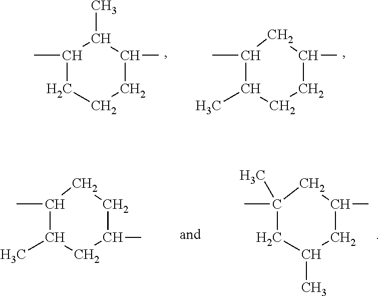

In the context of the present invention, the term “cycloalkylene” also relates to a bridged cyclic hydrocarbon group such as a cyclic hydrocarbon group with 2 to 4 rings having 5 to 30 carbon atoms. Representative examples include, but are not limited to, norbornylene groups (e.g. 1,4-norbornylene group and 2,5-norbornylene group), norbornyl groups (e.g. 2,6-norbornyl), and adamantylene groups (e.g. 1,5-adamantylene group and 2,6-adamantylene group).

In the context of the present invention, the term “heterocycloalkylene” also relates to a cyclic or polycyclic, saturated divalent radical having from 5 to 30 ring members in which carbon atoms are replaced with 1, 2 or 3 heteroatom(s) selected from the group consisting of N, O and S. Representative examples include, but are not limited to, 1,5-dioxaoctylene, 4,8-dioxabicyclo[3.3.0]octylene.

In the context of the present invention, the term “cycloalkenylene” relates to a bivalent cycloalkenyl ring structure, i.e., the cycloalkenyl as defined herein having two single bonds as points of attachment to other groups. Representative examples of “cycloalkenylene” include, but are not limited to, cyclopent-1,2-en-3,5ylene, 3cyclohexene-1,2ylene, 2,5-cyclohexadiene-1,4ylene, cyclohex-1,2-en-3,5ylene, 2,5cyclohexadiene-1,4ylene and cyclo-hept-1,2-en-3,5ylene.

In the context of the present invention, the term “heterocycloalkenylene” relates to a cyclic or polycyclic, nonaromatic unsaturated divalent radical having from 5 to 30 carbon atoms in which carbon atoms are replaced with 1, 2 or 3 heteroatom(s) selected from N, O and S heteroatom and having 1, 2 or 3 double bond(s).

In the context of the present invention, it is conceivable that if one or more of the substituents denote a cycloalkylene, cycloalkenylene, heterocycloalkylene, and heterocycloalkenylene which is mono- or polysubstituted, this group is preferably substituted with 1, 2, 3, 4 or 5, particularly preferably with 1, 2 or 3, substituents mutually independently selected from the group consisting of phenyl, F, Cl, Br, I, —NO₂, —CN, -O-phenyl, —O—CH₂-phenyl, —SH, -S-phenyl, —S—CH₂-phenyl, —NH₂, —N(C₁₅-alkyl)₂, —NH-phenyl, —N(C₁₅-alkyl)(phenyl), —N(C_{1 5}-alkyl)(CH₂-phenyl), —N(C₁₅-alkyl)(CH₂—CH₂-phenyl), —C(═O)—H, —C(═O)—C₁₅-alkyl, —C(═O)-phenyl, —C(═S)—C₁₅-alkyl, —C(═S)-phenyl, —C(═O)—OH, —C(═O)—O—C₁₅-alkyl, —C(═O)-0-phenyl, —C(═O)—NH₂, —C(═O)—NH—C₁₅-alkyl, —C(═O)—N(C₁₅-alkyl)₂, —S(═O)—C₁₅-alkyl, —35 S(═O)-phenyl, —S(═O)₂—C₁₅-alkyl, —S(═O)₂-phenyl, —S(═O)₂—NH₂ and —SO₃H, wherein the above-stated-C₁₅ alkyl residues in each case are linear or branched and the above-stated phenyl residues are unsubstituted or substituted with 1, 2, 3, 4 or 5, preferably with 1, 2, 3 or 4, substituents mutually independently selected from the group consisting of F, Cl, Br, I, —CN, —NO₂, —SH, —NH₂, —C(═O)—OH, —C₁₅ alkyl, —(CH₂)—O—C₁₅-alkyl, —C₂₋₅ alkenyl, —C₂₋₅ alkynyl, —C—C—Si(CH₃)₃, —C—C—Si(C₂H₅)₃, —S—C₁₅-alkyl, -S-phenyl, —S—CH₂-phenyl, —O—C₁₅-alkyl, —0-phenyl, —O—CH₂-phenyl, —CF₃, —CHF₂, —CH₂F, —O—CF₃, —O—CHF₂, —O—CH₂F, —C(═O)—CF₃, —S—CF₃, —S—CHF₂ and —S—CH₂F. It is conceivable that alkylene, alkenylene, heteroalkylene and heteroalkenylene groups are independently from one another unsubstituted or substituted with 1, 2 or 3 substituents mutually independently selected from the group consisting of phenyl, F, Cl, Br, I, —NO₂, —CN, -O-phenyl, —SH, -S-phenyl, —NH₂, —N(CH₃)₂, —N(C₂H₅)₂ and -N(CH₃)(C₂H₅), wherein the phenyl residue is unsubstituted or substituted with 1, 2, 3, 4 or 5 substituents mutually independently selected from the group consisting of F, Cl, Br, I, —SH, —NO₂, —CN, —O—CH₃, —O—CF₃, and —O—C₂H₅.

In the context of the present invention, the term “arylene”, refers to a closed aromatic divalent ring or ring system such as phenylene, naphthylene, biphenylene, fluorenylene, and indenyl.

In the context of the present invention, the term “heteroarylene”, refers to a closed aromatic divalent ring or ring system having at least one heteroatom selected from nitrogen, oxygen and sulfur. Representative examples heteroarylene groups include, but are not limited to, furylene, thienylene, pyridylene, quinolinylene, isoquinolinylene, indolylene, isoindolylene, triazolylene, pyrrolylene, tctrazolylene, imidazolylene, pyrazolylene, oxazolylene, thiazolylene, benzofuranylene, benzothiophenylene, carbazolylene, benzoxazolylene, pyrimidinylene, benzimidazolylene, quinoxalinylene, benzothiazolylene, naphthyridinylene, isoxazolylene, isothiazolylene, purinylene, quinazolinylene, pyrazinylene, 1-oxidopyridylene, pyridazinylene, triazinylene (preferably one or more of victriazinylene, asymtriazinylene, and symtriazinylene), tetrazinylene, oxadiazolylene and thiadiazolylene.

In the context of the present invention, it is conceivable that if one or more of the substituents denote an arylene and a heteroarylene which is mono- or polysubstituted, this is preferably substituted with 1, 2, 3 or 4, particularly preferably with 1, 2 or 3, substituents mutually independently selected from the group consisting of phenyl, F, Cl, Br, I, —NO₂, —CN, —O— phenyl, —O—CH₂-phenyl, —SH, -S-phenyl, —S—CH₂-phenyl, —NH₂, —N(C₁₅-alkyl)₂, —NH-phenyl, —N(C₁₅-alkyl)(phenyl), —N(C₁₅-alkyl)(CH₂-phenyl), —N(C₁₅-alkyl)(CH₂—CH₂-phenyl), —C(═O)—H, —C(═O)—C₁₅-alkyl, —C(═O)-phenyl, —C(═S)—C₁₅-alkyl, —C(═S)-phenyl, —C(═O)—OH, —C(═O)—O—C₁₅-alkyl, —C(═O)—O—phenyl, —C(═O)—NH₂, —C(═O)—NH—C₁₅-alkyl, —C(═O)—N(C₁₅-alkyl)₂, —S(═O)—C₁₅-alkyl, —S(═O)-phenyl, —S(═O)₂—C₁₅-alkyl, —S(═O)₂-phenyl, -S(═O)₂—NH₂ and —SO₃H, wherein the above-stated-C₁₋₅alkyl residues in each case are linear or branched and the above-stated phenyl residues are unsubstituted or substituted with 1, 2, 3, 4 or 5, preferably with 1, 2, 3 or 4, substituents mutually independently selected from the group consisting of F, Cl, Br, I, —CN, —NO₂, —SH, —NH₂, —C(═O)—OH, —C₁₅ alkyl, —(CH₂)—O—C₁₅-alkyl, —C₂₋₅ alkenyl, —C₂₋₅ alkynyl, —C-C-Si(CH₃)₃, —C—C-Si(C₂H₅)₃, —S—C₁₅-alkyl, —S— phenyl, —S—CH₂-phenyl, —O—C₁₅-alkyl, -O-phenyl, —O—CH₂-phenyl, —CF₃, —CHF₂, —CH₂F, —O—CF₃, —O—CHF₂, —O—CH₂F, —C(═O)—CF₃, —S—CF₃, —S—CHF₂ and —S—CH₂F. It is conceivable that alkylene, alkenylene, heteroalkylene and heteroalkenylene groups are independently from one another unsubstituted or substituted with 1, 2 or 3 substituents mutually independently selected from the group consisting of phenyl, F, Cl, Br, I, —NO₂, —CN, -O-phenyl, —SH, —S— phenyl, —NH₂, —N(CH₃)₂, —N(C₂H₅)₂ and —N(CH₃)(C₂H₅), wherein the phenyl residue is unsubstituted or substituted with 1, 2, 3, 4 or 5 substituents mutually independently selected from the group consisting of F, Cl, Br, I, —SH, —NO₂, —CN, —O—CH₃, —O—CF₃, and —O—C₂H₅.

In the context of the present invention, the term “alkyl” refers to acyclic saturated hydrocarbon residues, which may be branched or linear and unsubstituted or at least monosubstituted with, as in the case of C₁-C₃₀ alkyl, 1 to 30 (i.e. 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30) C atoms or with, as in the case of C₁-C₅ alkyl, 1 to 5 (i.e. 1, 2, 3, 4 or 5) C atoms. In the context of the present invention, it is conceivable that if one or more of the substituents denote an alkyl or comprise an alkyl which is mono- or polysubstituted, this is preferably substituted with 1, 2, 3, 4 or 5, particularly preferably with 1, 2 or 3, substituents mutually independently selected from the group consisting of F, Cl, Br, I, —OH, —NO₂, —CN, —SH, -N H₂, —N(C₁₅-alkyl)₂, —N(C₁₅-alkyl)(phenyl), —N(C₁₅-alkyl)(CH₂-phenyl), —N(C₁₅-alkyl)(CH₂—CH₂-phenyl), —C(═O)—H, —C(═O)—C₁₅-alkyl, —C(═O)-phenyl, —C(═S)—C₁₅-alkyl, —C(═S)-phenyl, —C(═O)—OH, —C(═O)—O—C₁₅-alkyl, —C(═O)—)-phenyl, —C(═O)—NH₂, —C(═O)—NH—C₁₅-alkyl, —C(═O)—N(C₁₅-alkyl)₂, —S(═O)—C₁₅-alkyl, —S(═O)-phenyl, —S(═O)₂—C₁₅-alkyl, —S(═O)₂-phenyl, —S(═O)₂—NH₂ and —SO₃H, wherein the above-stated C₁₅-alkyl residues are in each case linear or branched and the above-stated phenyl residues are unsubstituted or substituted with 1, 2, 3, 4 or 5 substituents mutually independently selected from the group consisting of F, Cl, Br, I, —CN, —CF₃, —NH₂, —O—CF₃, —SH, —O—CH₃, —O—C₂H₅, —O—C₃H₇, methyl, ethyl, n-propyl, isopropyl, n-butyl, 2-butyl, iso-butyl and tert-butyl. Particularly preferred substituents may be selected mutually independently from the group consisting of F, Cl, Br, I, —NO₂, —CN, —SH, —NH₂, —N(CH₃)₂, —N(C₂H₅)₂ and —N(CH₃)(C₂H₅).

In the context of the present invention, an unsubstituted linear C₁-C₃₀ alkyl preferably refers to an alkyl selected from the group consisting of methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, henicosyl, docosyl, tricosyl and tetracosyl; more preferably selected from the group consisting of hexyl, heptyl, octyl, nonyl, decyl, undecyl, dodecyl, tridecyl, tetradecyl, pentadecyl, hexadecyl, heptadecyl, octadecyl, nonadecyl, eicosyl, henicosyl, docosyl, tricosyl and tetracosyl; more preferably selected from the group consisting of methyl, ethyl, propyl, butyl, pentyl, hexyl, heptyl, octyl, nonyl, decyl, undecyl, dodecyl, tridecyl, tetradecyl and pentadecyl; more preferably selected from the group consisting of methyl, ethyl, propyl, butyl, pentyl, hexyl, heptyl, octyl, nonyl, decyl, undecyl and dodecyl; and more preferably selected from the group consisting of methyl, ethyl, propyl, butyl, pentyl, hexyl, heptyl, octyl, nonyl and decyl.

In the context of the present invention, an unsubstituted branched C₁-C₃₀ alkyl preferably refers to an alkyl selected from the group consisting of isopropyl, iso-butyl, sec-butyl, tert-butyl, sec-isopentyl, 2-pentyl, 2-methyl-4-pentyl, 3-pentyl, neo-pentyl, 2-methyl-pentyl, 2-ethyl-hexyl, 2-propyl-heptyl, 2-butyl-octyl, 2-pentyl-nonyl, 2-hexyl-decyl, iso-hexyl, iso-heptyl, 2,6-dimethyl-4-heptyl, iso-octyl, iso-nonyl, iso-decyl, iso-dodecyl, iso-tetradecyl, iso-hexadecyl, iso-octadecyl, iso-eicosyl, and 3-pinanyl-methyl, more preferably selected from the group consisting of 2-ethyl-hexyl, 2-propyl-heptyl, 2-butyl-octyl, 2-pentyl-nonyl, 2-hexyl-decyl, iso-hexyl, iso-heptyl, iso-octyl, iso-nonyl, iso-decyl, iso-dodecyl, iso-tetradecyl, iso-hexadecyl, iso-octadecyl, iso-eicosyl, 2-methyltricosyl, 2-ethyldocosyl, 3-ethylhenicosyl, 3-ethylicosyl, 4-propylhenicosyl, propylnonadecyl, 6-butyldodecyl and 5-ethylundecyl. In the context of the present invention, a polysubstituted alkyl is understood to be an alkyl which is either poly-, preferably di- or trisubstituted, either on different or on the same C atoms, for example trisubstituted on the same C atom as in the case of -CF₃, or at different locations as in the case of —(CHCl)—(CH₂F). Polysubstitution may proceed with identical or different substituents. Representative examples of substituents include, but are not limited to, —CH₃, —CF₃, —CF₂H, —CFH₂, —(CH₂)—OH, —(CH₂)—NH₂, —(CH₂)—CN, —(CH₂)—(CF₃), —(CH₂)—(CH F₂), —(CH₂)—(CH₂F), —(CH₂)—(CH₂)—O—CH₃, —(CH₂)—(CH₂)—NH₂, —(CH₂)—(CH₂)—CN, —(CF₂)—(CF₃), —(CH₂)—(CH₂)—(CF₃), and —(CH₂)—(CH₂)—(CH₂)—O—CH₃.

In the context of the present invention, a substituted, linear or branched, C₁-C₃₀ alkyl also refers to a branched or linear saturated hydrocarbon group having C₁-C₃₀ carbon atoms substituted with functional groups selected from the group consisting of F, Cl, Br, I, —OH, 2-furanyl, —NO₂, —CN, —SH, -N H₂, —N(C₁₅-alkyl)₂, —N(C₁₅-alkyl)(phenyl), —N(C₁₅-alkyl)(CH₂— phenyl), —N(C₁₅-alkyl)(CH₂—CH₂-phenyl), —C(═O)—H, —C(═O)—C₁₅-alkyl, —C(═O)-phenyl, —C(═S)—C₁₅-alkyl, —C(═S)-phenyl, —C(═O)—OH, —C(═O)—O—C₁₅-alkyl, —C(═O)—)-phenyl, —C(═O)—NH₂, —C(═O)—NH—C₁₅-alkyl, —C(═O)—N(C₁₅-alkyl)₂, —S(═O)—C₁₅-alkyl, —S(═O)-phenyl, —S(═O)₂—C₁₅-alkyl, —S(═O)₂-phenyl, —S(═O)₂—NH₂ and —SO₃H, wherein the above-stated C_{1 5}-alkyl residues are in each case linear or branched and the above-stated phenyl residues are preferably unsubstituted or substituted with 1, 2, 3, 4 or 5 substituents mutually independently selected from the group consisting of F, Cl, Br, I, —CN, —CF₃, —NH₂, —O—CF₃, —SH, —O—CH₃, —O—C₂H₅, —O—C₃H₇, methyl, ethyl, n-propyl, isopropyl, n-butyl, 2-butyl, isobutyl and tert-butyl. Particularly preferred substituents may be selected mutually independently from the group consisting of F, Cl, Br, I, —NO₂, —CN, —SH, —NH₂, —N(CH₃)₂, —N(C₂H₅)₂ and —N(CH₃)(C₂H₅).

In the context of the present invention, a substituted, linear or branched, C₁-C₃₀ alkyl also refers to a branched or linear saturated hydrocarbon group having C₁-C₃₀ carbon atoms substituted with functional groups selected from the group consisting of hydroxy, alkoxy, C(═O)R, CN and SR, preferably selected from the group consisting of 1-methoxy methyl, 1-methoxy methyl, 1-methoxy ethyl, 1-methoxy propyl, 1-methoxy butyl, 2-hydroxy-butyl, 1-methoxy pentyl, 1-methoxy hexyl, 1-methoxy heptyl, 1-methoxy octyl, 1-methoxy nonyl, decyl, 1-methoxy undecyl, 1-methoxy dodecyl, 1-methoxy tridecyl, 1-methoxy tetradecyl, 1-methoxy pentadecyl, 1-methoxy hexadecyl, 1-methoxy heptadecyl, 1-methoxy octadecyl, 1-methoxy nonadecyl, 1-methoxy eicosyl, 1-methoxy henicosyl, 1-methoxy docosyl, 1-methoxy tricosyl, 1-methoxy tetracosyl, 2-methoxy propyl, 2-methoxy butyl, 2-methoxy pentyl, 2-methoxy hexyl, 2-methoxy heptyl, 2-methoxy octyl, 2-methoxy nonyl, decyl, 2-methoxy undecyl, 2-methoxy dodecyl, 2-methoxy tridecyl, 2-methoxy tetradecyl, 2-methoxy pentadecyl, 2-methoxy hexadecyl, 2-methoxy heptadecyl, 2-methoxy octadecyl, 2-methoxy nonadecyl, 2-methoxy eicosyl, 2-methoxy henicosyl, 2-methoxy docosyl, 2-methoxy tricosyl, 2-methoxy tetracosyl, 1-acetoxy methyl, 1-acetoxy ethyl, 1-acetoxy propyl, 1-acetoxy butyl, 1-acetoxy pentyl, 1-acetoxy hexyl, 1-acetoxy heptyl, 1-acetoxy octyl, 1-acetoxy nonyl, decyl, 1-acetoxy undecyl, 1-acetoxy dodecyl, 1-acetoxy tridecyl, 1-acetoxy tetradecyl, 1-acetoxy pentadecyl, 1-acetoxy hexadecyl, 1-acetoxy heptadecyl, 1-acetoxy octadecyl, 1-acetoxy nonadecyl, 1-acetoxy eicosyl, 1-acetoxy henicosyl, 1-acetoxy docosyl, 1-acetoxy tricosyl, 1-acetoxy tetracosyl, 1-cyano methyl, 1-cyano ethyl, 1-cyano propyl, 1-cyano butyl, 1-cyano pentyl, 1-cyano hexyl, 1-cyano heptyl, 1-cyano octyl, 1-cyano nonyl, decyl, 1-cyano undecyl, 1-cyano dodecyl, 1-cyano tridecyl, 1-cyano tetradecyl, 1-cyano pentadecyl, 1-cyano hexadecyl, 1-cyano heptadecyl, 1-cyano octadecyl, 1-cyano nonadecyl, 1-cyano eicosyl, 1-cyano henicosyl, 1-cyano docosyl, 1-cyano tricosyl, 1-cyano tetracosyl, 2-cyano propyl, 2-cyano butyl, 2-cyano pentyl, 2-cyano hexyl, 2-cyano heptyl, 2-cyano octyl, 2-cyano nonyl, decyl, 2-cyano undecyl, 2-cyano dodecyl, 2-cyano tridecyl, 2-cyano tetradecyl, 2-cyano pentadecyl, 2-cyano hexadecyl, 2-cyano heptadecyl, 2-cyano octadecyl, 2-cyano nonadecyl, 2-cyano eicosyl, 2-cyano henicosyl, 2-cyano docosyl, 2-cyano tricosyl, 2-cyano tetracosyl, 1-thioyl methyl, 1-thioyl ethyl, 1-thioyl propyl, 1-thioyl butyl, 1-thioyl pentyl, 1-thioyl hexyl, 1-thioyl heptyl, 1-thioyl octyl, 1-thioyl nonyl, decyl, 1-thioyl undecyl, 1-thioyl dodecyl, 1-thioyl tridecyl, 1-thioyl tetradecyl, 1-thioyl pentadecyl, 1-thioyl hexadecyl, 1-thioyl heptadecyl, 1-thioyl octadecyl, 1-thioyl nonadecyl, 1-thioyl eicosyl, 1-thioyl henicosyl, 1-thioyl docosyl, 1-thioyl tricosyl and 1-thioyl tetracosyl.

In the context of the present invention, the term “alkenyl” refers to unsubstituted, linear C₂-C₃₀ alkenyl. Representative examples of the alkenyl include, but are not limited to, 1-propenyl, 1-butenyl, 1-pentenyl, 1-hexenyl,2-hexenyl, 1-heptenyl, 2-heptenyl, 1-octenyl, 2-octenyl, 1-nonenyl, 2-nonenyl,1-decenyl, 2-decenyl,1-undecenyl, 2-undecenyl, 1-dodecenyl, 2-dodecenyl,1-tridecenyl, 2-tridecenyl, 1-tetradecenyl,2-tetradecenyl, 1-pentadecenyl,2-pentadecenyl, 1-hexadecenyl,2-hexadecenyl, 1-heptadecenyl,2-heptadecenyl, 1-octadecenyl,2-octadecenyl, 1-nonadecenyl, 2-nonadecenyl,1-eicosenyl and 2-eicosenyl, more preferably selected from 1-hexenyl,2-hexenyl, 1-heptenyl, 2-heptenyl, 1-octenyl, 2-octenyl, 1-nonenyl, 2-nonenyl,1-decenyl, 2-decenyl,1-undecenyl, 2-undecenyl, 1-dodecenyl, 2-dodecenyl,1-tridecenyl, 2-tridecenyl, 1-tetradecenyl,2-tetradecenyl, 1-pentadecenyl,2-pentadecenyl, 1-hexadecenyl,2-hexadecenyl, 1-heptadecenyl,2-heptadecenyl, 1-octadecenyl,2-octadecenyl, 1-nonadecenyl, 2-nonadecenyl,1-eicosenyl and 2-eicosenyl, 20-henicosenyl, 2-docosenyl, 6-tricosenyl and 2-tetracosenyl.

Representative examples of the unsubstituted branched C₂-C₃₀ alkenyl include, but are not limited to, isopropenyl, iso-butenyl, neo-pentenyl, 2-ethyl-hexenyl, 2-propyl-heptenyl, 2-butyl-octenyl, 2-pentyl-nonenyl, 2-hexyl-decenyl, iso-hexenyl, iso-heptenyl, iso-octenyl, iso-nonenyl, iso-decenyl, iso-dodecenyl, iso-tetradecenyl, iso-hexadecenyl, iso-octadecenyl, iso-eicosenyl, 2-methyl tricosenyl, 2-ethyl docosenyl, 3-ethylhenicosenyl, 3-ethyl icosenyl, 4-propylhenicosenyl, 4-propylnonadecenyl, 6-butyldodecenyl, 5-ethylundedcenyl, 1,4-hexadienyl, 1,3-hexadienyl, 2,5-hexadienyl, 3,5-hexadienyl, 2,4-hexadienyl, 1,3,5-hexatrienyl, 1,3,6-heptatrienyl, 1,4,7-octatrienyl or 2-methyl-1,3,5 hexatrienyl, 1,3,5,7-octatetraenyl, 1,3,5,8-nonatetraenyl, 1,4,7,10-undecatetraenyl, 2-ethyl-1,3,6,8-nonatetraenyl, 2-ethenyl-1,3,5,8-nonatetraenyl, 1,3,5,7,9-decapentaenyl, 1,4,6,8,10-undecapentaenyl, and 1,4,6,9,11-dodecapentaenyl.

In the context of the present invention, a substituted, linear or branched, C₂-C₃₀ alkenyl refers to a branched or a linear unsaturated hydrocarbon group having C₂-C₃₀ carbon atoms substituted with functional groups selected from alkoxy, C(═O)R, CN and SR; wherein R is hydrogen, substituted or unsubstituted, linear or branched C₁-C₃₀ alkyl, substituted or unsubstituted, linear or branched C₂-C₃₀ alkenyl, substituted or unsubstituted C₅-C₃₀ cycloalkyl, substituted or unsubstituted C₅-C₃₀ cycloalkenyl, substituted or unsubstituted C₆-C₃₀ aryl, substituted or unsubstituted C₇-C₃₀ arylalkyl.

In the context of the present invention, the term “alkenyl” further refers to a branched or an linear unsaturated hydrocarbon group having C₂-C₃₀ carbon atoms substituted with functional groups selected from, alkoxy, C(═O)R, CN and SR; preferably selected from the group consisting of 1-methoxy ethenyl, 2-methoxy propenyl, 4-methoxy butenyl, 3-methoxy pentenyl, 5-methoxy hexenyl, 2-methoxy heptenyl, 5-methoxy octenyl, 3-methoxy nonenyl, 6-methoxy undecenyl, 1-methoxy dodec-2-enyl, 1-methoxy tridec-5-enyl, 3-methoxy tetradic-5-enyl, 3-methoxy pentade-12-encyl, 10-methoxy hexadec-15-enyl, 12-methoxy heptadic-16-enyl,1-methoxy octadec-3-enyl, 1-methoxy nonadec-2-enyl, 1-methoxy eicos-20-enyl, 1-methoxy henicos-2-enyl, 1-methoxy docos-4-enyl, 1-methoxy tricos-22-enyl, 1-methoxy tetracos-23-enyl, 2-methoxy prop-1-enyl, 2-methoxy but-1-enyl, 2-methoxy pent-4-enyl, 2-methoxy hex-2-enyl, 2-methoxy hept-3-enyl, 2-methoxy oct-7-enyl, 2-methoxy non-5-enyl, 2-methoxy undec-10-enyl, 2-methoxy dodec-4-enyl, 2-methoxy tridec-12-enyl, 2-methoxy tetradic-10-enyl, 2-methoxy pentadec-14-enyl, 2-methoxy hexadec-1-enyl, 2-methoxy heptadic-1-enyl, 2-methoxy octadic-12-enyl, 2-methoxy nonadec-10-enyl, 2-methoxy eicos-18-enyl, 2-methoxy henicos-2-enyl, 2-methoxy docos-3-enyl, 20-methoxy tricos-2-enyl, 21-methoxy tetracos-4-enyl, 1-acetoxy ethenyl, 1-acetoxy prop-1-enyl, 1-acetoxy but-2-enyl, 1-acetoxy pent-4-enyl, 1-acetoxy hex-2-enyl, 1-acetoxy hept-1-enyl, 1-acetoxy oct-7-enyl, 1-acetoxy non-2-enyl, 5-acetoxy dec-3-enyl, 1-acetoxy undec-10-enyl, 1-acetoxy dodec-2-enyl, 1-acetoxy tridec-12-enyl, 10-acetoxy tetradec-2-enyl, 15-acetoxy pentadec-2-enyl, 10-acetoxy hexadec-2-enyl, 11-acetoxy heptadec-1-enyl, 13-acetoxy octadec-2-enyl, 1-acetoxy nonadec-14-enyl, 20-acetoxyeicos-19-enyl, 1-acetoxy henicos-2-enyl, 1-acetoxy docos-10-enyl, 1-acetoxy tricos-22-enyl, 1-acetoxy tetracos-23-enyl, 1-cyano eth-1-enyl, 1-cyano prop-2-enyl, 1-cyano but-2-enyl, 1-cyano pent-3-enyl, 1-cyano hex-5-enyl, 1-cyano hept-6-enyl, 1-cyano oct-2-enyl, 1-cyano non-3-enyl, 11-cyano undec-2-enyl, 10-cyano dodec-2-enyl, 10-cyano tridec-12-enyl, 1-cyano tetradec-3-enyl, 1-cyano pentadec-14-enyl, 1-cyano hexadec-15-enyl, 1-cyano heptadec-2-enyl, 1-cyano octadec-3-enyl, 1-cyano nonadec-18-enyl, 1-cyano eicos-10-enyl, 1-cyano henicos-20-enyl, 15-cyano docos-3-enyl, 1-cyano tri-cos-20-enyl, 1-cyano tetracos-2-enyl, 2-cyano prop-2-enyl, 2-cyano but-1-enyl, 2-cyano pent-1-enyl, 2-cyano hex-3-enyl, 2-cyano hept-6-enyl, 2-cyano oct-1-enyl, 2-cyano non-8-enyl, 2-cyano undec-10-enyl, 2-cyano dodec-1-enyl, 2-cyano tridec-12-enyl, 2-cyano tetradec-10-enyl, 2-cyano pentadec-3-enyl, 2-cyano hexadec-2-enyl, 2-cyano heptadec-1-enyl, 2-cyano octadec-12-enyl, 2-cyano nonadec-15-enyl, 2-cyano eicos-1-enyl, 2-cyano henicos-5-enyl, 2-cyano docos-20-enyl, 2-cyano tricos-22-enyl, 2-cyano tetracos-20-enyl, 1-thionyl eth-1-enyl, 1-thionyl prop-2-enyl, 1-thionyl but-2-enyl, 1-thionyl pent-4-enyl, 1-thionyl hex-2-enyl, 1-thionyl hept-5-enyl, 1-thionyl oct-3-enyl, 1-thionyl non-5-enyl, 1-thionyl undec-10-enyl, 1-thionyl dodec-11-enyl, 1-thionyl tridec-2-enyl, 1-thionyl tetradec-4-enyl, 1-thionyl pentadec-5-enyl, 1-thionyl hexadec-3-enyl, 1-thionyl heptadec-2-enyl, 1-thionyl octadec-3-enyl, 1-thionyl nonadec-15-enyl, 1-thionyl eicos-18-enyl, 1-thionyl henicos-20-enyl, 1-thionyl docos-21-enyl, 1-thionyl tricos-20-enyl and 1-thionyl tetracos-22-enyl.

In the context of the present invention, the term “heteroalkyl” refers to an alkyl group, in which one or more carbon atoms have in each case been replaced by a heteroatom mutually independently selected from the group consisting of oxygen, sulfur and nitrogen (NH). A heteroalkyl preferably comprises 1, 2 or 3 heteroatom(s) mutually independently selected from the group consisting of oxygen, sulfur and nitrogen (NH) as chain link(s). Further, a heteroalkyl may be 2- to 12-membered, preferably 2- to 6-membered.

In the context of the present invention, the term “heteroalkenyl” refers to an alkenyl group, in which one or more carbon atoms have in each case been replaced by a heteroatom mutually independently selected from the group consisting of oxygen, sulfur and nitrogen (NH).

A heteroalkenyl preferably comprises 1, 2 or 3 heteroatom(s) mutually independently selected from the group consisting of oxygen, sulfur and nitrogen (NH) as chain link(s). Further, a heteroalkenyl may be 3- to 12-membered, preferably 3- to 6-membered.

In the context of the present invention, the term “cycloalkyl” refers to a monocyclic and bicyclic saturated cycloaliphatic radical having 5 to 30 carbon atoms. Representative examples of unsubstituted or branched C₅-C₃₀ monocyclic and bicyclic cycloalkyl include, but are not limited to, cyclopentyl, cyclohexyl, dicyclohexylmethyl, cyclohexylmethyl, cyclododecyl, cycloheptyl, cyclooctyl, bicyclo[2.2.1]heptyl, and bicyclo[3.1.1]heptyl.

In the context of the present invention, a C₅-C₃₀ monocyclic and bicyclic cycloalkyl can be further branched with one or more equal or different alkyl groups such as methyl, ethyl, n-propyl, iso-propyl, n-butyl, iso-butyl, n-pentyl, iso-pentyl, neo-pentyl etc. The representative examples of branched C₃-C₁₀ monocyclic and bicyclic cycloalkyl include, but are not limited to, methyl cyclohexyl and dimethyl cyclohexyl.

In the context of the present invention, the term “cycloalkenyl” refers to a monocyclic and bicyclic unsaturated cycloaliphatic radical having 5 to 30 carbon atoms, which comprises one or more double bonds. Representative examples of C₅-C₃₀ cycloalkenyl include, but are not limited to, cyclopentenyl, cyclohexenyl, cycloheptenyl, cyclooctenyl, cyclononenyl or cyclodecenyl. These radicals can be branched with one or more equal or different alkyl radical, preferably with methyl, ethyl, n-propyl or iso-propyl. The representative examples of branched C₅-C₃₀ monocyclic and bicyclic cycloalkenyl include, but are not limited to, methyl cyclohexenyl and dimethyl cyclohexenyl.

In the context of the present invention, the term “heterocycloalkyl” means a nonaromatic monocyclic or polycyclic ring comprising 5 to 30 ring members in which at least one carbon atom as a ring member is replaced with at least one heteroatom selected from O, S, and N.

Representative examples of heterocycloalkyl include, but are not limited to, aziridinyl, pyrrolidinyl, pyrrolidino, piperidinyl, piperidino, piperazinyl, piperazino, morpholinyl, morpholino, thiomorpholinyl, thiomorpholino, tetrahydrofuranyl, tetrahydrothiofuranyl, tetrahydropyranyl and pyranyl.

In the context of the present invention, the term “heterocycloalkenyl” refers to a non-aromatic unsaturated monocyclic or polycyclic ring comprising 5 to 30 ring members in which at least carbon atom as ring member is replaced with at least one heteroatom selected from O, S, and N and having at least one double bond. Representative examples include, but are not limited to, (2,3)-dihydrofuranyl, (2,3)-dihydrothienyl, (2,3)-dihydropyrrolyl, (2,5)-dihydropyrrolyl, (2,5)-dihydropyrrolyl, (2,3)-dihydroisoxazolyl, (1,4)-dihydropyridin-1-yl, di-hydropyranyl, 2,3-dihydropyrazol-1-yl, 2,3-dihydropyrazol-2-yl, 2,3-dihydropyrazol-3-yl, 2,3-dihydro-pyrazol-4-yl, 2,3-dihydropyrazol-5-yl, 3,4-dihydropyrazol-1-yl, 3,4-dihydropyrazol-3-yl, 3,4-dihydropyrazol-4-yl, 3,4-dihydropyrazol-5-yl, 4,5-dihydropyrazol-1-yl, 4,5-dihydropyrazol-3-yl, 4,5-dihydropyrazol-4-yl, 4,5-dihydropyrazol-5-yl, 2,3-dihydrooxazol-2-yl, 2,3-dihydrooxa-zol-3-yl, 2,3-dihydrooxazol-4-yl, 2,3-dihydrooxazol-5-yl, 3,4-dihydrooxazol-2-yl, 3,4-dihydrooxazol-3-yl, 3,4-dihydrooxazol-4-yl, 4,5-dihydropyrazol-2-yl, 4,5-dihydropyrazol-3-yl, 4,5-dihydropyrazol-4-yl, 4,5-dihydropyrazol-5-yl, 2,5-dihydrothienyl and (1,2,3,4)-tetrahydro-pyridin-1-yl.

In the context of the present invention it is conceivable that if one or more of the substituents denote a heteroalkyl, heteroalkenyl, cycloalkyl, cycloalkenyl, heterocycloalkyl and heterocycloalkenyl which is mono- or polysubstituted, this group is preferably substituted with 1, 2, 3, 4 or 5, particularly preferably with 1, 2 or 3, substituents mutually independently selected from the group consisting of F, Cl, Br, I, —CN, —NO₂, —OH, —SH, —NH₂, oxo (═O), thioxo (═S), —C(═O)—OH, C₁₅ alkyl, —C₂₋₅ alkenyl, —C₂₋₅ alkynyl, —C—C—Si(CH₃)₃, —C—C—Si(C₂H₅)₃, —(CH₂)—O—C₁₅-alkyl, —S—C₁₅-alkyl, -S-phenyl, —S—CH₂-phenyl, —O—C₁₅-alkyl, -O-phenyl, —O—CH₂-phenyl, —CF₃, —CHF₂, —CH₂F, —O—CF₃, —O—CHF₂, —O—CH₂F, —C(═O)—CF₃, —S—CF₃, —S—CHF₂, —S—CH₂F, —S(═O)₂-phenyl, —S(═O)₂—C₁₅-alkyl, —S(═O)—C₁₅-alkyl, —NH—C₁₅-alkyl, N(C₁₅alkyl)(C₁₅-alkyl), —C(═O)—O—C₁₅-alkyl, —C(═O)—H, —C(═O)—C₁₅-alkyl, —CH₂—O—C(═O)-phenyl, —O—C(═O)-phenyl, —NH—S(═O)₂—C₁₅-alkyl, —NH—C(═O)—C₁₅-alkyl, —C(═O)-NH₂, —C(═O)—NH—C₁₅-alkyl, —C(═O)—N(C₁₅-alkyl)₂, pyrazolyl, phenyl, furyl(furanyl), thiadiazolyl, thiophenyl(thienyl) and benzyl, wherein the above-stated C₁₋₅alkyl residues are in each case linear or branched and the cyclic substituents or the cyclic residues of these substituents themselves are in each case unsubstituted or substituted with 1, 2, 3, 4 or 5, preferably with 1, 2, 3 or 4, substituents mutually independently selected from the group consisting of F, Cl, Br, I, —CN, —CF₃, —OH, —NH₂, —O—CF₃, —SH, —O—C₁₅-alkyl, -O-phenyl, —O—CH₂— phenyl, —(CH₂)—O—C₁₅-alkyl, —S—C₁₅-alkyl, -S-phenyl, —S—CH₂-phenyl, —C₁₅ alkyl, —C₂₋₅ alkenyl, —C₂₋₅ alkynyl, —CC-Si(CH₃)₃, —CC-Si(C₂H₅)₃, —C(═O)—O—C₁₋₅-alkyl and —C(═O)-CF₃.

In the context of the present invention, the term “aryl” refers to aromatic compounds that may have more than one aromatic ring. The representative examples for substituted and unsubstituted C₆-C₃₀ aryl include, but are not limited to, phenyl, benzyl, cyclohexyl(phenyl)methyl, naphthyl, anthracenyl, tetraphenyl, phenalenyl and phenanthrenyl.

In the context of the present invention, the term “heteroaryl” refers to a monocyclic or polycyclic, preferably a mono-, bi- or tricyclic aromatic hydrocarbon residue with preferably 5, 6, 7, 8, 9, 10, 11, 12, 13, 14, 15, 16, 17, 18, 19, 20, 21, 22, 23, 24, 25, 26, 27, 28, 29 or 30 ring members, particularly preferably with 5, 6, 9, 10, 13 or 14 ring atoms, very particularly preferably with 5 or 6 ring members, in which one or more carbon atoms as ring members have been replaced with heteroatoms each independently selected from the group consisting of oxygen, sulfur and nitrogen (NH). A heteroaryl may comprise 1, 2, 3, 4 or 5, preferably 1, 2 or 3, heteroatom(s) mutually independently selected from the group consisting of oxygen, sulfur and nitrogen (NH) as ring member(s) A heteroaryl can be unsubstituted or monosubstituted or identically or differently polysubstituted. Representative examples of heteroaryl include, but are not limited to, thienyl, furyl, pyrrolyl, pyrazolyl, pyrazinyl, pyranyl, triazolyl, pyridinyl, imidazolyl, indolyl, isoindolyl, benzo[b]furanyl, benzo[b]thiophenyl, benzo[d]thiazolyl, benzodiazolyl, benzotriazolyl, benzoxazolyl, benzisoxazolyl, thiazolyl, thiadiazolyl, oxazolyl, oxadiazolyl, isoxazolyl, pyridazinyl, pyrimidinyl, indazolyl, quinoxalinyl, quinazolinyl, quinolinyl, naphthridinyl and isoquinolinyl.

In the context of the present invention, aryl or heteroaryl may be fused (anellated) with a mono- or bicyclic ring system. Representative examples of aryl which are fused with a mono- or bicyclic ring system include, but are not limited to, (1,2,3,4)-tetrahydroquinolinyl, (1,2,3,4)-tetrahydroisoquinolinyl, (2,3)-dihydro-1H-isoindolyl, (1,2,3,4)-tetrahydronaphthyl, (2,3)-dihydrobenzo[1.4]dioxinyl, benzo[1.3]dioxolyl and (3,4)-dihydro-2H-benzo[1.4]oxazinyl.

In the context of the present invention, the term “arylalkyl” refers to an aryl ring attached to an alkyl chain. The representative examples for the arylalkyl include, but are not limited to, 1-phenylmethyl, 1-phenylethyl, 1-phenylpropyl, 1-phenylbutyl, 1-methyl-1-phenyl-propyl, 3-phenylpropyl, 4-phenylbutyl, 3-phenylbutyl and 2-methyl-3-phenyl-propyl.

In the context of the present invention it is conceivable that if one or more of the substituents denote an aryl, heteroaryl or arylalkyl or comprise an aryl or heteroaryl which is mono- or polysubstituted, this may preferably be substituted with 1, 2, 3, 4 or 5, particularly prefer-ably with 1, 2 or 3, substituents mutually independently selected from the group consisting of F, Cl, Br, I, —CN, —NO₂, —SH, —NH₂, —C(═O)—OH, —C₁₅ alkyl, —(CH₂)—O—C₁₅-alkyl, —C₂₋₅ alkenyl, —C₂₋₅ alkynyl, —CC—Si(CH₃)₃, —CC—Si(C₂H₅)₃, —S—C₁₋₅-alkyl, -S-phenyl, —S—CH₂— phenyl, —O—C₁₅-alkyl, -O-phenyl, —O—CH₂-phenyl, —CF₃, —CHF₂, —CH₂F, —O—CF₃, —O—CHF₂, —O—CH₂F, —C(═O)—CF₃, —S—CF₃, —S—CHF₂, —S—CH₂F, —S(═O)₂-phenyl, —S(═O)₂—C₁₅-alkyl, -S(═O)-C₁₅-alkyl, -N H-C₁₅-alkyl, N(C₁₅alkyl)₂, —C(═O)—O—C₁₅-alkyl, —C(═O)—H; —C(═O)—C₁-alkyl, —CH₂—O—C(═O)-phenyl, —O—C(═O)-phenyl, —NH—S(═O)₂—C₁₅-alkyl, —NH—C(═O)—C₁₅-alkyl, —C(═O)—NH₂, —C(═O)—NH-C₁₅-alkyl, —C(═O)—N(C₁₅-alkyl)₂, pyrazolyl, phenyl, furyl(furanyl), thiazolyl, thiadiazolyl, thiophenyl(thienyl), benzyl and phenethyl, wherein the above-stated C₁₋₅alkyl residues are in each case linear or branched and the cyclic substituents or the cyclic residues of these substituents themselves are unsubstituted or substituted with 1, 2, 3, 4 or 5, preferably with 1, 2, 3 or 4, substituents mutually independently selected from the group consisting of F, Cl, Br, I, —CN, —NO₂, —SH, —NH₂, —C(═O)—OH, —C_{1 5} alkyl, —(CH₂)—O—C₁₅-alkyl, —C₂₋₅ alkenyl, —C₂₋₅ alkynyl, —CC—Si(CH₃)₃, —CC—Si(C₂H₅)₃, —S—C₁₅-alkyl, -S-phenyl, —S—CH₂-phenyl, —O—C₁₅-alkyl, -O-phenyl, —O—CH₂-phenyl, —CF₃, —CHF₂, —CH₂F, —O—CF₃, —O—CHF₂, —O—CH₂F, —C(═O)—CF₃, —S—CF₃, —S—CHF₂ and —S—CH₂F; most preferably, the substituents are in each case mutually independently selected from the group consisting of F, Cl, Br, I, —CN, —NO₂, methyl, ethyl, n-propyl, isopropyl, n-butyl, isobutyl, 2-butyl, tert.-butyl, n-pentyl, neopentyl, ethenyl, allyl, ethynyl, propynyl, —C—C—Si(CH₃)₃, —C—C—Si(C₂H₅)₃, —CH₂—O—CH₃, —CH₂—O—C₂H₅, -S H, —NH₂, —C(═O)—OH, —S—CH₃, —S—C₂H₅, —S(═O)—CH₃, —S(═O)₂—CH₃, —S(═O)—C₂H₅, —S(═O)₂—C₂H₅, —O—CH₃, —O—C₂H₅, —O—C₃H₇, —O—C(CH₃)₃, —CF₃, —CHF₂, —CH₂F, —O—CF₃, —O—CHF₂, —O—CH₂F, —C(═O)—CF₃, —S—CF₃, —S—CHF₂, —S—CH₂F, —S(═O)-phenyl, pyrazolyl, phenyl, —N(CH₃)₂, —N(C₂H₅)₂, —NH—CH₃, —NH—C₂H₅, —CH₂—O—C(═O)-phenyl, —NH—S(═O)₂—CH₃, —C(═O)—O—CH₃, —C(═O)—O—C₂H₅, —C(═O)—O—C(CH₃)₃, —C(═O)—H, —C(═O)—CH₃, —C(═O)—C₂H₅, —NH—C(═O)—CH₃, -N H—C(═O)—C₂H₅, —O—C(═O)-phenyl, —C(═O)—NH₂, —C(═O)—NH—CH₃, —C(═O)—N(CH₃)₂, phenyl, furyl(furanyl), thiadiazolyl, thiophenyl(thienyl) and benzyl, wherein the cyclic substituents or the cyclic residues of these substituents themselves are in each case unsubstituted or substituted with 1, 2, 3, 4, or 5, preferably with 1, 2, 3 or 4, substituents mutually independently selected from the group consisting of F, Cl, Br, I, —CN, —NO₂, —SH, —NH₂, —C(═O)—OH, methyl, ethyl, n-propyl, isopropyl, n-butyl, isobutyl, 2-butyl, tert.-butyl, n-pentyl, neopentyl, ethenyl, allyl, ethynyl, propynyl, —C—C—Si(CH₃)₃, —C—C—Si(C₂H₅)₃, —CH₂—O—CH₃, —CH₂—O—C₂H₅, —S—CH₃, —S—C₂H₅, —S(═O)—CH₃, —S(═O)₂—CH₃, —S(═O)—C₂H₅, —S(═O)₂—C₂H₅, —O—CH₃, —O—C₂H₅, —O—C₃H₇, —O—C(CH₃)₃, —CF₃, —CHF₂, —CH₂F, —O—CF₃, —O—CHF₂, —O—CH₂F, —C(═O)—CF₃, —S—CF₃, —S—CHF₂ and —S—CH₂F.

In the context of the present invention, a substituted aryl may be selected from the group consisting of 2-methylphenyl, 3-methylphenyl, 4-methylphenyl, 2-fluorophenyl, 3-fluorophenyl, 4-fluorophenyl, 2-cyanophenyl, 3-cyanophenyl, 4-cyanophenyl, 2-aminophenyl, 3-aminophenyl, 4-aminophenyl, 2-dimethylaminophenyl, 3-dimethylaminophenyl, 4-dimethylaminophenyl, 2-methylaminophenyl, 3-methylaminophenyl, 4-methylaminophenyl, 2-acetylphenyl, 3-acetylphenyl, 4-acetylphenyl, 2-methylsulfinylphenyl, 3-methylsulfinylphenyl, 4-methylsulfinylphenyl, 2-methylsulfonylphenyl, 3-methylsulfonylphenyl, 4-methylsulfonylphenyl, 2-methoxyphenyl, 3-methoxyphenyl, 4-methoxyphenyl, 2-chlorophenyl, 3-chlorophenyl, 4-chlorophenyl, 2-ethoxyphenyl, 3-ethoxyphenyl, 4-ethoxyphenyl, 2-trifluoromethylphenyl, 3-trifluoromethylphenyl, 4-trifluoromethylphenyl, 2-difluoromethylphenyl, 3-difluoromethylphenyl, 4-difluoromethylphenyl, 2-fluoromethylphenyl, 3-fluoromethylphenyl, 4-fluoromethylphenyl, 2-nitrophenyl, 3-nitrophenyl, 4-nitrophenyl, 2-ethylphenyl, 3-ethylphenyl, 4-ethylphenyl, 2-propylphenyl, 3-propylphenyl, 4-propylphenyl, 2-isopropylphenyl, 3-isopropylphenyl, 4-isopropylphenyl, 2-tert.-butylphenyl, 3-tert.-butylphenyl, 4-tert.-butylphenyl, 2-carboxyphenyl, 3-carboxyphenyl, 4-carboxyphenyl, 2-ethenylphenyl, 3-ethenylphenyl, 4-ethenylphenyl, 2-ethynylphenyl, 3-ethynylphenyl, 4-ethynylphenyl, 2-allylphenyl, 3-allylphenyl, 4-allylphenyl, 2-trimethylsilanylethynylphenyl, 3-trimethylsilanylethynylphenyl, 4-trimethylsilanylethynylphenyl, 2-formylphenyl, 3-formylphenyl, 4-formylphenyl, 2-acetaminophenyl, 3-acetaminophenyl, 4-acetaminophenyl, 2-dimethylaminocarbonylphenyl, 3-dimethylaminocarbonylphenyl, 4-dimethylaminocarbonylphenyl, 2-methoxymethylphenyl, 3-methoxymethylphenyl, 4-methoxymethylphenyl, 2-ethoxymethylphenyl, 3-ethoxymethylphenyl, 4-ethoxymethylphenyl, 2-aminocarbonylphenyl, 3-aminocarbonylphenyl, 4-aminocarbonylphenyl, 2-methylaminocarbonylphenyl, 3-methylaminocarbonylphenyl, 4-methylaminocarbonylphenyl, 2-carboxymethyl ester phenyl, 3-carboxymethyl ester phenyl, 4-carboxymethyl ester phenyl, 2-carboxyethyl ester phenyl, 3-carboxyethyl ester phenyl, 4-carboxyethyl ester phenyl, 2-carboxy-tert.-butyl ester phenyl, 3-carboxy-tert.-butyl ester phenyl, 4-carboxy-tert.-butyl ester phenyl, 2-methylmercaptophenyl, 3-methylmercaptophenyl, 4-methylmercaptophenyl, 2-ethylmercaptophenyl, 3-ethylmercaptophenyl, 4-ethylmercaptophenyl, 2-biphenyl, 3-biphenyl, 4-biphenyl, 2-bromophenyl, 3-bromophenyl, 4-bromophenyl, 2-iodophenyl, 3-iodophenyl, 4-iodophenyl, 2-trifluoromethoxyphenyl, 3-trifluoromethoxyphenyl, 4-trifluoro-methoxyphenyl, 2-fluoro-3-trifluoro-methylphenyl, 2-fluoro-4-methylphenyl, (2,3)-difluorophenyl, (2,3)-dimethylphenyl, (2,3)-dichlorophenyl, 3-fluoro-2-trifluoro-methylphenyl, (2,4)-dichlorophenyl, (2,4)-difluorophenyl, 4-fluoro-2-trifluoromethylphenyl, (2,4)-dimethoxyphenyl, 2-chloro-4-fluorophenyl, 2-chloro-4-nitrophenyl, 2-chloro-4-methylphenyl, 2-chloro-5-trifluoromethylphenyl, 2-chloro-5-methoxyphenyl, 2-bromo-5-trifluoromethylphenyl, 2-bromo-5-methoxyphenyl, (2,4)-dibromophenyl, (2,4)-dimethylphenyl, 2-fluoro-4-trifluoromethylphenyl, (2,5)-difluorophenyl, 2-fluoro-5-trifluoro-methylphenyl, 5-fluoro-2-trifluoromethylphenyl, 5-chloro-2-trifluoro-methylphenyl, 5-bromo-2-trifluoromethylphenyl, (2,5)-dimethoxyphenyl, (2,5)-bis-trifluoro-methylphenyl, (2,5)-dichlorophenyl, (2,5)-dibromophenyl, 2-methoxy-5-nitrophenyl, 2-fluoro-6-trifluoro-methylphenyl, (2,6)-dimethoxyphenyl, (2,6)-dimethylphenyl, (2,6)-dichlorophenyl, 2-chloro-6-fluorophenyl, 2-bromo-6-chlorophenyl, 2-bromo-6-fluorophenyl, (2,6)-difluorophenyl, (2,6)-difluoro-3-methylphenyl, (2,6)-dibromophenyl, (2,6)-dichlorophenyl, 3-chloro-2-fluorophenyl, 3-chloro-5-methylphenyl, (3,4)-dichlorophenyl, (3,4)-dimethylphenyl, 3-methyl-4-methoxyphenyl, 4-chloro-3-nitrophenyl, (3,4)-dimethoxyphenyl, 4-fluoro-3-trifluoromethylphenyl, 3-fluoro-4-trifluoromethylphenyl, (3,4)-difluorophenyl, 3-cyano-4-fluorophenyl, 3-cyano-4-methylphenyl, 3-cyano-4-methoxyphenyl, 3-bromo-4-fluorophenyl, 3-bromo-4-methylphenyl, 3-bromo-4-methoxyphenyl, 4-chloro-2-fluorophenyl, 4-chloro-3-trifluoromethyl, 4-bromo-3-methylphenyl, 4-bromo-5-methylphenyl, 3-chloro-4-fluorophenyl, 4-fluoro-3-nitrophenyl, 4-bromo-3-nitrophenyl, (3,4)-dibromophenyl, 4-chloro-3-methylphenyl, 4-bromo-3-methylphenyl, 4-fluoro-3-methylphenyl, 3-fluoro-4-methylphenyl, 3-fluoro-5-methylphenyl, 2-fluoro-3-methylphenyl, 4-methyl-3-nitrophenyl, (3,5)-dimethoxyphenyl, (3,5)-dimethylphenyl, (3,5)-bis-trifluoromethylphenyl, (3,5)-difluorophenyl, (3,5)-dinitrophenyl, (3,5)-dichlorophenyl, 3-fluoro-5-trifluoromethylphenyl, 5-fluoro-3-trifluoro-methylphenyl, (3,5)-dibromophenyl, 5-chloro-4-fluorophenyl, 5-chloro-4-fluorophenyl, 5-bromo-4-methylphenyl, (2,3,4)-trifluorophenyl, (2,3,4)-trichlorophenyl, (2,3,6)-trifluorophenyl, 5-chloro-2-methoxyphenyl, (2,3)-difluoro-4-methyl, (2,4,5)-trifluorophenyl, (2,4,5)-trichlorophenyl, (2,4)-dichloro-5-fluorophenyl, (2,4,6)-trichlorophenyl, (2,4,6)-trimethylphenyl, (2,4,6)-trifluorophenyl, (2,4,6)-trimethoxyphenyl, (3,4,5)-trimethoxyphenyl, (2,3,4,5)-tetrafluorophenyl, 4-methoxy-(2,3,6)-trimethylphenyl, 4-methoxy-(2,3,6)-trimethylphenyl, 4-chloro-2,5-dimethylphenyl, 2-chloro-6-fluoro-3-methylphenyl, 6-chloro-2-fluoro-3-methyl, (2,4,6)-trimethylphenyl and (2,3,4,5,6)-pentafluorophenyl.

In the context of the present invention, examples of a substituted heteroaryl are 3-methylpyrid-2-yl, 4-methylpyrid-2-yl, 5-methylpyrid-2-yl, 6-methylpyrid-2-yl, 2-methylpyrid-3-yl, 4-methylpyrid-3-yl, 5-methylpyrid-3-yl, 6-methylpyrid-3-yl, 2-methylpyrid-4-yl, 3-methylpyrid-4-yl, 3-fluoropyrid-2-yl, 4-fluoropyrid-2-yl, 5-fluoropyrid-2-yl, 6-fluoropyrid-2-yl, 3-chloropyrid-2-yl, 4-chloropyrid-2-yl, 5-chloropyrid-2-yl, 6-chloropyrid-2-yl, 3-trifluoro-methylpyrid-2-yl, 4-trifluoromethylpyrid-2-yl, 5-trifluoromethylpyrid-2-yl, 6-trifluoro-methylpyrid-2-yl, 3-methoxypyrid-2-yl, 4-methoxypyrid-2-yl, 5-methoxypyrid-2-yl, 6-meth-oxypyrid-2-yl, 4-methylthiazol-2-yl, 5-methylthiazol-2-yl, 4-trifluoromethylthiazol-2-yl, 5-tri-fluoromethylthiazol-2-yl, 4-chlorothiazol-2-yl, 5-chlorothiazol-2-yl, 4-bromothiazol-2-yl, 5-bromothiazol-2-yl, 4-fluorothiazol-2-yl, 5-fluorothiazol-2-yl, 4-cyanothiazol-2-yl, 5-cyanothi-azol-2-yl, 4-methoxythiazol-2-yl, 5-methoxythiazol-2-yl, 4-methyloxazol-2-yl, 5-methyloxazol-2-yl, 4-trifluoromethyloxazol-2-yl, 5-trifluoromethyloxazol-2-yl, 4-chlorooxazol-2-yl, 5-chlorooxazol-2-yl, 4-bromooxazol-2-yl, 5-bromooxazol-2-yl, 4-fluorooxazol-2-yl, 5-fluorooxa-zol-2-yl, 4-cyanooxazol-2-yl, 5-cyanooxazol-2-yl, 4-methoxyoxazol-2-yl, 5-methoxyoxazol-2-yl, 2-methyl-(1,2,4)-thiadiazol-5-yl, 2-trifluoromethyl-(1,2,4)-thiadiazolyl-5-yl, 2-chloro-(1,2,4)-thiadiazol-5-yl, 2-fluoro-(1,2,4)-thiadiazol-5-yl, 2-methoxy-(1,2,4)-thiadiazol-5-yl, 2-cyano-(1,2,4)-thiadiazol-5-yl, 2-methyl-(1,2,4)-oxadiazol-5-yl, 2-trifluoromethyl-(1,2,4)-oxadiazol-5-yl, 2-chloro-(1,2,4)-oxadiazol-5-yl, 2-fluoro-(1,2,4)-oxadiazol-5-yl, 2-methoxy-(1,2,4)-oxadiazol-5-yl and 2-cyano-(1,2,4)-oxadiazol-5-yl.

In the context of the present invention, the term “substituted” for any one of the alkylene; heteroalkylene; alkenylene; heteroalkenylene; cycloalkylene; heterocycloalkylene; cycloalkenylene; heterocycloalkenylen; arylene and heteroarylene disclosed herein refers to mono- or polysubstituted alkylene; heteroalkylene; alkenylene; heteroalkenylene; cycloalkylene; heterocycloalkylene; cycloalkenylene; heterocycloalkenylen; arylene and heteroarylene, respectively, they may preferably be substituted with 1, 2, 3, 4 or 5, more preferably with 1, 2 or 3 substituents. Examples of substituents are —NHR¹, with R¹ is —C(R_{U})(Rₙ)(R_{W})—, wherein R_{U}, Rᵥ and R_{W} independently of each other are selected from the group consisting of hydro-gen, linear or branched, substituted or unsubstituted C₁-C₃₀alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl. More preferably, R_{U}, R, and R_{W} independently of each other are selected from the group consisting of hydrogen, linear or branched, substituted or unsubstituted C₁-C₃₀ alkyl. More preferably, R_{U}, R, and R_{W} independently of each other are selected from the group consisting of hydrogen, methyl, ethyl, propyl, iso-propyl, butyl, pentyl, hexyl, octyl, dodecyl, sec-butyl, tert-butyl, sec-isopentyl, 2-pentyl, 2-methyl-4-pentyl, 3-pentyl, 2-methyl-pentyl, 2,6-dimethyl-4-heptyl, 3-pinanylmethyl, cyclopentyl, cyclohexyl, dicyclohexylmethyl, cyclohexylmethyl, cyclododecyl, phenyl, benzyl, and cyclohexyl(phenyl)methyl, preferably selected from the group consisting of hydrogen, methyl, and ethyl, more preferably selected from the group consisting of hydrogen, methyl and ethyl. Alternatively, preferably, in —NHR^{1′} R¹ is —C(R)(R)(R_{W}), wherein C and R_{U} form a substituted or unsubstituted C₆-C₃₀ arylene, and both R, and R_{W} are none. For example, —NHR¹ can be —NH—Ph.

In the context of the present invention, for —Z₁₂—, —N(R_{f})-means that the N atom is bonded with R_{f} of formula which is bonded to Ca, forming thus a heterocycle.

In the context of the present invention, a reversible NCO bond designates the bond between N (from secondary hindered amine) and C (of NCO) of a urea group which can be reversibly formed and broken.

In the context of the present invention, a “thermoset polymer” refers to a network polymer, comprising covalently bonded structures having at least three points of covalent bond attachment between polymer chains, wherein preferably the at least three points of covalent bond attachment between polymer chains forms part of a polymer network.

In the context of the present invention, a “thermoplastic polymer” refers to a linear polymer, comprising covalently bonded structures having two points of covalent bond attachment between polymer chains, wherein preferably the two points of covalent bond attachment between polymer chains forms part of a linear polymer system.

In the context of the present invention, an isocyanate is a general term for a molecule that comprises at least one isocyanate functional group. Therefore, the interpretation of the term “at least one isocyanate” encompases monoisocyanate(s), diisocyanate(s), triisocyanate(s), tetraisocyanate(s) and isocyanate(s) with higher numbers of isocyanate functional groups such as polymers having one or more isocyanate functional groups. An example of an isocyanate in the context of the present invention is polymethylene polyphenylisocyanate also commonly referred to as pMDI.

The present invention can be further explained and illustrated on the basis of the following examples. However, it will be understood that these examples are included merely for purposes of illustration and are not intended to limit the scope of the invention in any way.

### EXAMPLES

### Materials

PolyTHF (a commercial product from BASF): Polytetrahydrofurane (Polytetramethylene ether glycol) (functionality=2; average molecular weight Mn=2000 g/mol, OH=56 mg KOH/g).

MDI: 4,4′-Methy/enebis(pheny/isocyanate) purchased from BASF Polyurethanes GmbH BDO: 1,4-butanediol purchased from Alfa Aesar DIBIS: diethylene glycol bis chloroformate purchased from BASF Polyurethanes GmbH Benzoyl Chloride purchased from Sigma Aldrich TDI, Mixture of 80% 2,4- and 20% 2,6-toluene diisocyanate purchased from BASF pMDI (BASF product): polymeric diphenylmethane diisocyanate DIB-MDA: 4,4′-Methylenebis(N-sec-butylaniline) purchased from abcr DIB-polyetheramine T403 prepared from polyetheramine T403 purchased from BASF Polyol 1=trifunctional polyether polyol and contains predominantly secondary hydroxyl groups -functionality=3, Mn=3500 g/mol, OH=48 mg KOH/g, Viscosity (25° C.)=600 mPa·s.

Polyol 2=trifunctional polyether polyol based on glycerine -functionality=3, Mn=420 g/mol, OH=400 mg KOH/g, Viscosity (25° C.)=373 mPa·s Polymer type TP: Thermoplastics

Polymer type TS: Thermosets

### Analytical Methods

### The Content of NCO

The content of NCO was determined according to ISO DIN EN ISO 14896 (Modell 916 TI-Touch, Metrohm)

### Melting Points

Samples of polyurethane ureas were cut into cubes having dimension of 0.2×0.2×0.2 cm³, which were transferred to a hot press. The sample was pressed applying 20 kN of pressure for at least 5 minutes and the temperature was increased at a rate of XX. The melting point was determined when solid polymer visibly transitioned in phase.

### Thermogravimetrical Analysis (TGA)

TGA spectra were obtained according to ISO 11358 under N2 atmosphere in gold crucibles.

### DSC Measurements

DSC analysis was carried out on samples of about 5-10 mg using a TA Instruments brand DSC model Q20 according to ASTM D 3418

### Determination of Soluble Fraction

Samples of polyurethane ureas were cut into cubes having dimension of 0.5×0.5×0.5 cm³, of 500 grams

The sample was allowed to swell in THF at room temperature for 24 h. Subsequently, the excess of THF was removed. The swelled samples were weighted (m(swollen)). The samples were dried first at ambient conditions, then under vacuum at 65° C. to remove the THF that was taken up. In the end the mass of the dried sample was evaluated (m(dried)). The swelling ratio and insoluble fraction was determined via the following equations:

$$Swelling ratio = [ m ( swollen ) - m ( dried ) ] / m ( dried )$$

$$Insoluble fraction = m ( dried ) / m ( dry )$$

TABLE 1
Brief summary

| | | | | | Soluble | Swelling | NCO | |
|---|---|---|---|---|---|---|---|---|
| | Prepolymer | S | Chain | | fraction | Ratio | band | TGA −5% |
| | Polyol/ | (Standard)/ | Extender/ | Polymer | (THF, 24 h) | (THF, | gone | mass |
| Example | Isocyanate | CAN/CAS | Cross-linker | Type | [%] | 24 h) | (IR) | [° C.] |
| 1A | polyTHF | Comparative: | BDO | TP | 100 | — | yes | >300 |
| | (f = 2)/ | S | (f = 2) | | | | | |
| | mMDI | Inventive: | DIB- | | 100 | — | yes | 289 |
| | (f = 2) | CAS | MDA | | | | | |
| | | | (f = 2) | | | | | |
| 1B | polyTHF | Comparative: | BDO | TP | 100 | — | yes | 297 |
| | (f = 2)/ | S | (f = 2) | | | | | |
| | TDI (f = 2) | Inventive: | DIB- | | 100 | — | yes | 272 |
| | | CAS | MDA | | | | | |
| | | | (f = 2) | | | | | |
| 1C | polyTHF | Comparative: | BDO | TS | 1 | 2.25 | yes | >300 |
| | (f = 2)/ | S | (f = 2) | | | | | |
| | pMDI (f = | Inventive: | DIB- | | 0 | 2.56 | yes | 292 |
| | 2-3) | CAN | MDA | | | | | |
| | | | (f = 2) | | | | | |
| 1D | poly THF | Comparative: | BDO | TS | 1 | 2.03 | yes | >300 |
| | (f = 2)/ | S | (f = 2) | | | | | |
| | mMDI:pMDI | Inventive: | DIB- | | 2 | 2.41 | Yes | 290 |
| | (1:1) (f = | CAN | MDA | | | | | |
| | 2-3) | | (f = 2) | | | | | |
| 2 | Polyol 1 | Comparative: | BDO | TS | 2 | 3.40 | yes | 316 |
| | (f = 3)/ | S | (f = 2) | | | | | |
| | mMDI | Inventive: | DIB- | | 2 | 3.48 | yes | 287 |
| | (f = 2) | CAN | MDA | | | | | |
| | | | (f = 2) | | | | | |
| 3 | polyTHF | Comparative: | Polyol 2 | TS | 0 | 2.55 | Yes | >300 |
| | (f = 2)/ | S | (f = 3) | | | | | |
| | mMDI | Inventive: | DIB- | | | | | |
| | (f = 2) | CAN | polyetheramine | | | | | |
| | | | T403 | | | | | |
| | | | (f = 3) | | | | | |

Unless otherwise noted, the ratios given in the examples refer to molar ratios.

Reference Example 1A: Preparation of a prepolymer 100 g of 4,4′-methylenebis(phenyl isocyanate) (mMDI) (0.400 mol) were immersed in a flask, put under N₂. The mixture was heated. When the MDI was melted, 0.02 g benzoyl chloride (141 μmol) were added. 233 g polytetrahydrofuran (polyTHF) (functionality=2, Mₙ=2000 g/mol, hydroxyl value=55 mg KOH/g) were melted and added slowly at 80° C. to the mMDI-containing mixture. The reaction was terminated by cooling when the NCO value reached<8% (Ratio NCO:OH about 1:0.3). The prepolymer 1a was obtained as a colorless, slightly opaque liquid.

### Reference Example 1B: Preparation of a Prepolymer

17.4 g of toluene diisocyanate (TDI) (0.100 mol) were immersed in a flask, put under N₂. The mixture was heated to 80° C. and 0.008 g diglycol bis chloroformate (DIBIS) (35 μmol) were added. 62 g polyTHF (functionality=2, Mₙ=2000 g/mol, hydroxyl value=55 mgKOH/g) were melted and added slowly at 80° C. to the TDI mixture. The reaction was terminated by cooling when the NCO value reached<8% (Ratio NCO:OH˜1:0.3). The prepolymer 1b was obtained as a colorless, slightly opaque liquid.

### Reference Example 1C: Preparation of a Prepolymer

34.0 g of polymeric diphenylmethane diisocyanate (pMDI) (0.100 mol) and 8 mg DIBIS (35 μmol) were mixed. 75.0 g polyTHF (functionality=2, Mₙ=2000 g/mol, hydroxyl value=55 mgKOH/g) were melted and added slowly at 80° C. to the pMDI-containing mixture. The reaction was terminated by cooling when the NCO value reached<8% (Ratio NCO:OH about 1:0.25). The prepolymer 1c was obtained as a brownish, slightly opaque liquid.

### Reference Example 1D: Preparation of a Prepolymer

20.0 g of mMDI (0.060 mol) was added to 20.0 g of pMDI (0.080 mol) and 8 mg DIBIS (35 μmol). 77.5 g polyTHF (functionality=2, Mₙ=2000 g/mol, hydroxyl value=55 mgKOH/g) were melted and added slowly at 80° C. to the mMDI/pMDI-containing mixture. The reaction was terminated by cooling when the NCO value reached<8% (Ratio NCO:OH about 1:0.3). The prepolymer was obtained as a brownish, slightly opaque liquid.

### Reference Example 2: Preparation of a Prepolymer

75.0 g of MDI (0.300 mol) were immersed in a flask, put under N₂ It was heated to 80° C. and a mixture of 188 g Polyol 1 (trifunctional polyether polyol with propylene oxide (PO) end-capping, having secondary hydroxyl groups, functionality=3, Mₙ=3500 g/mol, hydroxyl value=48 mgKOH/g, viscosity (25° C.)=600 mPa*s) and 0.008 g DIBIS (35 μmol) were added slowly at 80° C. The reaction was terminated by cooling when the NCO value reached<8% (Ratio NCO:OH about 1:0.3). The prepolymer 2 was obtained as a colorless, slightly opaque liquid.

### Reference Example 3: Preparation of DIB-Polyetheramine T403

A 300 mL steel pressure autoclave was charged with 100 g (0.21 mol, 1 eq) polyetheramine T403 and 26.6 g butan-2-on (0.36 mol, 1.7 eq) in the presence of a palladium catalyst (Pd/Ag on alumina with predominantly theta content, with 0.3 wt.-% Pd, 0.1 wt.-% Ag based on alumina, the EM distribution is egg-shell, catalyst purchased from BASF -such catalyst are described in WO 2006/040159 A1) (17.75 g, 14.06 wt %). The autoclave was sealed, purged with nitrogen and heated to 140° C. under normal pressure. Subsequently, the autoclave was pressurized with H₂ (160 bar) at the same temperature for 20 h. The autoclave was cooled down and vented. The crude compound was filtered, and volatiles and water were removed under reduced pressure to give 98 g of a colorless, transparent liquid that was used without any further purification.

### Comparative Example 1A: Preparation of a Poly(Urea-Urethane) Polymer According To the Prior Art and Recyclability Testing Thereof

60.0 g of the prepolymer 1a obtained according to Ref. Ex. 1A (7.94% NCO) were heated to 70° C., degassed and set under N₂. 4.67 g 1,4-butanediol (BDO) (51.8 mmol) were added (Ratio NCO:OH 1.00:1.00 to 1.05:1.00) and the mixture was stirred in a speedmixer at 2000 rpm for 20 seconds. The mixture was casted into a silicon rubber mold lined with separating foil and cured for 40 min at 105° C. in a drying oven. The material was obtained as a white opaque solid plate. The characteristics of the obtained material are noted in Tables 1 & 2.

Recyc/abi/ity testing (melting). A sample of the obtained plate was cut into small cubes (0.2×0.2×0.2 cm³), which were transferred to a hot press. The sample was pressed applying 20 kN of pressure for at least 5 minutes. The sample started to melt around 110 to 120° C. and formed a cookie shaped plate after cooling down. Further testing are disclosed in Example 9 and 10 below.

### Example 1A: Preparation of a Covalent Adaptable System (CAS) Poly(Urea-Urethane) Polymer According to the Present Invention and Recyclability Testing Thereof

60.0 g of the prepolymer 1a obtained according to Ref. Ex. 1A (7.94% NCO) were heated to 70° C., degassed and set under N₂. 16.1 g 4,4′-methylene-bis[N-(1-methylpropyl)-phenylamine](DIB-MDA) (51.8 mmol) (Ratio NCO:NH 1.00:1.00 to 1.05:1.00) and were added and the mixture was stirred in a speedmixer at 2000 rpm for 20 seconds. The obtained mixture was casted into a silicon rubber mold lined with separating foil and cured for 40 min at 105° C. in a drying oven. The material was obtained as a yellow transparent solid plate. The characteristics of the obtained material are noted in Tables 1 & 2.

Recyclability testing (melting). A sample of the obtained plate was cut into small cubes (about 0.2×0.2×0.2 cm³), which were transferred to a hot press. The sample was pressed applying 20 kN of pressure for at least 5 minutes. The sample started to melt around 70° C. and formed a thin foil after cooling down. Further testing are disclosed in Example 9 and 10 below.

Conclusion: the product obtained according to the present invention starts melting at temperature of about 70° C., at much lower temperatures than Comp. Ex. 1A, and permits to form a thin foil -it is recyclable.

### Comparative Example 1B: Preparation of a Poly(Urea-Urethane) Polymer According To the Prior Art

30.0 g of the prepolymer 1b obtained according to Ref. Ex. 1B (7.47% NCO) were heated to 70° C., degassed and set under N₂. 2.29 g 1,4-butanediol (BDO) (25.4 mmol) were added (Ratio NCO:OH 1.00:1.00 to 1.05:1.00) and the mixture was stirred in a speedmixer at 2000 rpm for 20 seconds. The mixture was casted into a silicon rubber mold lined with a separating foil and cured for 16 h at 105° C. in a drying oven. The material was obtained as a colorless transparent viscoelastic plate that showed to flow already at room temperature.

The characteristics of the obtained material are noted in Tables 1 & 2.

### Example 1B: Preparation of a Covalent Adaptable System (CAS) Poly(Urea-Urethane) Polymer According to the Present Invention

30.0 g of the prepolymer 1b according to Ref. Ex. 1B (7.47% NCO) were heated to 70° C., degassed and set under N₂. 8.39 g DIB-MDA (25.4 mmol) (Ratio NCO:NH 1.00:1.00 to 1.05:1.00) were added and the mixture was stirred in a speedmixer at 2000 rpm for 20 seconds. The mixture was casted into a silicon rubber mold lined with separating foil and cured for 40 min at 105° C. in a drying oven. The material was obtained as a yellow transparent viscoelastic plate that showed to flow already at room temperature. The characteristics of the obtained material are noted in Tables 1 & 2.

### Comparative Example 1C: Preparation of a Poly(Urea-Urethane) Polymer According to The Prior Art and Recyclability Testing Thereof

30.0 g of the prepolymer 1c according to Ref. Ex. 1C (7.15% NCO) were mixed with 2.19 g BDO (24.2 mmol) (Ratio NCO:OH 1.05:1.00) and stirred in a speedmixer at 2000 rpm for 20 seconds. The mixture was casted into a silicon rubber mold lined with separating foil and cured for 90 min at 105° C. in a drying oven. The material was obtained as a brownish opaque solid plate. The characteristics of the obtained material are noted in Tables 1 & 2.

Recyclability testing (melting). A sample of the obtained plate was cut into small cubes (about 0.2×0.2×0.2 cm³), which were transferred to a hot press. The sample was pressed applying 20 kN of pressure for at least 5 minutes. The sample did not melt up to a temperature of 180° C.

### Example 1C: Preparation of a Covalent Adaptable Network (CAN) Poly(Urea-Urethane) Polymer According to the Present Invention and Recyclability Testing Thereof

30.0 g of the prepolymer 1c according to Ref. Ex. 1C (7.15% NCO) were mixed with 8.03 g DIB-MDA (24.2 mmol) (Ratio NCO:OH 1.05:1.00) and stirred in a speedmixer at 2000 rpm for 20 seconds. The mixture was casted into a silicon rubber mold lined with separating foil and cured for 90 min at 105° C. in a drying oven. The material was obtained as a brownish opaque solid plate. The characteristics of the obtained material are noted in Tables 1 & 2.

Recyc/abi/ity testing (melting). A sample of the obtained plate was cut into small cubes (about 0.2×0.2×0.2 cm³), which were transferred to a hot press. The sample was pressed applying 20 kN of pressure for at least 5 minutes. The sample started to melt around 160° C. and formed a thin foil after cooling down.

Conclusion: Contrary to Comp. Ex. 1C, the product obtained according to the present invention is able to melt and permits to form a thin foil -it is recyclable.

### Comparative Example 1D: Preparation of a Poly(Urea-Urethane) Polymer According To the Prior Art and Recyclability Testing Thereof

25.0 g of the prepolymer 1d obtained according to Ref. Ex. 1D (7.85% NCO) were mixed with 2.00 g BDO (22.2 mmol) (Ratio NCO:OH 1.05:1.00) and stirred in a speedmixer at 2000 rpm for 20 seconds. The mixture was casted into a silicon rubber mold lined with separating foil and cured for 90 min at 105° C. in a drying oven. The material was obtained as an off-white opaque solid plate. The characteristics of the obtained material are noted in Tables 1 & 2.

Recyclability testing (melting). A sample of the obtained plate was cut into small cubes (about 0.2×0.2×0.2 cm³), which were transferred to a hot press. The sample was pressed applying 20 kN of pressure for at least 5 minutes. The sample did not melt up to a temperature of 180° C.

### Example 1D: Preparation of a Covalent Adaptable Network (CAN) Poly(Urea-Urethane) Polymer According to the Present Invention and Recyclability Testing Thereof

25.0 g of the prepolymer 1d obtained according to Ref. Ex. 1D (7.85% NCO) were mixed with 7.35 g DIB-MDA (22.2 mmol) (Ratio NCO:OH 1.05:1.00) and stirred in a speedmixer at 2000 rpm for 20 seconds. The mixture was casted into a silicon rubber mold lined with separating foil and cured for 90 min at 105° C. in a drying oven. The material was obtained as a yellow slightly opaque solid plate. The characteristics of the obtained material are noted in Tables 1 & 2.

Recyclability testing (melting). A sample of the obtained plate was cut into small cubes (about 0.2×0.2×0.2 cm³), which were transferred to a hot press. The sample was pressed applying 20 kN of pressure for at least 5 minutes. The sample started to melt around 140° C. and formed a thin foil after cooling down.

Conclusion: Contrary to Comp. Ex. 1D, the product obtained according to the present invention is able to melt and permits to form a thin foil-it is recyclable.

### Comparative Example 2: Preparation of a Poly(Urea-Urethane) Polymer According to The Prior Art and Recyclability Testing Thereof

30.0 g of the prepolymer 2 obtained according to Ref. Ex. 2 (7.50% NCO) and 2.30 g BDO (25.3 mmol) were added (Ratio NCO:OH was 1.00:1.00 to 1.05:1.00) and the mixture was stirred in a speedmixer at 2000 rpm for 20 seconds. The mixture was casted into a silicon rubber mold lined with separating foil and cured for 90 min at 105° C. in a drying oven. The material was obtained as a white opaque solid plate. The characteristics of the obtained material are noted in Tables 1 & 2.

Recyclability testing (melting). A sample of the obtained plate was cut into small cubes (about 0.2×0.2×0.2 cm³), which were transferred to a hot press. The sample was pressed applying 20 kN of pressure for at least 5 minutes. The sample did not melt up to a temperature of 180° C.

Recyclability testing (extruding). For testing the extruding properties, a sample of the obtained plate was cut into small cubes (about 0.2×0.2×0.2 cm³), which were transferred to an extruder. The sample was extruded at 200° C., it did not melt, the material blocked the extruder. When the extrusion chamber was opened the material was reobtained as crumbly solid.

### Example 2: Preparation of a Covalent Adaptable Network (CAN) Poly(Urea-Urethane) Polymer According to the Present Invention and Recyclability Testing Thereof

30.0 g of the prepolymer 2 obtained according to Ref. Ex. 2 (7.50% NCO) and 8.43 g DIB-MDA (25.5 mmol) were added (Ratio NCO:NH 1.00:1.00 to 1.05:1.00), and the mixture was stirred in a speedmixer at 2000 rpm for 20 seconds. The mixture was casted into a silicon rubber mold lined with separating foil and cured for 90 min at 105° C. in a drying oven.

The material was obtained as a yellow opaque solid plate. The characteristics of the obtained material are noted in Tables 1 & 2.

Recyclability testing (melting). A sample of the obtained plate was cut into small cubes (about 0.2×0.2×0.2 cm³), which were transferred to a hot press. The sample was pressed applying 20 kN of pressure for at least 5 minutes. The sample started to melt around 100° C. and formed a thin foil after cooling down.

Conclusion: Contrary to Comp. Ex. 2, the product obtained according to the present invention is able to melt and permits to form a thin foil -it is recyclable.

Recyclability testing (extruding). For testing the extruding properties, a sample of the obtained plate was cut into small cubes (about 0.2×0.2×0.2 cm³), which were transferred to an extruder. The sample was extruded at 180° C. At this temperature the sample was able to be extruded as a homogeneous, flowable paste with a maximum torque of 2.2 kN.

Conclusion: Contrary to Comp. Ex. 2, the product obtained according to the present invention is able to be extruded and permits to form an homogeneous paste -it is recyclable.

### Comparative Example 3: Preparation of a Poly(Urea-Urethane) Polymer According to The Prior Art

60.0 g of the prepolymer 1a obtained according to Ref. Ex. 1A (7.43% NCO) and 14.15 g Polyol 2 (functionality=3, Mₙ=400 g/mol, hydroxyl value=400 mgKOH/g) were added (Ratio NCO:OH was 1.05:1.00) and the mixture was stirred in a speedmixer at 2000 rpm for 20 seconds. The mixture was casted into a silicon rubber mold lined with separating foil and cured for 90 min at 105° C. in a drying oven. The material was obtained as a yellowish transparent solid plate. The characteristics of the obtained material are noted in Tables 1 & 2.

Recyclability testing (melting). A sample of the obtained plate was cut into small cubes (about 0.2×0.2×0.2 cm³), which were transferred to a hot press. The sample was pressed applying 20 kN of pressure for at least 5 minutes. The sample did not melt up to a temperature of 180° C.

### Example 3: Preparation of a Covalent Adaptable Network (CAN) Poly(Urea-Urethane) Polymer According to the Present Invention

60.0 g of the prepolymer 1a obtained according to Ref. Ex. 1A (7.50% NCO) and 21.1 g of DIB-polyetheramine T403 (sec-butyl-modified polyetheramine T403, functionality=3, Mₙ=600 g/mol, amine value=270 mgKOH/g) prepared as described in Ref. Ex. 3 were added (Ratio NCO:NH was 1.05:1.00), and the mixture was stirred in a speedmixer at 2000 rpm for 20 seconds. The mixture was casted into a silicon rubber mold lined with separating foil and cured for 90 min at 105° C. in a drying oven. The material was obtained as a yellow opaque solid. The characteristics of the obtained material are noted in Tables 1 & 2.

Recyclability testing (melting,). A sample of the obtained plate was cut into small cubes (about 0.2×0.2×0.2 cm³), which were transferred to a hot press. The sample was pressed applying 20 kN of pressure for at least 5 minutes. The sample started to melt around 10° C. and formed a thin foil after cooling down.

Conclusion: Contrary to Comp. Ex. 3, the product obtained according to the present invention is able to melt and permits to form a thin foil -it is recyclable.

TABLE 2
Properties/Recyclability of prepared materials

| | | | | | | | Melting @ |
|---|---|---|---|---|---|---|---|
| | | | | | | DSC | 20 kN, |
| | | | | | | exothermic | 5 min |
| | Prepolymer | S | Chain | | TGA −5% | peak | (Yes at |
| | Polyol/ | (Standard)/ | Extender / | Polymer | mass | [° C./ | T ° C./ |
| Example | Isocyanate | CAN/CAS | Cross-linker | Type | [° C.] | J/g] | No) |
| 1A | polyTHF | Comparative: | BDO | TP | >300 | 195/2.22 | Yes, |
| | (f = 2)/ | S | (f = 2) | | | | 110° C. |
| | mMDI | Inventive: | DIB- | | 289 | 186/14.75 | Yes, |
| | (f = 2) | CAS | MDA | | | | 70° C. |
| | | | (f = 2) | | | | |
| 1B | poly THF | Comparative: | BDO | TP | 297 | 209/2.83 | already |
| | (f = 2)/ | S | (f = 2) | | | | liquid |
| | TDI (f = 2) | Inventive: | DIB- | | 272 | 160/15.87 | already |
| | | CAS | MDA | | | | liquid |
| | | | (f = 2) | | | | |
| 1C | polyTHF | S | BDO | TS | >300 | — | No |
| | (f = 2)/ | | (f = 2) | | | | |
| | PMDI (f = | Inventive: | DIB- | | 292 | 215/3.27 | Yes, |
| | 2-3) | CAN | MDA | | | | 160° C. |
| | | | (f = 2) | | | | |
| 1D | poly THF | Comparative: | BDO | TS | >300 | 178/3.48 | No |
| | (f = 2)/ | | (f = 2) | | | | |
| | mMDI : | S | | | | | |
| | pMDI | Inventive: | DIB- | | 290 | 222/3.00 | Yes, |
| | (1:1) (f = | CAN | MDA | | | | 140° C. |
| | 2-3) | | (f = 2) | | | | |
| 2 | Polyol 1 | Comparative: | BDO | TS | 316 | 180/4.51 | No |
| | (f = 3)/ | S | (f = 2) | | | | |
| | mMDI | Inventive: | DIB- | | 287 | 197/6.34 | Yes, |
| | (f = 2) | CAN | MDA | | | | 100° C. |
| | | | (f = 2) | | | | |
| 3 | poly THF2000 | Comparative: | Polyol 2 | TS | >300 | — | No |
| | (f = 2)/ | S | (f = 3) | | | | |
| | mMDI | Inventive: | DIB- | | 293 | — | Yes, |
| | (f = 2) | CAN | polyetheramine | | | | 100° C. |
| | | | T403 | | | | |
| | | | (f = 3) | | | | |

### Example 4: Preparation of a Composite According to the Present Invention Comprising Glass Fibers

30.0 g of the prepolymer 2 obtained according to Ref. Ex. 2 (6.87% NCO) were heated to 70° C., degassed and set under N₂. 7.26 g DIB-MDA (51.8 mmol) (Ratio NCO:NH 1.05 1.00) were added. The mixture was stirred in a speedmixer at 2000 rpm for 20 seconds. Subsequently, 300 mg of single glass fibers as filling material were stirred in. The mixture was casted into a silicon rubber mold lined with separating foil and cured for 40 min at 105° C. in a drying oven. The material was obtained as a yellow opaque plate.

### Example 5: Mechanical Recycling

The material obtained from Example 4 was cut and pressed applying 20 kN of pressure for at least 5 minutes at 140° C. As a result, a thin foil was obtained showing that the composite was mechanically recyclable.

### Example 6: Mechanical Recycling Test of a Composite According to the PreSent Invention

A sample of the obtained yellow opaque solid plate according to Example 2 was cut to small cubes (about 0.2×0.2×0.2 cm³), which were transferred to a hot press. The sample was pressed applying 20 kN of pressure for at least 5 minutes at 140° C. to obtain thin foils.

Single glass fibers were put between two foils and the construct was pressed applying 20 kN of pressure for at least 5 minutes at 140° C. to obtain a composite in form of a thin foil.

Recyc/ingtesting: The obtained composite in the form of a thin foil was cut into pieces and the pieces pressed applying 20 kN of pressure for at least 5 minutes at 140° C. As a result, a thin foil was obtained showing that the composite was mechanically recyclable.

### Example 7: Chemical Recycling of a Composite According to the Present invention

22.0 g of the composite according to Example 4 was immersed in 150 mL of dry toluene and heated to reflux under stirring. The material started to swell, before the resin was completely dissolved after 4 h. When the solution was cooled down, the mixture underwent a sol-gel transition that was reversible when heated again. Then, the dissolved gel was filtered hot, and the glass fibers were filtered off.

The filtrate was collected in a flask. The filtrate gelled and was dried under reduced pressure at elevated temperatures first at the rotation evaporator at 120° C. and 50 mbar, then in a vacuum oven at 80° C.

The resulting solid was pressed with 20 kN of pressure for at least 5 minutes at 140° C. to obtain thin foils. Single glass fibers were put between two foils and the construct was pressed applying 20 kN of pressure for at least 5 minutes at 140° C. to obtain a new composite from recycled polymer. The chemical recycling according to Example 7 is illustrated in FIG. 3.

### Example 8: Chemical Recycling in the Presence of an Amine

About 5 g of the bulk material (poly(urea urethane) polymer) obtained according to Example 2 were immersed in 50 mL of toluene. 2.6 g DIB-MDA (1 eq. in relation to reversible NCO bonds) were added to scavenge the open NCO-bonds that were formed by the thermal breaking of the urea bonds. After 16 h stirring under reflux the material was completely dissolved. The toluene was removed under reduced pressure for obtaining a mixture comprising an amine terminated pre-polymer as a viscous liquid that did not solidify. Said mixture was diluted with 1 mL of toluene and the amine terminated pre-polymer was precipitated by addition to 50 g of n-heptane in order to remove the excess of DIB-MDA. The amine terminated pre-polymer was separated from the solvent and therein dissolved DIB-MDA by decantation. The amine terminated pre-polymer was then dried yielding 4.51 g of amine (DIB-MDA) terminated pre-polymer with an amine number of 75.2 mg KOH/g.

Formation of a newpoly(urea urethane) polymer (bulk material): This amine (DIB-MDA) terminated pre-polymer was reacted with the pre-polymer of Example 2 to obtain a recycled covalent adaptable network (CAN) poly(urea-urethane) polymer, which is the same material as the bulk material (poly(urea urethane) polymer) obtained according to Example 2.

### Example 9: Testing of the Polymers Obtained in Example 1A and Comparative Example 1a -Recycling Properties

The plates obtained according to Example 1A and Comparative Example 1A were cut to small cubes (about 0.2×0.2×0.2 cm³).
19.1 About 5 g of a sample of the material according to Example 1A were mixed with 50 mL toluene and heated under reflux for 16 h. The mixture was then cooled down. The CAS material according to Example 1A was dissolved completely in toluene, such that a homogeneous yellowish liquid mixture was obtained. After removal of the solvent, a transparent yellowish solid was obtained.
19.2 About 5 g of a sample of the material according to Comparative Example 1A were mixed with 50 mL toluene and heated under reflux for 16 h. The mixture was then cooled down. The material did not dissolve.

This example is illustrated in FIG. 1. It has thus been demonstrated by this example that contrary to a material of the prior art, the CAS material in accordance to the present invention is reversibly soluble in toluene allowing chemical recycling thereof.

### Example 10: Testing of the Polymers Obtained in Example 1A and Comparative Example 1A -Melting Behavior

The materials obtained in Example 1A and Comparative Example 1A were cut into small cubes (about 0.2×0.2×0.2 cm³), transferred to a hot press, and then subjected to compression molding in the hot press at 20 kN for 5 minutes at different temperatures, namely 80, 100 and 120° C. The obtained products are illustrated in FIG. 2.

With the material of Example 1A a foil was obtained already at 80° C. while at 80° C. and even 100° C. the material of the comparative example remained as white pieces. At 120° C., a fine white opaque plate was formed for the comparative example while a fine transparent foil was obtained for the inventive example. Thus, it is shown that the material according to the present invention melts at much lower temperatures compared to a common material.

### Example 11: Preparation of a Covalent Adaptable Network (CAN) Poly(Urea-Urethane) Polymer According to the Present Invention from an Aliphatic Diamine

60.0 g of Reference Example 2 (7.50% NCO) and 9.44 g DIB-butanediamine (N,N′-di-sec-butyl-1,4-butanediamine) (47.1 mmol) were added (ratio NCO:NH 1.05:1.00), and the mix was stirred in a speedmixer at 2000 rpm for 20 seconds. The mix turned solid immediately and was cured at 105° C. for 1 h and at room temperature for 48 h to yield an off-white opaque material.

Recyclability testing (melting). A sample of the obtained plate was cut into small cubes (0.2×0.2×0.2 cm³), which were transferred to a hot press. The sample was pressed applying 20 kN of pressure for at least 5 minutes. The sample started to melt around 100° C. and formed a circular shaped plate after cooling down.

Recyclability testing (solution, toluene). 2 g of the plate obtained from the melting test was cut into small cubes (0.2×0.2×0.2 cm³) and immersed into 20 mL of toluene. The mixture was heated to 110° C. for 24 h. The sample did not dissolve.

Recyclability testing (solution, DMI). 2 g of the obtained plate was cut into small cubes (0.2×0.2×0.2 cm3) and immersed into 20 mL of 1,3-dimethyl-2-imidazolidinone. The mixture was heated to 130° C. for 24 h. The sample dissolved completely to give a clear solution.

Higher temperatures are needed to recycle polymers comprising aliphatic amines according to the invention by means of dissolving in an organic solvent.

### Reference Example 4: Preparation of a Prepolymer

20 g of 4,4′-methylene-bis-(phenylisocyanate) (MDI) (0.080 mol) and 20 g polymeric MDI (pMDI, average functionality of about 2.5) (0.06 mol) were immersed in a flask, put under N₂ The mixture was heated, when the MDI was melted, 0.02 g benzoylchloride (141 μmol) was added. 82.6 g Polytetrahydrofuran (polyTHF) (f=2, MA=2000 g/mol, #OH=55 mgKOH/g) were melted and added slowly at 80° C. to the MDI/pMDI mixture. The reaction 15 was terminated by cooling when the NCO value reached<8% (ratio NCO:OH is about 1:0.3). The prepolymer was obtained as a yellow clear liquid.

### Example 12: Preparation of a Covalent Adaptable Network (CAN) Poly(Urea-Urethane) Polymer According to the Present Invention from N-(2-Hy-droxyethyl)aniline

15.0 g of the prepolymer according to Reference Example 4 (7.3% NCO) and 1.70 g N-(2-Hydroxyethyl)aniline (12.4 mmol) were added (ratio NCO:XH 1.05:1.00, X=total sum of 0 and N), and the mixture was stirred in a speedmixer at 2000 rpm for 20 seconds. The mixture was casted into a silicon rubber mold lined with separating foil and cured for 90 min at 105° C. in a drying oven. The material was obtained as a yellow opaque solid plate.

Recyclability testing (melting). A sample of the obtained plate was cut into small cubes (0.2×0.2×0.2 cm³), which were transferred to a hot press. The sample was pressed applying 20 kN of pressure for at least 5 minutes. The sample started to melt around 180° C. and formed a cookie shaped plate after cooling down.

Recyclability testing (solution, toluene): 3 g of the obtained plate was cut into small cubes (0.2×0.2×0.2 cm³) and immersed into 13 mL of toluene. 1 g of N-butylamine was added to scavenge the open NCO bonds. The mixture was heated to 110° C. The sample dissolved completely, but gave a turbid solution.

Recyclability testing (solution, DMI). 3 g of the obtained plate was cut into small cubes (0.2×0.2×0.2 cm³) and immersed into 30 mL of 1,3-Dimethyl-2-imidazolidinon. 1 g of N-butylamine was added to scavenge the open NCO bonds. The mixture was heated to 120° C. The sample dissolved completely after 1 h to give a clear solution.

### Example 13: Preparation of a Covalent Adaptable Network (CAN) Poly(Urea-Urethane) Polymer According to the Present Invention from 2-(Ethyla-mino)ethanol

15.0 g of the prepolymer according to Reference Example 4 (7.3% NCO) and 1.10 g 2-(ethylamino)ethanol (12.8 mmol) were added (ratio NCO:XH 1.05:1.00, X=total sum of 0 and N), and the mixture was stirred in a speedmixer at 2000 rpm for 20 seconds. The mixture was casted into a silicon rubber mold lined with separating foil and cured for 90 min at 105° C. in a drying oven. The material was obtained as a yellow opaque solid plate.

Recyclability testing (melting). A sample of the obtained plate was cut into small cubes (0.2×0.2×0.2 cm³), which were transferred to a hot press. The sample was pressed applying 20 kN of pressure for at least 5 minutes. The sample started to melt around 150° C. and formed a cookie shaped plate after cooling down.

Recyclability testing (solution, toluene): 3 g of the obtained plate was cut into small cubes (0.2×0.2×0.2 cm³) and immersed into 13 mL of toluene. 1 g of N-butylamine was added to scavenge the open NCO bonds. The mixture was heated to 110° C. The sample did not dissolve, but swelled.

Recyclability testing (solution, DMI). 3 g of the obtained plate was cut into small cubes (0.2×0.2×0.2 cm³) and immersed into 30 mL of 1,3-dimethyl-2-imidazolidinon. 1 g of N-butylamine was added to scavenge the open NCO bonds. The mixture was heated to 120° C. The sample dissolved completely after 4 h to give a clear solution.

### Comparative Example 14: Preparation of a Covalent Adaptable Network (CAN) Poly(Urea-Urethane) Polymer from 1,4-Butanediol

15.0 g of the prepolymer according to Reference Example 4 (7.3% NCO) and 1.12 g 1,4-butanediol (12.4 mmol) were added (ratio NCO:XH 1.05:1.00, X═O), and the mixture was stirred in a speedmixer at 2000 rpm for 20 seconds. The mixture was casted into a silicon rubber mold lined with separating foil and cured for 90 min at 105° C. in a drying oven. The material was obtained as a yellow opaque solid plate.

Recyclability testing (melting). A sample of the obtained plate was cut into small cubes (about 0.2×0.2×0.2 cm³), which were transferred to a hot press. The sample was pressed applying 20 kN of pressure for at least 5 minutes. The sample did not melt up to a temperature of 180° C.

Recyclability testing (solution, toluene): 3 g of the obtained plate was cut into small cubes (0.2×0.2×0.2 cm³) and immersed into 13 mL of toluene. 1 g of N-butylamine was added to scavenge the open NCO bonds. The mixture was heated to 110° C. The sample did not dissolve.

Recyclability testing (solution, DMI). 1 g of the obtained plate was cut into small cubes (0.2×0.2×0.2 cm³) and immersed into 10 mL of 1,3-dimethyl-2-imidazolidinone. 0.33 g of N-butylamine was added to scavenge the open NCO bonds. The mixture was heated to 120° C.

The sample did not dissolve after 7 h, the sample swelled in the solvent.

### Comparative Example 15: Preparation According to WO2022189242

16.5 g pMDI was dissolved in THF and cooled down to 0° C. A DIB-MDA (20.23 g) in THF was dropped into the pMDI/THF solution under stirring. The reaction mixture was stirred for 1 h at 0° C. and then slowly heated to reflux for 6 h. The solvent was removed, and the sample was cured at 140° C. for 24 h. The product 15a was obtained as a yellow solid.

Recyclability testing (solution, toluene). 3 g of the solid 15a was cut into small cubes (0.2×0.2×0.2 cm³) and immersed into 30 mL of toluene. The mixture was heated to 110° C. for 4 h. The sample did not dissolve. 3 g of the plate 15a were immersed into 30 mL of toluene and 0.9 g of 1,4-butandiol was added (2.00 eq of OH butanediol/eq HUBs in plate). The mixture was stirred under reflux for 24 h. After this time the substance was swollen, but not dissolved. 3 g of 15a were cut to pieces and immersed into a small amount of toluene (5 mL), 0.4 g of diisopropylamine were added. The mixture was heated for 8 h under reflux. The cubes dissolved and a yellow liquid was obtained. 3 g of the plate 15a were immersed into 30 mL of toluene and 0.4 g of DIB-MDA was added (0.25 eq of secondary hindered amine DIB-MDA/eq HUBs in plate). The mixture was stirred under reflux overnight. When cooled down the mixture did not gel. When the solvent was removed a sticky liquid was obtained that was still soluble in THF.

### Recycling Example 1: Recycling Via Scavenger Molecules/Prepolymers

### Preparation of Prepolymer 2

75.0 g of MDI (0.300 mol) were immersed in a flask, put under N2. The mixture was heated to 80° C. and a mixture of 188 g Lupranol 2074 (triol polyol with a propylene oxide (PO) end-cap, creating secondary hydroxyl groups, f=3, Mn=3500 g/mol, #OH=48 mgKOH/g, Viscosity (25° C.)=600 mPa*s) and 0.008 g diglycol-bis-chlorformiat (DIBIS) (35 μmol) were added slowly at 80° C. to the MDI mixture. The reaction was terminated by cooling when the NCO value reached<8% (Ratio NCO:OH˜1:0.3). The prepolymer was obtained as a colorless, slightly opaque liquid.

### Preparation of CAN 2

30.0 g of prepolymer 2 (7.50% NCO) and 8.43 g DIB-MDA (25.5 mmol) were added (Ratio NCO:NH 1.00:1.00-1.05:1.00), and the mix was stirred in a speedmixer at 2000 rpm for 20 seconds. The mix was casted into a silicon rubber mold lined with separating foil and cured for 90 min at 105° C. in a drying oven. The material was obtained as a yellow opaque solid plate.

### Recycling Example 2: No Scavenger Molecule

22 g of the plate CAN 2 was immersed in 100 mL toluene. The mixture was heated to reflux for 24 h, the plate was completely dissolved in toluene. The solution was kept without stirring at room temperature, the mixture gelled when cooled down. When the solvent was removed from the gel a solid was obtained.

### Recycling Example 3: With DIB-MDA

5 g of the plate CAN 2 were immersed into 50 mL of toluene and 1.0 g/0.5g/0.3g of DIB-MDA was added (0.8/0.4/0.25 eq of SHA DIB-MDA/eq SHU in plate). The mixture was stirred under reflux overnight. When cooled down the mixture did not gel. When the solvent was removed a sticky liquid was obtained that was still soluble in THF.

### Recycling Example 4: Closed Loop Recycling of CAN 2 with DIB-MDA

26 g of the plate CAN 2 were immersed in 250 mL toluene with 13.3 g of DIB/MDA (2 eq of SHA DIB-MDA/eq SHU in plate). The plate dissolved over night under stirring over reflux.

The toluene was then removed and the liquid prepolymer diluted with 10 g of THF. To remove unreacted DIB-MDA, the prepolymer was precipitated into 250 mL n-heptane.

The prepolymer was dried and the amine number was determined (53.2 mg KOH/g). 10 g of the prepolymer obtained from CAN2 was mixed with the respective amount of fresh Prepolymer 2 (5.7 g, NCO=7.0%) at 1400 Upm for 20 sec and cured at 105° C. for 1 h.

The recycled polymer was analyzed via IR and matched the original polymer.

The recycled polymer showed again recyclability via mechanical recycling (compression molding at 140° C., 20 kN, 5 min) and chemical recycling by complete dissolution in hot toluene.

### Recycling Example 5: With Diol

5 g of the plate CAN 2 were immersed into 50 mL of toluene and 0.6 g/0.3g/0.15g/0.076g/0.048g of 1,4 Butandiol was added (2.00/1.00/0.50/0.25/0.125 eq of OH butandiol/eq SHU in plate). The mixture was stirred under reflux overnight. When cooled down the mixture did not gel. When the solvent was removed a sticky liquid was obtained that was still soluble in THF.

### Recycling Example 6: With Isocyanate

5 g of the plate CAN 2 were immersed into 50 mL of toluene and 1.61g of MDI was added (2.00 eq of NCO MDI/eq SHU in plate). The mixture was stirred under reflux overnight. When cooled down the mixture did not gel. When the solvent was removed a sticky liquid 10 was obtained that was still soluble in THF.

### Recycling Example 7: Recycling Via Volatile Monoamines

Proof-of-concept:
Without diisopropylamine:

3 g of CAN 2 were cut to pieces and immersed into a small amount of toluene (5 mL), the mixture was heated for 8 h under reflux. Due to the small amount of solvent no diffusion took place, the pieces did not dissolve. Instead, they swelled in the solvent.

With diisopropylamine:

3 g of CAN 2 were cut to pieces and immersed into a small amount of toluene (5 mL), 0.4 g of diisopropylamine were added. The mixture was heated for 8 h under reflux. The cubes dissolved and a yellow liquid was obtained.

When the solvent was removed the prepolymer remained liquid.

### Prepolymer 1a

100 g of 4,4′-Methylen-bis-(phenylisocyanate) (MDI) (0.400 mol) were immersed in a flask, put under N₂ The mixture was heated, when the MDI was melted, 0.02 g benzoylchloride (141 μmol) was added. 233 g Polytetrahydrofuran (polyTHF) (f=2, Mₙ=2000 g/mol, #OH=55 mgKOH/g) were melted and added slowly at 80° C. to the MDI mixture. The reaction was terminated by cooling when the NCO value reached<8% (Ratio NCO:OH 1:0.3). The prepolymer was obtained as a colorless, slightly opaque liquid.

Amine-capped Polymer 1a-DiPA:

5,1 g of Prepolymer 1a were mixed with 0.90 g of diisopropylamine (DiPA) and cured for 40 min at 105° C. To yield a yellow waxlike thermoplastic. The thermoplastic was analyzed via NMR spectrometry and NCO titration. The reversible reaction was shown by heating the polymer under vacuum (20 mbar) at different temperatures and analyzing the NMR spec-trum and NCO value.

| | | | | Amine signal | |
|---|---|---|---|---|---|
| | | | Urea signal | NMR (e.g. | |
| | NCO | Mass | in NMR | Duplet | Remaining |
| Sample | Value | loss | (6.15 ppm) | 1.31 ppm) | Amine* |
| Prepolymer | 6.8 | Reference | No | No | |
| 1a | | | | | |
| Prepolymer | 39 | 0 | No | No | |
| 1a 150° C. | | | | | |
| 5 h | | | | | |
| 1a-DiPA | 0 | Reference | Yes | Yes | 100 |
| 1a-DiPA | 0 | 0.9 | yes | Yes | 96 |
| 120° C. 1 h | | | | | |
| 1a-DiPA | 0.61 | 3.0 | Yes | Yes | 80 |
| 150° C. 1 h | | | (decreasing) | (decreasing) | |
| 1a-DIPA | 2.06 | 7.15 | Yes | Yes | 49 |
| 160° C. 1 h | | | (decreasing) | (decreasing) | |
| 1a-DIPA | 3.05 | 10.5 | Yes | Yes | 10 |
| 170° C. 1 h | | | (decreasing) | (decreasing) | |
| 1a-DiPA | 3.2 | 9.0 | yes | No | 0 |
| 180° C. 1 h | | | | | |

*NMR Ratio Amine peak at 1.31 referenced to polyol peak 1.80-1.50, normalized to pristine 1a-DiPA

| | 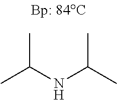 | 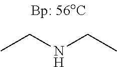 | 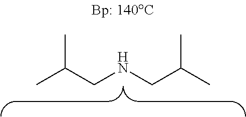 | | |
|---|---|---|---|---|---|
| | 1 h in 180° C | 1 h in 180° C | 1 h in 180° C | 3 h in 180° C | 4 h in 150° C |
| Mass loss [%] | 9 | 1.3 | 1.6 | 2.2 | Prepolymer 4h |
| | | | | | at 150° C |
| NCO value | 3.2 | 0.5 | 0.4 | 0.36 | 3.9 |
| [%] | | | | | |
| Remaining | 0 | ~92 | ~97 | ~93 | — |
| Amine [%] | | | | | |

### Recycling Example 8: Closed Loop Recycling of CAN 2 with Diisopropylamine

7.8 g of CAN 2 were immersed into 15.6 g diisopropylamine. The mixture was heated to 80° C. for 24 h. The network became liquid and formed a separate phase below the excess amine. A part of the polymer phase (1.6 g) was dried at 80° C. at 20 mbar to remove excess amine. The intermediate prepolymer was obtained as a viscous liquid (0.62 g). The polymer did not have a network structure for it was soluble in a small amount of THF (1 g), a depolymerization to a thermoplastic system took place.

The intermediate prepolymer was used to create a recycled CAN 2. The reacted amine was removed by heating the prepolymer to 170° C. at 20 mbar for 1 h. The polymer was reobtained as 540 mg of a solid material. The network structure could be confirmed by adding THF (1 g). The sample did not dissolve, it swelled.

### BRIEF DESCRIPTION OF THE FIGURES

FIG. 1 shows the different steps relative to the testing of the recycling properties of the plates obtained in Comp. Example 1A and Example 1A. 1. Shredding/cutting; 2. Addition of toluene; 3. Heating for 16h, followed by cooling down; 4. Removal of toluene.

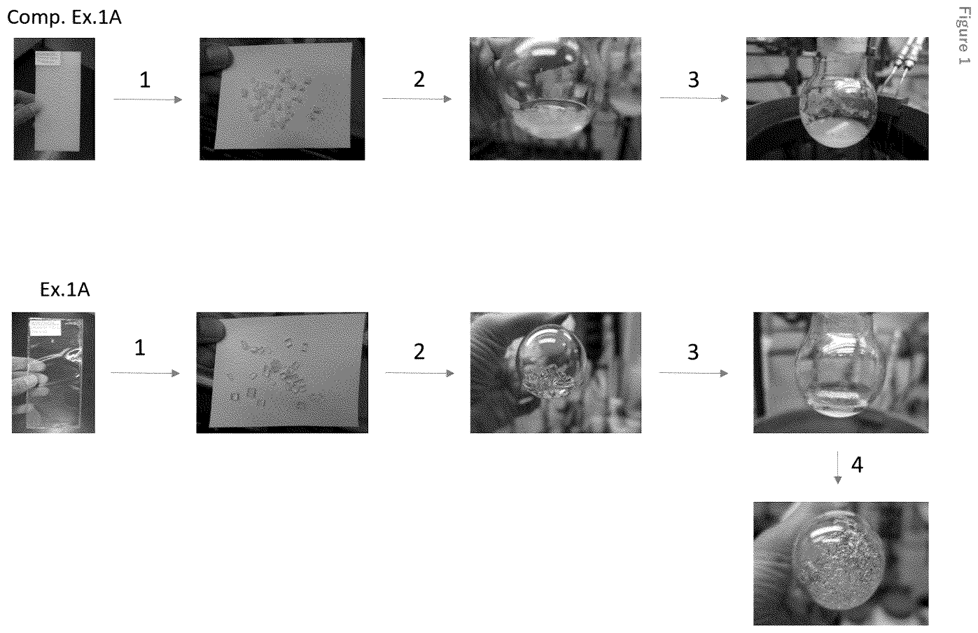

FIG. 2 shows the results of the test after compression molding at different temperatures for Example 1A and Comparative Example 1A. The arrows shows that only small pieces are obtained at 80 and 100° C. for the Comparative Example suggesting no melting at these temperatures while a foil is obtained already at 80° C. with the material of Example 1A.

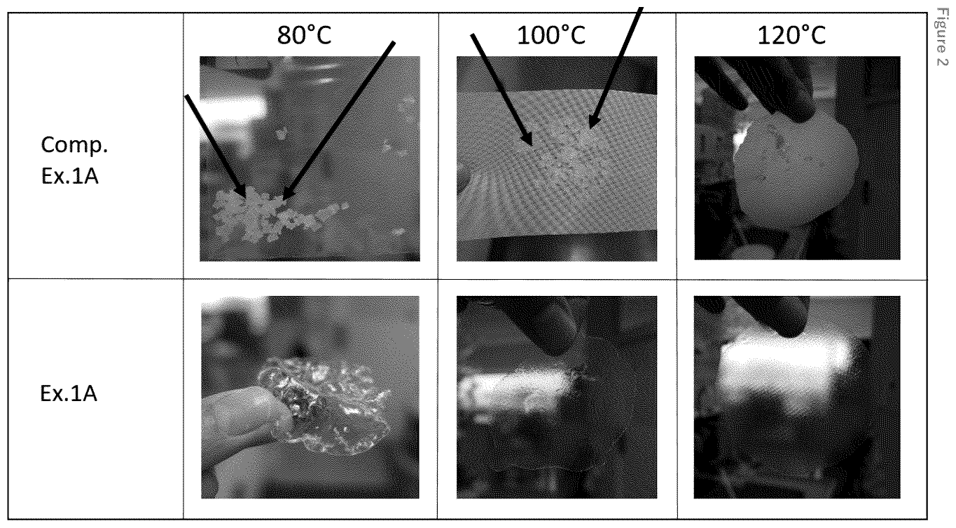

FIG. 3 shows the different steps relative to the testing of the recycling properties of the plates obtained in Comp. Example 2 and Example 2.1. Shredding/cutting; 2. Addition of toluene; Heating for 16h, followed by cooling down;

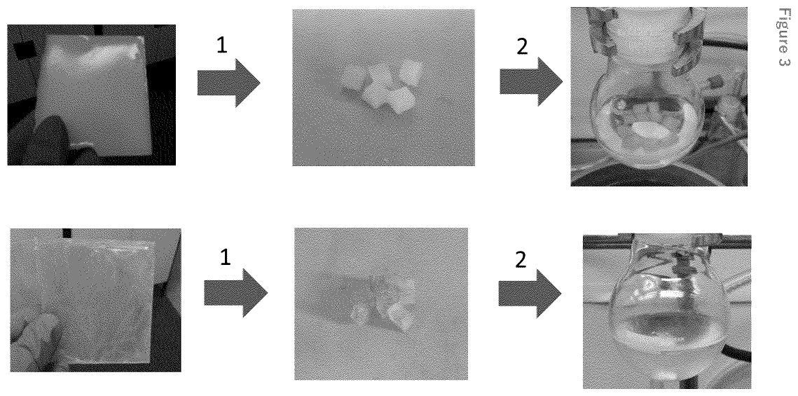

FIG. 4 shows the results of the test after compression molding at different temperatures for Example 2 and Comparative Example 2. Comparative Example 2 does not melt at all up to temperatures of 180° C., whereas Example 2 melts at around 130° C.

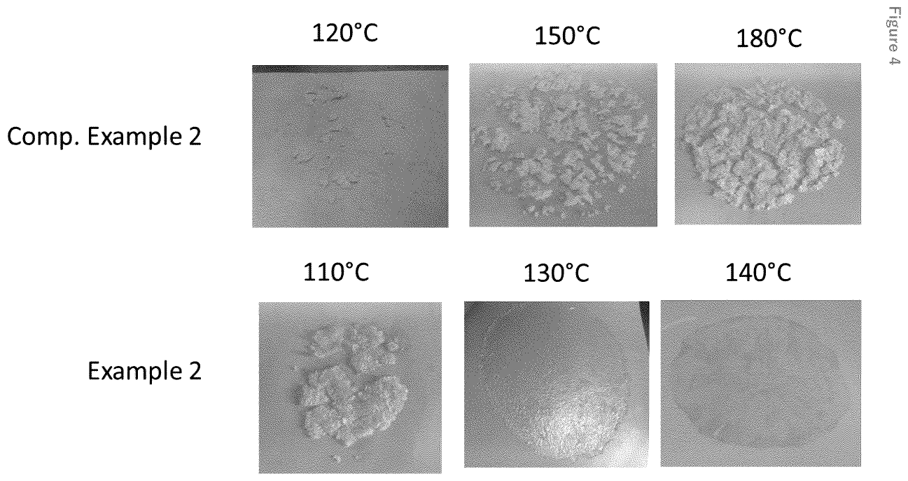

FIG. 5 shows the different steps relative to the testing of the recycling properties of the composite of Example 4.1. Addition of toluene to pieces of the composite of Example 4, heating under reflux for 16 h 2. Hot filtration; a: separated glass fibers, b: the filtrate gelled and was dried; 3.: b was pressed at 20 kN for 5 min at 140° C. to obtain a thin foil, 4. Recycled composite with glass fibers obtained by pressing glass fibers in between two foils.

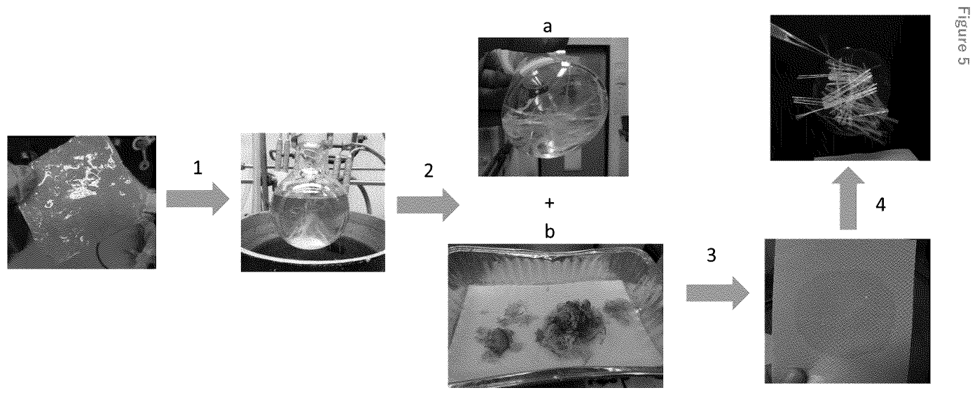

### CITED LITERATURE

Kunststoffhandbuch [Plastics handbook], volume 7, Polyurethane [Polyurethanes]”, Carl Hanser Verlag, 3rd edition 1993, chapter 3.1, 3.2 and 3.3.2 Ullmann's Encyclopedia of Industrial Chemistry], 4th edition, volume 19, pp. 62 to 65 WO 2006/040159 A1

1-14. (canceled)

15. A process for recycling a composition comprising a poly(urea-urethane) polymer (PUU1) comprising step (i):
(i) treating the composition comprising the poly(urea-urethane) polymer (PUU1) under conditions suitable to at least partially cleave the urea bonds of the polymer to give a mixture (M1) containing prepolymers,
the poly(urea-urethane) polymer (PUU1) being obtained by a process comprising:
reacting the following components
(a) at least one isocyanate;
(b) at least one polyol; and
(c) at least one secondary amine having the following formula (I) 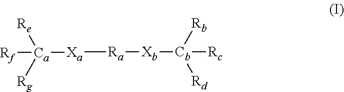
wherein —Rₐ— is selected from the group consisting of —Z₁—, —Z₂—, —Z₃—, —Z₄—, —Z₅—, —Z₆—, —Z₇—, —Z₇—, —Z₈—, —Z₉—, —Z₁₀—, —Z₁₁—, —Z₁₃—, —Z₁—Z₅—, —Z₅—Z₁—Z₅—, —Z₁—Z₆—, —Z₁—Z₇—, —Z₁—Z₈—, —Z₁—Z₉—, —Z₉—Z₁—Z₉—, —Z₁—Z₁₀—, —Z₃—Z₅—, —Z₃—Z₆—, —Z₃—Z₇—, —Z₃—Z₈—, —Z₃—Z₉—, —Z₃—Z₁₀—, —Z₁—Z₅—Z₁—, —Z₁—Z₉—Z₁—, —Z₉—Z₁(—Z₁₁—Z₁), —Z₉—, with n=1, 2, 3, 4, 5, or 6, and —Z₁—Z₁₂—Z₁—;
wherein
—Z₁— is a substituted or unsubstituted, linear or branched C₁-C₃₀ alkylene;
—Z₂— is a substituted or unsubstituted, linear or branched 2- to 300,000-membered heteroalkylene;
—Z₃— is a substituted or unsubstituted, linear or branched C₂-C₃₀ alkenylene;
—Z₄— is a substituted or unsubstituted, linear or branched 3- to 30-membered heteroalkenylene;
—Z₅— is a substituted or unsubstituted C₅-C₃₀ cycloalkylene;
—Z₆— is a substituted or unsubstituted 5- to 30-membered heterocycloalkylene;
—Z₇— is a substituted or unsubstituted C₅-C₃₀ cycloalkenylene;
—Z₈— is a substituted or unsubstituted 5- to 30-membered heterocycloalkenylen;
—Z₉— is a substituted or unsubstituted C₆-C₃₀ arylene;
—Z₁₀—is a substituted or unsubstituted 5- to 30-membered heteroarylene;
—Z₁— is a C₆-C₃₀ arylene substituted with —NHR or —OR, wherein R is selected from the group consisting of H and substituted or unsubstituted, linear or branched C₁-C₁₀ alkyl;
—Z₁₂— is —N(R_{f})—;
—Z₁₃— is a substituted or unsubstituted 5- to 30-membered heterocycloalkylene, wherein at least one of the one or more heteroatoms of Z₁₃ is from Xa;
wherein Cₐ is a C atom or a H atom and C_{b} is a C atom or a H atom, wherein at least one of Cₐ and C_{b} is a C atom;
wherein Xₐ is a O atom or NH and Xb is a O atom or NH, wherein at least one of Xₐ and X_{b} is NH, with the condition that for Xₐ or X_{b} being NH, the respective Cₐ or C_{b} is/are C atom(s);
wherein
(A) R_{c}, Rd, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃0 cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃0 cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl, R_{b} and Rₑ independently of each other are defined as R_{c}, Rd, R_{f} and R_{g}; or
R_{b} and Rₑ are none, and Cₐ and C_{b} are connected to each other via a single bond forming a heterocycle consisting of Cₐ, C_{b}, Xₐ, X_{b} and Rₐ; or
(B) Cₐ and Rₑ form a substituted or unsubstituted C₆-C₃₀ arylene, and both R_{f} and R_{g} are none; and
C_{b} and R_{b} form a substituted or unsubstituted C₆-C₃₀ arylene, and both Rₑ and Rd are none; or
(C) —Cₐ and Rₑ form a substituted or unsubstituted C₆-C₃₀ arylene, and both R_{f} and R_{g} are none; or
C_{b} and R_{b} form a substituted or unsubstituted C₆-C₃₀ arylene, and both Rₑ and Rd are none;
wherein, when Cₐ and Rₑ form a substituted or unsubstituted C₆-C₃₀ arylene, R_{b}, Rₑ and Rd independently of each other are defined as any one of Rₑ, Rd, R_{f} and R_{g} under (A);
wherein, when C_{b} and R_{b} form a substituted or unsubstituted C₆-C₃₀ arylene, Rₑ, R_{f} and R_{g} independently of each other are defined as any one of Rₑ, Rd, R_{f} and R_{g} under (A).

16. The process according to claim 15, wherein step (i) is a treatment at a temperature in the range from 60° C. to 200° C. and a pressure in the range from 1 bar to 200 bar or in a range from 50 mbar to 1 bar.

17. The process according to claim 15, wherein in step (i) an aprotic solvent is added.

18. The process according to claim 15, wherein in step (i), a component (S) is added which is suitable to react with the free functional groups of the cleaved urea bonds.

19. The process according to claim 18, wherein component (S) is selected from the group consisting of polyols, diols, polyisocyanates, diisocyanates, polyamines, oligo-amines, diamines, and amines of the general formula (I).

20. The process according to claim 19, wherein component (S) is a polyamine, oligo-amine or diamine of the general formula (I).

21. The process according to claim 15, wherein the composition comprises a filler, the filler being selected from the group consisting of glass fibers, carbon fibers, mineral fibers, textiles, metal meshs, metal fibers, metal rods, carbonates, wood, and a mixture of two or more thereof.

22. The process according to claim 15, wherein the process comprises step (ii)
(ii) separating the components of the mixture obtained in step (i).

23. The process according to claim 22, wherein step (ii) comprises a filtering step.

24. The process according to claim 22, wherein the process comprises step (iii)
(iii) preparing a poly(urea-urethane) polymer using one or more of the components obtained in step (ii).

25. A prepolymer obtained according to the process of claim 15.

26. A poly(urea-urethane) polymer obtained according to the process according to claim 15.

27. A method of preparing a poly(urea-urethane) polymer comprising using the prepolymer according to claim 25.

28. A poly(urea-urethane) polymer obtained by a process using the prepolymer according to claim 25 for the preparation of a poly(urea-urethane) polymer.
